(19) United States
(12) Patent Application Publication
(10) Pub. No.: US 2003/0187744 A1
(43) Pub. Date: Oct. 2, 2003

(54) System for enabling omnidirectional navigation of hierarchical networks with spatial continuity

(76) Inventor: Alan Gardner Goodridge JR., Mountain View, CA (US)

Correspondence Address: Alan G. Goodridge Jr., 111 North Rengstorff Ave. #91, Mountain View, CA, 94043, US

(21) Appl. No.: 10/106,766

(22) Filed: Mar. 27, 2002

(51) Int. Cl. G06F 17/60

(52) U.S. Cl. 705/26

(57) ABSTRACT

The invention enables rapid omnidirectional navigation of hierarchical networks that contain compressed image information. A user agent advantageously joins units of map information using expanded higher-level map information, responsively to or in anticipation of user navigational actions such as downward level-jumping, lateral navigation, and scaling. The user agent positions lower-level units of map information using reference points which are expanded relative to corresponding higher-level points, reflecting an expansion of available area between levels.

### FIELD OF INVENTION

The present invention relates to viewing, navigating, and interacting with hierarchical HTML and non-HTML network information which contains compressed image information suitable for transmission over the internet. The present invention relates to the fields of interactive media, network navigation, web browsing, document viewing, video games, interactive television, and others.

### BACKGROUND OF THE INVENTION

Applications for browsing documents in the Hypertext Markup Language (HTML) format have become popular during the brief tenure of PC modems in the range of about 14400 to 56000 bps. But technologies such as cable modem and Digital Subscriber Line (DSL) redefine the tradeoff between bit economy and ease of use. Hyperlinking and client-dependent page layout methods combine to produce an excellent low-bandwidth navigational mechanism, but impose fundamental limitations on browsing efficiency at higher bitrates. The “drill-down” problem particularly limits the user by requiring a hierarchical form of navigation when lateral or scaling navigation would transport the user more efficiently. Thus there is a long-felt need in the art for improved methods of viewing, navigating, and controlling interaction with content on networks such as the internet, and in particular for methods which provide a fluid, omnidirectional type of navigation for networks that include relatively large amounts of compressed image information. There is particularly a need in the art for methods that overcome the limitiations of existing web browsers, which cater to the spatially discontinuous case of pure-hyperlink navigation, thus forcing inefficient traversal of hierarchically organized information.

The official HTML specification instructs user agents to confine spatial continuity to webpage areas limited by either the size of the browser's content area, or by a client-dependent page layout method. User agents such as Microsoft's Internet Explorer, America Online's Netscape Navigator, and Opera Software's Opera provide vertical and horizontal scrollbars for navigating laterally within a webpage, but do not allow users to scroll the frames of a frameset in unison. If the ROWS or COLS attribute of an HTML <FRAMESET> tag specifies a sum of widths or heights that is larger than the width or height of the content area respectively, such browsers limit the frameset to the area of the window. Internet Explorer and Netscape Navigator do so according to HTML specification: “Absolute lengths that do not sum to 100% of the real available space should be adjusted by the user agent . . . When overspecified, each view should be reduced according to its specified proportion of the total space.” Authors have long sought to control layout with HTML tables, and as of HTML 4.0 can use the <OBJECT> and <IFRAME> tags to specify embedded documents and inline frames respectively. But purists still frown upon the practice of creating webpages wider than the screen of the client, and user agents have generally ignored the special needs of such cases. Thus there is a need in the art for methods of viewing, navigating, and interacting with spatially continuous content that covers large areas.

To create more area, hypermedium authors typically organize data hierarchically and add more links. Navigational mechanisms of the user agent then let users “drill down” into more and more detailed information about content. Sometimes, authors combine the hierarchical format with map information that controls the positions of images or parts of images within a page. FIG. 1 shows the basic elements of such a position-controlled hierarchical network. Nodes (100 through 106) represent areas, while a group of arcs (110,111,112) extending downward from a node represents a unit of map information. Each area is navigationally associated with the map information that extends downward from it, and vice versa, while image information (not shown) is associated content-wise with the areas it appears in. A level (120,121) of the hierarchy consists of all map information at a particular level of the graph, plus associated content. FIG. 1 particularly describes a navigational hierarchy, rather than a content hierarchy which merely governs the layout of content within some area. User agents generally support the idea of traveling within a network; when the user navigates or “goes” to a different place in the network, the whole of a user's view of that network is subject to change.

FIG. 1 represents paths available to a user agent for traveling between different levels of content. For example, first map information 111 and second map information 112 of a first level 121 describe the positions of areas 103, 104, 105, and 106, each of which areas is content-wise associated with decodable compressed image information. While viewing some region of level 121, the user chooses to jump upward to a higher level 120 containing map information 110 which describes the positions of areas 101 and 102, each of which areas is content-wise associated with decodable compressed image information. Area 101 is navigationally associated with map information 111, and area 102 is navigationally associated with map information 112.

Documents in HTML and other formats contain map information and associated links in various forms. HTML table cells can contain images or embedded frame objects wrapped by inline links, as in either of the following:

<TD WIDTH=“192”><A HREF=“link1.htm”>

<IMG SRC=“image1.jpg” WIDTH=“192” HEIGHT=“128” BORDER=0></A></TD>

<TD WIDTH=“192”><A HREF=“link1.htm”>

<OBJECT DATA=“embfr1.htm” WIDTH=“192” HEIGHT=“128” BORDER=0></A></TD>

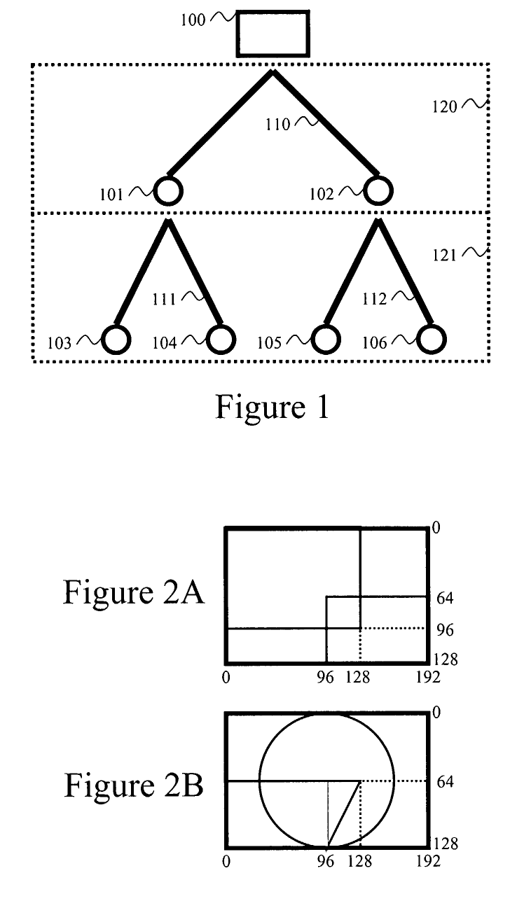

HTML client-side image maps allow authors to define different links for different “hotspots” within an image, as in either of the following (see FIG. 2A, FIG. 2B):

<MAP NAME=“map1”>

<AREA SHAPE=“RECT” COORDS=“0,0,128,96” HREF=“link1.htm”>
<AREA SHAPE=“RECT” COORDS=“96,64,192,128” HREF=“link2.htm”></MAP>

<IMG SRC=“image1.jpg” WIDTH=“192” HEIGHT=“128” USEMAP=“#map1” BORDER=0>
<MAP NAME=“map2”>

<A HREF=“link3.htm” SHAPE=“POLY” COORDS=“0,64,0,128,96,128,128,64”></A>
<A HREF=“link4.htm” SHAPE=“CIRCLE” COORDS=“96,64,64”></A></MAP>

<OBJECT DATA=“image1.gif” TYPE=“image/gif” USEMAP=“#map2” BORDER=0>
</OBJECT>

Alternatively, the ISMAP attribute of the <IMG> tag instructs the browser to link by sending click coordinates to a server-side image map:

<A HREF=“ssprog1.map”>

<I MG SRC=“image1.jpg” WIDTH=“192” HEIGHT=“128” ISMAP BORDER=0> </A>

The Cascading Style Sheets (CSS) format splits position and layer information into the <HEAD> section of an HTML or external document, while leaving link information in the <BODY> section (see FIG. 2A):

<HTML>

<HEAD><STYLE TYPE=“text/css”>

.rect1 { position:absolute; z-index:1; left:0px; top:0px; width:128px; height:96px; }
.rect2 { position:absolute; z-index:2; left:96px; top:64px; width:96px; height:64px; }

</STYLE></HEAD>
<BODY>

<span class=“rect1”><A HREF=“link1.htm”><IMG SRC=“image1.jpg”></A></span>
<span class=“rect2”><A HREF=“link2.htm”><IMG SRC=“image2.jpg”></A></span>

</BODY>

</HTML>

The medium of television has motivated various page-oriented formats that allow authors to synchronize the behavior of moving and dynamically varying elements, including image information such as video and a variety of compressed graphics formats. Like external-document CSS, the Synchronized Multimedia Integration Language (SMIL) format, supported by Real Networks' RealPlayer and Apple's QuickTime among others, splits map information between the <head> and <body> sections of a document in the Extensible Markup Language (XML) format. The fit attribute of the region tag demonstrates that the width and height of a map area (see FIG. 2A) need not be the same as the width and height of its source image:

<smil>

<head><layout>

<region id=“rect1” left“0” top=“0” width=“128” height=“196” z-index=“1” fit=“slice” />
<region id=“rect2” left=“96” top=“64” width=“96” height=“64” z-index=“2” fit=“meet” />

</layout></head>
<body><par>

<A HREF=“link1.htm”><img src=“image1.rp” region=“rect1” /></A>
<A HREF=“link2.htm”><video src=“video1.rm” region=“rect2” /></A>

</par></body>

</smil>

The Timed Interactive Multimedia Extensions (HTML+TIME) recommendation of Microsoft, Macromedia, Compaq, et al replaces the layout features of SMIL with CSS, while extending the functionality of SMIL into HTML by adding timing attributes to existing HTML elements. Other popular formats which define map information and associated links for dynamic media include the Shockwave (.swf) and Flash formats supported by Macromedia Director, the QuickTime (QTM) format supported by Apple Macintosh Operating System, etc.

Popular “metafile” formats featuring hyperlinks include Portable Document Format (.pdf supported by Adobe Acrobat), PostScript (.ps, eps, .ai, supported by Adobe Illustrator and many others), Powerpoint (.ppt, supported by Microsoft Powerpoint), etc. Some basic graphics file formats, such as Tagged Image File Format (TIFF), support multiple images per file and can themselves define links if pushed into service for such a task. In the volume “Encyclopedia Of Graphics File Formats, Second Edition”, James D. Murray and William vanRyper describe a number of such formats.

In HTML, nominal inline linking is often replaced by more flexible, script-based methods of associating areas with map information. Scripting languages such as VBScript and JavaScript, for example, can override the HREF attribute of an <A> or <AREA> tag through an OnClick( ) event handler. Scripted association can create querystrings, access variables containing map information, and decide mapping references dynamically. The Document Object Models (DOMs) of user agents such as Internet Explorer support event handlers for a variety of HTML elements that can be associated with image areas through script. The emerging XML-based Xlink standard will support a syntax that also includes multiple and bidirectional associations between resources.

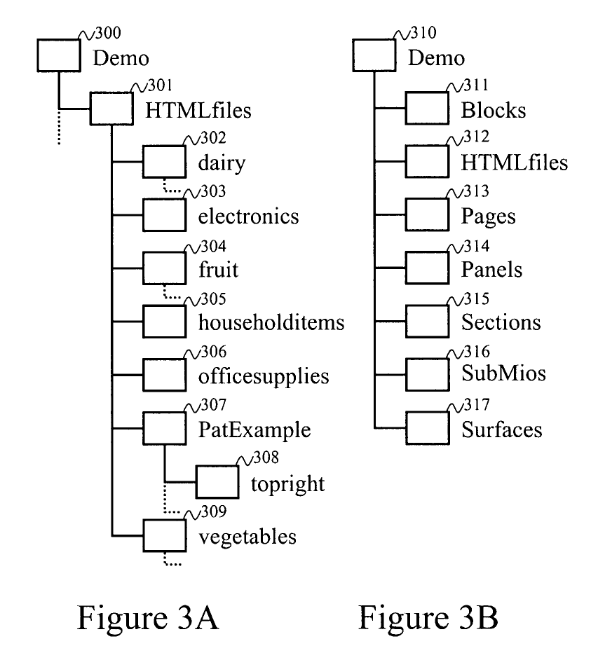

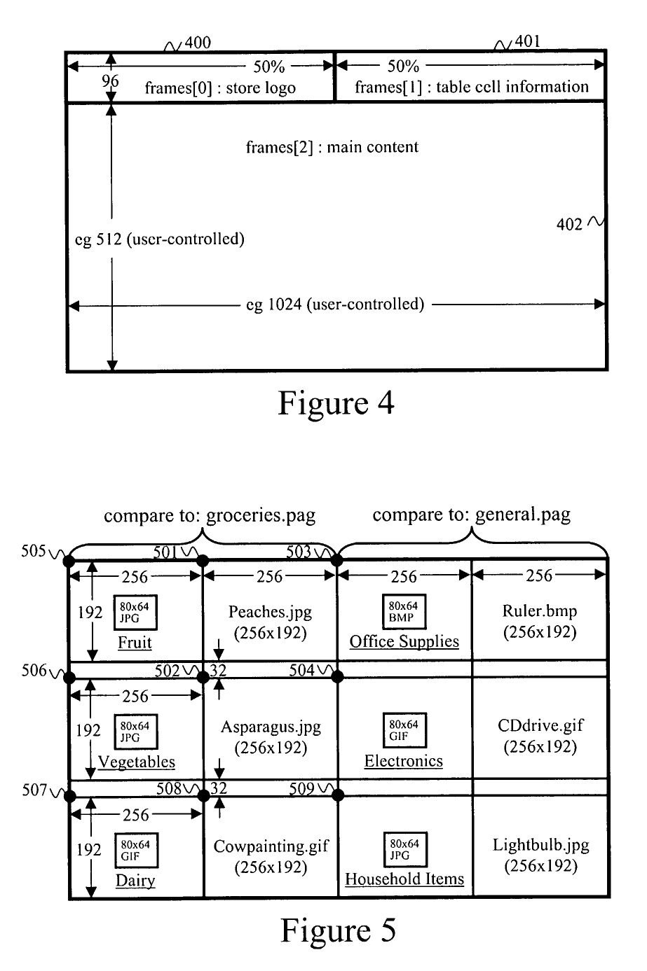

An ecommerce-oriented example using HTML tables helps to demonstrate the shortcomings of existing user agents. FIG. 3A shows the directory structure of the example; the contents of each HTML file are listed at the end of Appendix 1. Directing Internet Explorer to PatExample/framesetPatExample.htm (p. 175 of Appendix 1) when the browser window's dimensions are 1024×608 yields the frameset dimensions of FIG. 4; frames[0] 400 contains the website logo PatExample/logostore.gif; frames[2] 402 initially contains the top-level table of PatExample/tableMain.htm (pp. 176-177), and will contain other tables in the hierarchy of the example as a result of user navigation; and frames[1] 401 provides space for information about different categories and products associated with particular table cells. Scripted linking functions in the HTML for frames[1] 401 also reference the file Zsh/linktoOCX.htm (p. 207); a parallel example illustrating the present invention will include this file.

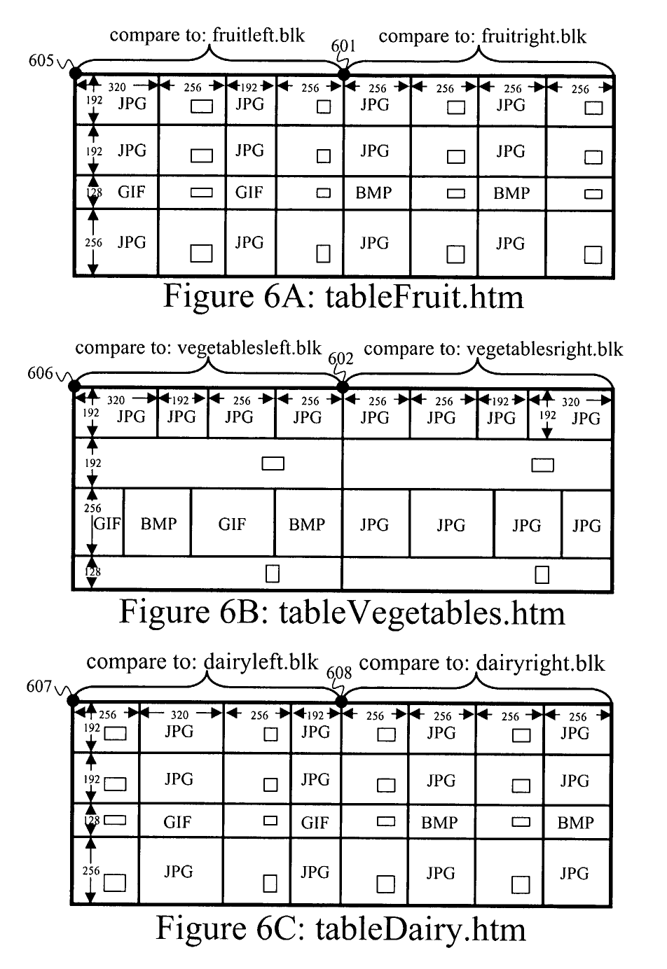

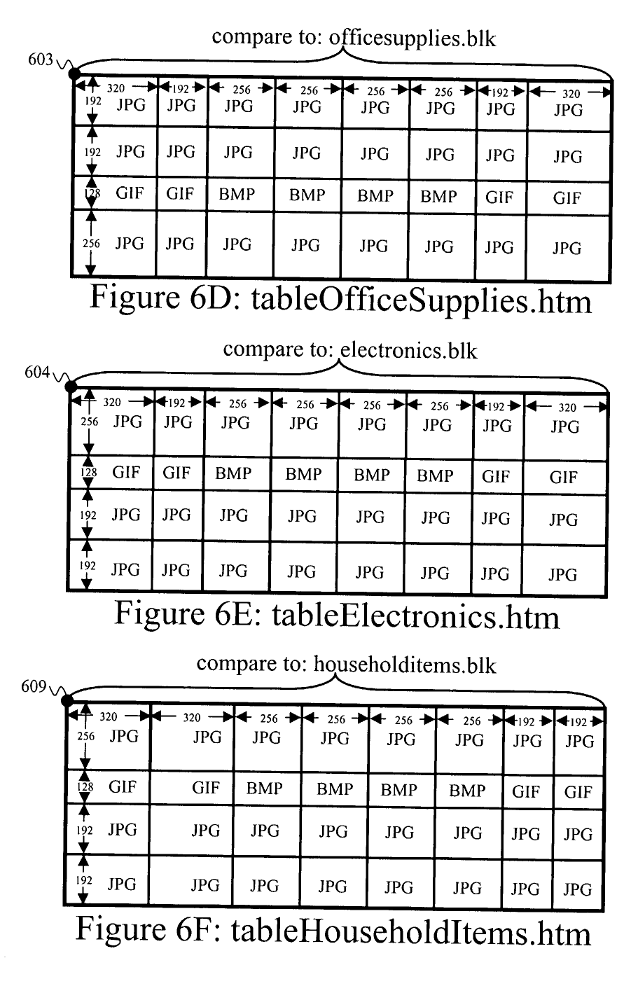

Javascript statements in tableMain.htm generate the table dimensions of FIG. 5. Grocery Store categories fill the left half of the table (fruit, vegetables, and dairy), while General Store categories fill the right half of the table (office supplies, electronics, and household items). A pair of adjacent table cells of size 256×192 represents each category; the right cell contains a compressed image of size 256×192 while the left cell contains a thumbnail image and some text describing the category. For each of the six categories, each of two links points to the same lower-level table. Moving the mouse over either link directs category-specific content to frames[1]. Javascript statements in fruit/tableFruit.htm through householditems/tableHouseholdltems.htm (pp. 180-199) generate the table dimensions of FIGS. 6A-6F (FIG. 5 adheres to the scale of FIG. 4, but FIGS. 6A-6F do not). Grocery Store tables contain thumbnails and text in cells covering roughly half of their area, while General Store tables contain compressed images throughout. General Store tables also contain links whose onmouseover( ) handlers direct product-specific content to frames[1]. The variety of different categories and products requiring compressed image information reflects a typical application of the present invention.

Lower-level table widths are 2048, while the browser window's example (user-defined) width is only 1024, which would normally force users to switch back and forth between horizontal and vertical scrollbars. Script functions in PatExample/javascriptMDLN.htm (pp. 178-179) address this problem by implementing mouse-down lateral navigation (MDLN), which is similar to the “hand tool” capability of other software programs. The function DoMouseMove(ev) responds to mouse movement by scrolling frames[2] in x and y simultaneously while the mouse is down. The function DoClickIE( ) cancels the browser's response to mouse clicks when mouse-down movement is 4 pixels or more in x or y; this action destroys the browser's usual drag-and-drop and selection range capabilities. Further drawbacks of scripted MDLN include slow screen updates, difficulty in accurately calculating scroll range endpoints, interaction with mouse-down in scrollbars, and the need to account for a different event model (and different bugs) in Netscape Navigator.

Using MDLN after navigating downward to any of the lower-level webpages reveals a major limitation of existing user agents. Even though map information in tableMain.htm defines a positional relationship between lower-level table areas, Internet Explorer and other web browsers can only display one lower-level table at a time. At some point during lateral navigation, the user agent bumps into a barrier beyond which it cannot retrieve or display anything further. Logically, the existence of higher-level map information should enable seamless navigation across such boundaries. User agents should deliver rapid, unbounded progress in any lateral direction without incurring the loading or reflow delays typical of large webpages. Existing user agents fail to join together the units of map information which form hierarchical levels, fail to detect the conditions which make this desirable or possible, and fail even in obvious cases where lower-level areas merely subdivide equally proportioned higher-level areas. The two-dimensional convenience of MDLN demonstrates and underscores the potential value of this kind of spatial continuity.

Poor scaling capabilities also limit the usefulness of existing user agents. By zooming out from the displayed region of a given hierarchical level, users could benefit from a wider view of the region's context before proceeding with further navigation. Internet Explorer and Netscape Navigator do not offer scaling. Opera scales individual webpages, but does not display additional webpages when the user reduces resolution. Logically, the existence of higher-level map information should enable scaling which encompasses large, arbitrary regions. User agents should scale smoothly up to a bird's-eye view of surrounding areas without incurring the loading or reflow delays typical of large webpages. Existing user agents fail to join together the units of map information which could bring other areas into view during scaling, and fail to detect the conditions which make such scaling desirable or possible.

### SUMMARY OF THE INVENTION

The present invention addresses the aforementioned needs in the art by enabling rapid omnidirectional navigation of hierarchical networks that contain compressed image information. In a method according to the present invention, a user agent advantageously joins units of map information using expanded higher-level map information, responsively to or in anticipation of user navigational actions such as downward level-jumping, lateral navigation, and scaling. The user agent positions lower-level units of map information using reference points which are expanded relative to corresponding higher-level points, reflecting an expansion of available area between levels.

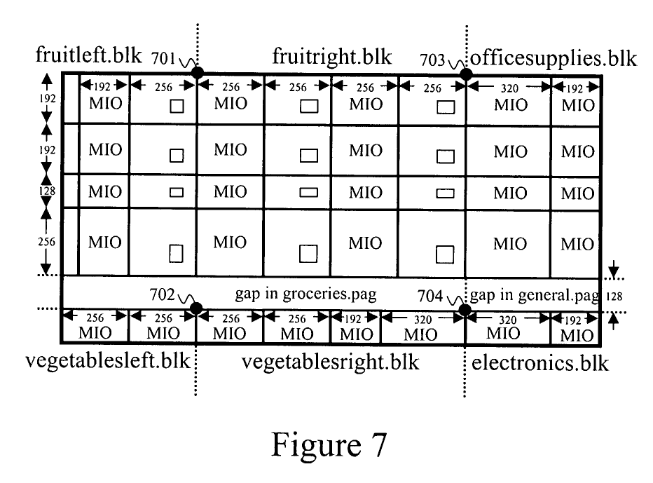

FIG. 7 illustrates the effect of using reference points which are expanded relative to corresponding higher-level points. The four reference points 701-704 correspond to the four lower-level points 601-604 of FIGS. 6A-6F, and to the four higher-level points 501-504 of FIG. 5. In one possible computation, the user agent scales coordinates in the space of tableMain.htm by a factor of four to yield coordinates in a lower-level space. For example, the coordinates (256,224) and (512,224) of points 501 and 503 yield the coordinates (1024,896) and (2048,896) of reference points 701 and 703. Coordinates in the spaces of tableFruit.htm and tableOfficeSupplies.htm then represent offsets from reference points 701 and 703 respectively. FIG. 7 represents the effect of jumping one level downward in the hierarchy, navigating laterally, and counteractively decimating by a factor of two. FIGS. 6A-6F and FIG. 7 indicate the widths and heights of compressed image data and unscaled HTML-containing areas; screen pixel widths and heights are one half the values shown, due to counteractive scaling (compare to FIG. 4). In an illustrated embodiment of the present invention, a self-registering ActiveX Control (OCX) named Zoosh operates on hierarchical data which includes HTML data as a subset. The C++ source files in Appendix 1 implement Zoosh. C++ classes CZooshApp and CZoosliCtrl are adapted from Microsoft OCX skeleton classes.

RGU Format

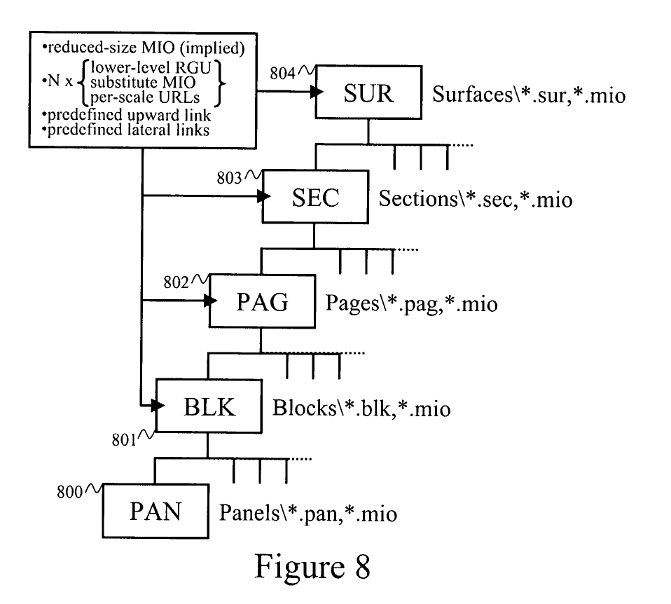

The Retail Grouping Unit (RGU) format defines four hierarchical levels. FIG. 8 shows the different levels: Blocks (.blk) 801, Pages (.pag) 802, Sections (.sec) 803, and Surfaces (.sur) 804. Panels (.pan, class CPanEntry, derived from class CZshFileEntry) 800 represent leaf content. RGU files other than Panels (class CBpssEntry, also derived from CZshFileEntry) contain a concatenation of components, each of which contains position, width, height, file path of another RGU, URLs for a series of integer scale values, and file path of a “substitute” image. Internally, Zoosh stores each component as an object of class CPosRgu, and encapsulates operations on the CPosRgu objects of a given level in class CPosRguConcat. Zoosh maintains multiple-level hierarchies in class CReSuConcat, caches RGU and image files using location-based algorithms in class CEntryCache, and maintains its coordinate system in class CCoordSys. Zoosh confines level-to-level scaling factors to powers of two in each of width and height. The descriptions to follow utilize level-to-level scaling factors of four in each of width and height, yielding factors of 16 in area.

HTML and MIO Formats

HTML components (class CWebBrowser2, provided by Microsoft) can display anything the WebBrowser control can display, and remain interactive. MIO files (.mio, class CMioEntry) contain header information and compressed image information in a format that encapsulates MPEG-IFrame-Only (files iquantvld.cpp, jrevdct.cpp, mfwddct.cpp adapted from Berkeley MPEG Tools, version 1.0, Release 1; Feb. 5, 1995). Personal computers and settop boxes commonly support hardware MPEG decoding, including MPEG IFrame decoding; compression efficiency in MPEG-IFrame-Only is comparable to that of JPEG. The MIO format confines image dimensions to multiples of the macroblock unit size, in order to streamline processing on devices with limited processing or memory capacity. With 4:2:0 sampling, the 16×16 MPEG macroblock contains four 8×8 chroma blocks and two 8×8 luma blocks. MIO headers contain fields for integer macroblock and submacroblock padding amounts. When loading an RGU file, Zoosh looks for a default image with the same file stem and “.mio” extension. Default images for Block level and above typically represent decimated concatenations of component images. In the absence of a substitute image, Zoosh displays the default image.

Preloading and Predecoding

Zoosh preloading and predecoding algorithms enable instantaneous display updates during lateral, scaling, and level-jumping navigations. Under the control of CReSuConcat, CEntryCache algorithms preload by fetching the fraction of a parent RGU's components that lie within a programmable preload perimeter, and call CBpssEntry to offset the child map information in each preloaded component by the scaled top left coordinates of the preloaded component. CReSuConcat directs top-down preloading, starting from a programmable number of levels above the current level. CEntryCache predecodes by decoding the compressed image information for each preloaded component that lies within a programmable predecode perimeter, and both preloads and predecodes HTML components by loading URLs into CWebBrowser2 controls (“Navigate” method of CWebBrowser2). CReSuConcat demonstrates independent control over 1) top-down preloading for current level and higher, 2) bottom-up predecoding for current level and higher, and 3) preloading and predecoding for next-lower level. RGU files also support predefinable upward links. CReSuConcat uses predefined upward links to continue navigating when it has not previously loaded an RGU's parent; CBpssEntry overwrites upward link fields upon loading the CPosRgu components of any known parent.

Zoosh User Interface

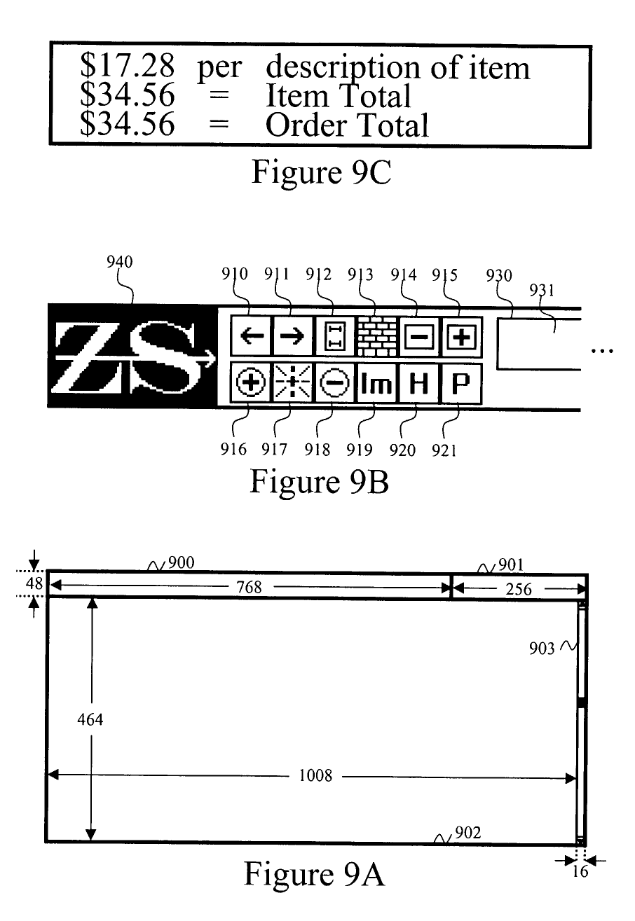

Class CChildSwitch divides the ActiveX Control's area into three separate views as in FIG. 9A. The main content area (classes CVidWnd, CVidArea) 902 displays a region of a hierarchical level and supports mouse-down lateral navigation, high-performance continuous scaling, and autohiliting of RGU contents on mouseover. FIG. 9B details the toolbar area (classes CToolWnd, CToolArea) 900, which contains the ZoomShopper logo 940, toolbar buttons 910-920, and combobox 930 with text entry field 931 and dropdown menu (righthand side of combobox, not shown). The upward level-jumping button 914 and Escape key jump one level up; the downward level-jumping button 915 and Enter key jump one level down; the resolution increase button 916 and resolution decrease button 918 double and halve the resolution of MIO display respectively; the vertical scrollbar 903 and “+” and “−” keys control a mechanism which integrates level jumping with continuous scaling; the realign button 917 restores initial navigational values (xviewTL, yViewTL, LevelDelta, and Scale); the HTML button 920 gives precedence to HTML URLs over substitute or reduced-size images (CPosRgu objects may have all three); the Images button 919 gives precedence to MIO images over URLs. A set of four arrow key functions direct navigational shifting by fixed amounts.

Ecommerce Features

The illustrated embodiment of the present invention includes a number of features that support ecommerce. At Block level, the Enter key adds a copy of selected CPosRgu objects to a shopping cart data structure (class CCartConcat, derived from CPosRguConcat) instead of jumping downward (except in mall configuration, see below). Toggling the shopping cart switch 912 yields an autoformatted RGU representing the contents of a shopping cart. The repack button 913 repacks the cart after editing. Adding selected items to the cart produces audio feedback (class CAudEffect) whose pitch increases after the first addition, and deleting selected items from the cart produces audio feedback whose pitch decreases after the final deletion. FIG. 9C details the reporting area (classes CRepWnd, CRepArea) 902, which displays a unit price 940 for the current item (or selection range), a total 941 for like items (or like selection ranges) in the cart, and a total 942 for the entire cart.

History Mechanism

A history mechanism (class CURLHistEntry) supports arbitrary links between RGUs, and links between RGUs and webpages. In a “mall” configuration, Panel MIOs represent storefronts. At Block level, jumping downward or using the Enter key fills the whole Zoosh area (FIG. 9A) with a CWebBrowser2 control, and navigates to a mall Block URL. Zoosh then intercepts linking within the CWebBrowser2 control and overrides Internet Explorer behavior when linking to RGU files. The history mechanism remembers navigational values, so that backing up to the mall leads back to the storefront at a saved position, and leaving the shopping cart display leads back to the retail display at a saved position. The pulldown menu (not shown) of combobox 930 permit arbitrary branching, and text area 931 supports querystrings for search engines. History arrows 910 and 911 jump one history entry backward or forward respectively.

Margined Doubly Circular Source Buffering

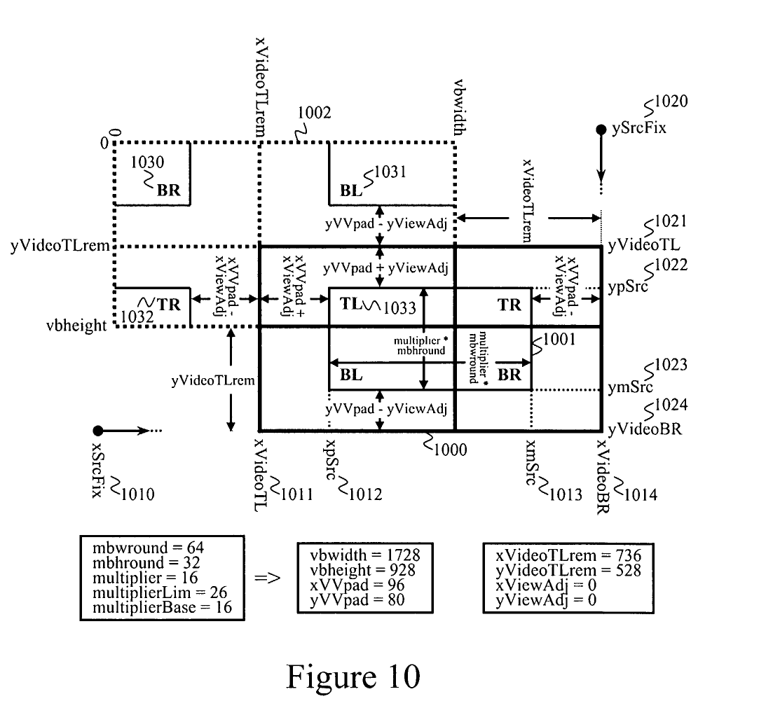

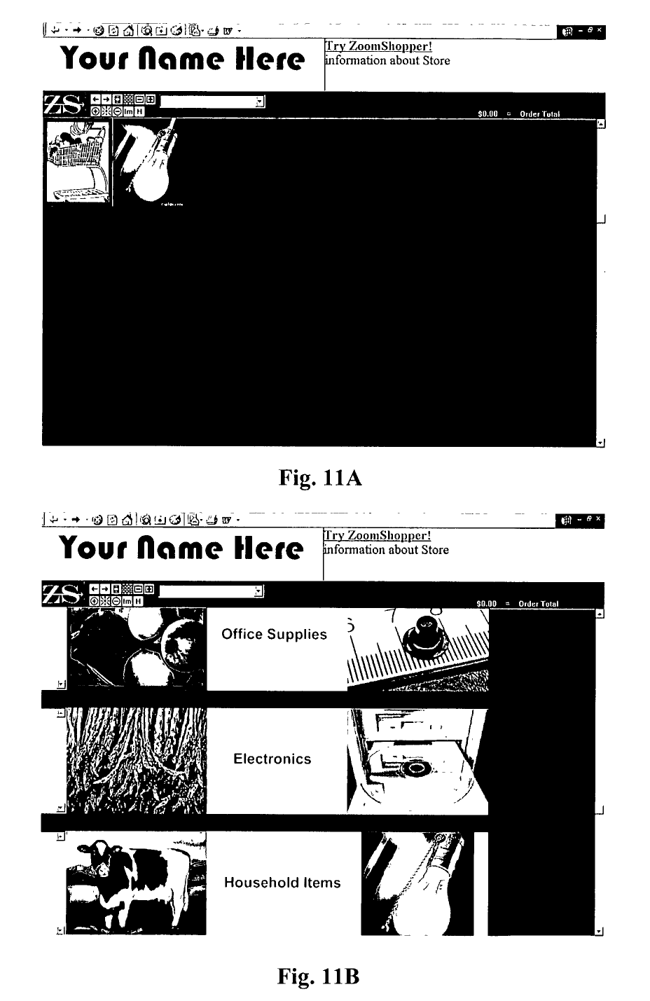

The illustrated embodiment of the present invention implements low-delay lateral navigation and continuously gradated scaling using a margined, doubly circular buffering mechanism, and using the coordinate system operations of class CCoordSys. FIG. 10 shows a buffer-sized region 1000 in the source coordinate space of a hierarchical level, with x coordinates 1010-1014 and y coordinates 1020-1024. A scaling factor S=multiplier/multiplierBase relates the dimensions of a destination view area to the dimensions of a source view area 1001 (approximate); S>1 implies shrinking while S<1 implies enlargement. CCoordSys permits multiplier values in the range multiplierLim/2 . . . multiplierLim-1, with multiplierLim<=multiplierBase*2. The doubly circular buffer 1002 stores data at coordinates defined by a modulo operation: buffer coordinates=source coordinates modulo (vbwidth, vbheight). Lateral navigation controls the top left point (xVideoTL, yVideoTL) of the buffered region 1000, and causes its modulo remainder (xVideoTLrem, yVideoTLrem) to wrap periodically. Four quadrants 1030-1033 of the view region thus occupy reversed positions within the buffer 1002, as do four corresponding quadrants of margin area. Zoosh overwrites rows and columns of the buffer 1002 in increments of macroblock granularity, tracking submacroblock adjustments to the nominal margin sizes xVVpad and yVVpad in xViewAdj and yViewAdj respectively.

RGU Example

FIG. 3B shows the directory structure of an RGU example which parallels the HTML example of FIGS. 4-6 and 3A; the Demo directory 310 gains directories for Panels 314, Blocks 311, Pages 313, Sections 315, Surfaces 317, and substitute images 316. Demo/HTMLfiles also gains directories PatExample/Zsh and fruit/cellframes through dairy/cellframes. In the RGU example (again using FIG. 4), frames[0] 400 contains the same logo as before, frames[1] 401 again provides product and category information, and frames[2] 402 contains the Zoosh ActiveX Control. Sections/stores.sec, which contains Pages/groceries.pag and Pages/general.pag (Appendix 2 contains RGU file listings) representing the Grocery Store and General Store respectively, defines an extra level for the RGU example that is not present in the HTML example. RGUs groceries.pag and general.pag contain Blocks with exactly the same size and layout as lower-level tables of the HTML example, except that a pair of Blocks replaces each lower-level table in the Grocery Store (ie, two Blocks of width wcell replace one table of width wcell*2; see FIGS. 6A-6F). MIO images replace table-cell-filling JPEGs, GIFs, and BMPs, and separate HTML files (under */cellframes) replace other table cell content.

Zoosh Initialization

The user can enter the hierarchy at Section/stores.sec (Pages level) by pointing Internet Explorer to Zsh/framesetOCXDirect.htm. Alternatively, the user can enter the hierarchy at Blocks level by clicking on “Try ZoomShopper!” in frames[1] of the HTML example, invoking one of the aforementioned scripted linking functions that target frames[2] with Zsh/linktoOCX.htm. Javascript variables at frameset document scope control get/set properties of the Zoosh object at instantiation time. Initial navigational values include: LevelDelta of −2 for directing an initial downward jump from Pages level to Blocks level; xViewTL and yViewTL for aligning top left of view with top left of fruit Block, vegetables Block, dairy Block, etc; and Scale of 0 for initializing image display to the highest noninterpolated resolution of MIO data.

### DETAILED DESCRIPTION

In an illustrated embodiment of the present invention, a self-registering ActiveX Control named Zoosh operates on hierarchical data from the RGU example described above, which parallels the HTML example of FIGS. 4-6 and 3A. The Detailed Description contains a description of the individual software modules in Zoosh, followed by a set of example scenarios which demonstrate the operation of Zoosh.

MFC ActiveX ControlWizard of Microsoft Visual C++ version 5.0 generates a project skeleton containing the files readMe.txt (page 0 line 0 of Appendix 2), Zoosh.h (p. 0 line 0), Zoosh.cpp (p. 0 line 0), ZooshCtl.cpp (p. 0 line 0), ZooshCtl.h (p. 0 line 0), and Resouce.h (p. 0 line 0). The file readMe.txt summarizes the roles of these files in building the ActiveX Control, as well as the roles of several files not included in this disclosure. The function of material generated by MFC ActiveX ControlWizard is well-understood in the art.

In the following descriptions, the ZOOMENC and ZOOMEDIT compile switches are not defined, so that all code enclosed by (for example) #ifdef ZOOMEDIT . . . #endif does not enter into a compilation. Other identifiers in all-caps are contant values whose #defines are in General.h (pp.26-28; ColorConst.h contains only color constant definitions), or in the header files of individual C++ classes. Bold text is used to indicate member variables and functions, as distinguished from function parameters, local variables, etc. It is generally recognized in the art that there are many different ways to render data into a video buffer and/or display screen, and some modules which deal primarily with rendering aspects have been omitted from this disclosure; in particular, class CVidArea and its subordinate classes, which render into the main content area of Zoosh, have been omitted except for the implementations of a few functions (VidArea.cpp, pp.172-174). The module descriptions and examples below nonetheless describe relevant functions of CVidArea without going into the details of rendering.

Class CZooshApp

Class CZooshApp (files Zoosh.h, p.5; Zoosh.cpp, pp.6-7, UpdateReg.cpp, pp.22-25) defines an OLE control module object derived from base class COleControlModule. CZooshApp provides the member functions InitInstance for initializing the control module, and ExitInstance for terminating the control module. CZooshApp's override of InitInstance (p.6 line 24) calls the function AfxEnableControlContainer (MFC framework) so that Zoosh can itself contain further OLE controls, such as web browser objects. The InitInstance override also calls a global function init_iquantvld_stuff to create data tables used in MPEG I-frame decoding (rendering related), and the global function SetupYUVtoRGBTables to create data tables used in YUV-to-RGB colorspace conversion (also rendering related). The ExitInstance override calls the global function FreeYUVtoRGBTables to free memory blocks malloc'ed by SetupYUVtoRGBTables.

Class CZooshCtrl

Class CZooshCtrl (files ZooshCtl.h, pp.8-10; ZooshCtl.cpp, pp.11-21) defines a dynamically created OLE control object derived from base class COleControl. CZooshCtrl's self-registering function (UpdateReg.cpp, p.22 line 22) has also been modified per the instruction of Microsoft documents entitled “The ABCs of MFC ActiveX Controls” and “Registering an ActiveX Object as the Player for a Media Type”, so that Zoosh becomes the registered application for MIME type “application/x-ZoomShopper”, file extensions such as “.zsh”, etc, and so that Zoosh is marked as safe for scripting and data initialization. Methods for updating the (Operating System's) registry that are appropriate for ActiveX controls are well-understood in the art.

Class CZooshCtrl handles communication between an object of class CChildSwitch (pp.90-104) and the Operating System (Windows messages), ActiveX control container, and web browser controls contained by Zoosh. CChildSwitch* theChildSwitch (p. 10 line 30) manages the division of Zoosh area amongst child windows, coordinate system initialization, hierarchical navigational actions, branching history, and toggling to and from a shopping cart display (see class CChildSwitch below). The functions of CZooshCtrl may be divided into 7 categories as follows:

1) Constructor (p.8 line 20), destructor (p.8 line 57): In a normal initialization sequence, the MFC framework first calls the CZooshCtrl constructor (p. 13 line 3), then script language statements within a web page set initial values of Zoosh properties, then the framework calls OnCreate (p.18 line 22). The member variable InitialState (p.10 line 27) is 0 after construction, 1 after OnCreate, and 2 after the framework's initial call to OnSize (p. 18 line 40). InitialState's only current use is to bypass the usual functionality of OnSize during initialization, since this would duplicate work done in OnCreate. The CZooshCtrl constructor allocates theChildSwitch, which creates a degenerate first history entry, then sets default characteristics for the first history entry in case nothing in the container environment sets initial values of Zoosh properties (see comment, p.13 line 11). The CZooshCtrl destructor (p.13 line 23) deletes theChildSwitch.

2) Virtual function overrides (p.8 line 22): MFC ActiveX ControlWizard generates virtual function overrides OnDraw (p.13 line 32), DoPropExchange (p.13 line 38), and OnResetState (p.13 line 48) as part of the project skeleton. OnDraw does nothing, since Zoosh handles drawing in child window OnPaint functions and other child window message handlers. Overrides of PreTranslateMessage and OnActivateInPlace are necessary because of a series of MFC bugs related to keystrokes not being acted upon by web browser controls that are embedded within CViews. One bug is described in Microsoft document Q165074 entitled “PRB: Keystroke Problems in CView/CWnd WebBrowser Control” (see comment, p.14 line 36), and another is described in Microsoft document Q167697 entitled “FIX: ActiveX Control in IE Asserts in CTLINPLC.CPP, Line 328” (see comment, p.14 line 49).

3) Message handling functions for Zoosh-specific messages: (p.8 line 34): The function MakeActiveInPlace (p.15 line 41) addresses a third bug in the aformentioned series, which is described in Microsoft document Q168777 entitled “PRB: MFC ActiveX Control in IE Doesn't Detect Keystrokes”. MakeActiveInPlace provides an initial in-place activation that would normally result from clicking the mouse within the control; the Zoosh-specific message WM_MAKEACTIVEINPLACE is sent from functions responding to user actions that should activate Zoosh, including most of the Zoosh-specific message handlers described below.

The functions (starting p.16 line 5) BranchToURL, JumpHistory, CartToggle, DescendLevelsCenter, AscendLevelsCenter, TrackLevelsCenter, DescendLevelsMouse, AscendLevelsMouse, TrackLevelsMouse, and GoToLevelInit call CChildSwitch counterparts to produce navigational actions in response to the Zoosh-specific messages WM_BRANCHTOURL, WM_JUMPHISTORY, WM_CARTTOGGLE, WM_DESCENDLEVELSCENTER, WM_ASCENDLEVELSCENTER, WM_TRACKLEVELSCENTER, WM_DESCENDLEVELSMOUSE, WM_ASCENDLEVELSMOUSE, WM_TRACKLEVELSMOUSE, and WM_GOTOLEVELINIT respectively (BranchToURL and JumpHistory furthermore call FireGoToFrameset; see event-firing functions below). The functions MoveBrowsers (p.17 line 56) and UpdatePerimeters (p.16 line 33) call CChildSwitch counterparts to complement lateral navigational actions in response to the Zoosh-specific messages WM_MOVEBROWSERS and WM_UPDATEPERIMETERS respectively. And the functions DeleteBrowsers (p.17 line 40) and BrowsersOnOff (p. 17 line 48) call CChildSwitch counterparts to produce changes in browser window state in response to the Zoosh-specific messages WM_DELETEBROWSERS and WM_BROWSERSONOFF respectively. CChildSwitch counterpart functions are discussed under class CChildSwitch below, and the meaning of Zoosh-specific messages is discussed under the child-window owned classes from which the messages are sent. The function ShowDataURL (p. 15 line 50) responds to the Zoosh-specific message WM_SHOWDATAURL, calling FireShowDataURL to tell script functions in the container environment to display descriptive information about a selected RGU in frames[1] (see FIG. 4).

4) Message handling functions for Windows messages (“Message maps”, p.9 line 7): Zoosh initialization is completed by the framework's call to OnCreate (p.18 line 22). OnCreate passes the Zoosh CWnd pointer to CChildSwitch for later reference, and calls CChildSwitch::GoToHistEntry (see below) to intialize child window size and placement and perform initial navigation. OnSize (p.18 line 40) updates child window size and placement with a call to CChildSwitch::SizeChildWindows (see below); as mentioned above, OnSize is bypassed at initialization time. OnKeyDown (p.18 line 53) and OnKeyUp (p.19 line 10) pass all keyboard input to the child window class CVidWnd (see below).

5) ActiveX property and method implementations (“Dispatch maps”, p.9 line 16): Setting the ActiveX property m_zooshLoc from the container environment invokes OnZooshLocChanged (p. 19 line 52), which directs CChildSwitch to overwrite the current history entry's URL (relative pathname) with the value of m_zooshLoc; similarly, setting the property m_zooshBase from the container environment invokes OnZooshBaseChanged (p.20 line 1), which directs CChildSwitch to update the base directory basedir stored in theChildSwitch::theReSuConcat::theEntryCache (see classes CEntryCache, CReSuConcat, and CChildSwitch below). The 5 get/set properties Config, Scale, XViewTL, YViewTL, and LevelDelta are realized as data members of the current history entry. The ActiveX method JumpHistoryExternal allows JumpHistory to be called from the container environment.

6) ActiveX event firing functions: “Event maps” (p.9 line 38): The FireGoToURL event is currently unused. Either FireGoToFramesetMall or FireGoToFramesetStore is called from FireGoToFrameset, but neither plays a role in the webpages of this disclosure. As described above, FireShowDataURL tells script functions in the container environment to display descriptive information about a selected RGU in frames[1] (see FIG. 4).

7) Event sink functions, called by embedded web browser controls (p.10 line 14): Event sink functions OnBeforeNavigate, OnFrameBeforeNavigate, OnDownloadComplete, OnTitleChange, and OnBeforeNavigate2 each service a particular event generated by web browser controls; the first three are currently unused. OnTitleChange (p.20 line 41) updates the Zoosh window's title according to the title of the web page displayed by the web browser control. When Zoosh's area is completely occupied by a single web browser, OnBeforeNavigate2 (p.20 line 49) intercepts navigation to RGU-format URLs, to avoid the nesting of ActiveX controls that would result from allowing the web browser control to recognize a Zoosh file suffix or mime type. Zoosh posts a message to itself which eventually results in deleting the web browser control which has generated OnBeforeNavigate2, and cancels the pending navigation.

Class CZshFileEntry

Class CZshFileEntry (files ZshFileEntry.h, p.29; ZshFileEntry.cpp, pp.30-31) is the base class for CPanEntry and CBpssEntry, which represent the leaf and non-leaf RGU file content respectively. The CZshFileEntry constructor (p. 0 line 0) stores relative pathname information (first constructor input) in member variable RguFile (p.29 line 41), and stores an associated CMioEntry* (third constructor input) in member variable RedMioEntry (p.29 line 45). The constructor also derives a file name from RguFile and stores this in the (currently unused) member variable fname (p.29 line 42), using protected functions SetNames (p.31 line 5) and FileFromPathName (p.31 line 14). The CZshFileEntry constructor uses URLDownloadToCacheFile (a simple blocking function from the Microsoft ActiveX “URL Open Stream” package) to download RguFile (unless basedir is a “file:” URL) and return the name of the cached (local) file. The CZshFileEntry constructor then reads the file's data into memory, stores the address of file data in member variable data_start (p.29 line 38), stores the size of this data in member variable file_size, and stores a predefined upward link extracted from file data in member variable RguUpward (p.29 line 44; commented out since most of the examples to follow use a file structure that does not contain RguUpward).

Class CPanEntry

Class CPanEntry (files PanEntry.h, p.32; PanEntry.cpp, p.33) represents leaf RGU file content. CPanEntry currently has no member variables or functions other than base class members; the CPanEntry constructor (p.33 line 6) merely passes its inputs to CZshFileEntry in a member initialization list.

Class CBpssEntry

Class CBpssEntry (files BpssEntry.h, p.34; BpssEntry.cpp, pp.35-36) represents non-leaf RGU file content. The CBpssEntry constructor (p.35 line 7) merely passes its inputs to CZshFileEntry in a member initialization list. Member variable PosRguListBpss (p.34 line 34) is a list of pointers to CPosRgu elements (see class CPosRgu below), each of which represents a component of the map information in file RguFile. The function InitPosRguList (p.35 line 22) creates the CPosRgu objects from file data, and compares the bounding rectangle of each CPosRgu to the expanded bounding rectangle of a CPosRgu representing the component's parent (ie representing RguFile); a CPosRgu* representing RguFile is the only input to InitPosRguList. If the component's bounding rectangle is contained within the parent's bounding rectangle (or if input testbounds is not set) the component is accepted into PosRguListBpss, and CPosRgu::Offset adds the expanded top left coordinates of the parent to the top left coordinates of the component (p.35 line 41). CPosRgu::CprUpward of every accepted component is set to the input CPosRgu* (see class CPosRgu below). The function RecursiveJog (p.35 line 56) adds the expanded top left coordinates of the parent to the top left coordinates of the component recursively, as if the top left (macroblock unit) coordinates of its input cprThis had been translated from (0, 0). RecursiveJog is used in level ascending with predefined upward links, when a disembodied root CPosRgu (see class CReSuConcat below) is replaced with a PosRguListBpss CPosRgu whose origin is no longer (0, 0). The function SetCprUpwardOfChildren (p.36 line 17) provides a means of resetting the CPosRgu::CprUpward of all PosRguListBpss elements, ie to something different from what is originally passed into InitPosRguList (see class CReSuConcat below). The function FindChildEntry (p.36 line 24) searches PosRguListBpss for a CPosRgu* corresponding to an input relative pathname (see class CReSuConcat below). The CBpssEntry destructor (p.35 line 14) deletes all CPosRgu objects in PosRguListBpss.

Class CPosRgu

Class CPosRgu (files PosRgu.h, pp.37-39; PosRgu.cpp, pp.40-43) represents a unit of positioned content. The primary CPosRgu constructor (p.40 line 17) takes a file data pointer reference as input (see discussion of CZshFileEntry::data_start above), reads data defining the characteristics of one map information component, and increments the reference so that it points to the next component. The constructor reads successively into member variables representing top left coordinates of the component area in macroblock units (mbxRguTL, mbyRguTL: p.39 line 10), width and height of the component area in macroblock units (mbw, mbh: p.39 line 12), relative pathname of child map information (RguFile: p.39 line 18), relative pathname of web-format information for a series of scale values (CellURL[ ]: p.39 line 20), and relative pathname of substitute MIO image (SubMioImage: p.39 line 19). Assignments to member variables pointing to the CZshFileEntry for RguFile (ZshFileEntry: p.39 line 23), default CMioEntry implied by file stem of RguFile (RedMioEntry: p.39 line 24), and CMioEntry for SubMioImage (SubMioEntry: p.39 line 25), are left to class CEntryCache, the owner of all CBpssEntry objects. Protected function InitPosRgu (p.41 line 34) intializes member variables representing bottom right coordinates of the component area in macroblock units (mbxRguBR, mbyRguBR: p.39 line 14), pointer to parent component (CprUpward: p.39 line 26), pointer to an object that encapsulates web browser software functions (theWebBrowser: p.39 line 29), hilite state of the component as rendered (hiliteThickness, hiliteConfigs: p.39 line 34; constant values p.37 line 9), general purpose component-specific bit flags (didbits: p.39 line 37; currently used only by CCartConcat), and bit flags used by CEntryCache to keep track of preloading and predecoding states (prebits: p.39 line 38; constant values p.37 line 31). InitPosRgu calls protected function GenerateHiliteConfigs (p.42 line 21) to record the edge configuration of each macroblock-sized unit of the component area in hiliteconfigs, using an array of size mbw×mbh. Finally, the primary CPosRgu constructor initializes the value of a runtime flag indicating whether the component is being rendered as web browser content or MIO image (isHTMLCell: p.39 line 30), according to CPRPRIORITYRULE (General.h, p.27 line 46) and relative pathname usability.

A second CPosRgu constructor that takes no parameters (p.40 line 5) is used by CReSuConcat to create “disembodied” root CPosRgu objects (see class CReSuConcat below), and by CPosRguConcat to create 1-values for operator=(p.41 line 7), which copies field by field in the obvious manner except that it always initializes theWebBrowser to NULL. The function Offset (p.41 line 50) adds its input to the top left (mbxRguTL, mbyRguTL) and bottom right (mbxRguBR, mbyRguBR) coordinate pairs (see class CBpssEntry above). The function PosRguRect (p.42 line 2) puts the top left and bottom right coordinate pairs into a CRect (MFC class). The function IsMatch (p.⁴2 line 11) returns true if and only if its input is within the boundaries of the component area. Rendering code uses the function get_YUVrgu (p.43 line 3) to obtain pointers to decoded YUV image data via CPosRgu, and uses the function SubtractMbpad (p.43 line 14) to obtain coordinates with respect to the top left of an encoded fraction of the component area (MIO encodings may specify macroblock-unit amounts of padding surrounding the encoded fraction). SubtractMbpad returns true if and only if its output coordinates are outside the encoded fraction. Various inline get and set functions in the CPosRgu class definition operate in the obvious manner.

Class CPosRguConcat

Class CPosRguConcat (files PosRguConcat.h, pp.44-46; PosRguConcat.cpp, pp.47-54) encapsulates operations on the CPosRgu objects of one level. CPosRguConcat contains two linked lists of CPosRgu objects (p.45 line 46): PosRguListSel defines a selection range, and PosRguListUns contains all other (unselected) material within a “preload” perimeter at the same level; type CPRList is an instance of MFC template class CTypedPtrList (file PosRgu.h, p.39 line 46). Member variable SRmbBounds (p.45 line 48) maintains the bounding rectangle of the selection range in macroblock units, while member variable TotmbBounds (p.45 line 49) maintains the bounding rectangle of both lists combined in macroblock units. The CPosRguConcat constructor (p.47 line 5) initializes bounding rectangles to match initially empty CPRLists, and gives the default value of false to member variable flags (p.45 line 51) representing whether the object is a CCartConcat (iscart), whether the object's level is level 0 (islevelmin), whether the object's level is root child level (islevelmax), and whether the object is designated as having the mall configuration property (ismall). The functions of CPosRguConcat may be divided into 5 categories as follows:

1) CPRList management (p.44 line 37, p.45 line 22): The functions DeleteSel (p.47 line 38) and DeleteUns (p.47 line 45) call protected function DeleteList (p.47 line 49) to delete the CPosRgu objects in PosRguListSel and PosRguListUns respectively; each of the CPRList-deleting functions returns true if and only if something is deleted. The function UnSelectAll (p.48 line 13) transfers all of a level's CPosRgus into PosRguListUns in the obvious manner. The function SelectAll (p.48 line 2) transfers all of a level's CPosRgus into PosRguListSel, unless its input is false, in which case it excepts all CPosRgus with isHTMLCell turned on. SelectAll uses protected function UnsToSel (p.48 line 31) to transfer one CPosRgu given its position in PosRguListUns, and to expand SRmbBounds accordingly (mbBounds management below). Protected function SelToUns (p.48 line 39; not needed by UnSelectAll) transfers one CPosRgu given its position in PosRguListSel, and contracts SRmbBounds accordingly. The (mouesover-driven) autoselect mechanism of a CVidArea-owned rendering class uses SelToUnsTail (p.48 line 22) to do the equivalent of SelToUns for the CPosRgu at the tail position in PosRguListSel.

2) mbBounds management (p.44 line 44, p.45 line 28): Protected function ExpandmbBounds (p.49 line 16) expands its CRect& input as necessary to enclose the area of its CPosRgu* input. Protected function ContractmbBounds (p.49 line 27) sets its CRect& input to the union of CPosRgu areas in its CPRList& input, thereby removing the influence of its CPosRgu* input. The functions ComputeSRmbBounds (p.48 line 49) and ComputeTotmbBounds (p.48 line 57) compute SRmbBounds and TotmbBounds respectively from scratch using ExpandmbBounds. The functions ExpandSRmbBounds (p.49 line 8) and ContractSRmbBounds (p.49 line 12) call ExpandmbBounds and ContractmbBounds respectively with SRmbBounds as input.

3) Iterant callers, general (p.44 line 50, p.45 line 32): CPosRguConcat iterants allow class CEntryCache (as well as two CVidArea-owned rendering classes) to call functions within their own scope for each CPosRgu in PosRguListSel and/or PosRguListUns. Each iteration function signature (p.44 line 10) has a single CPosRgu* parameter; some return flags while others return no value. Protected functions Iterate (two signatures, p.52 line 19 and p.52 line 27) simply call an iterant for each CPosRgu in their input CPRList&. The functions IterateUns (two signatures, p.50 line 30 and p.50 line 34), IterateSel (p.50 line 38), and IterateAll (p.50 line 42) call Iterate for each CPosRgu in PosRguListUns, PosRguListSel, and both lists combined respectively. Protected function IterateStop works like Iterate except that it stops and returns true if any iterant call returns true; IterateUnsStop and IterateSelStop call IterateStop for each CPosRgu in PosRguListUns and PosRguListSel respectively. Derived class CCartConcat (see below) calls protected function AddCopy (p.52 line 47) to duplicate the contents of a CPRList using CPosRgu::operator=; AddCopy provides an optional iterant call that is not used by CCartConcat. Class CReSuConcat (see below) calls IterateAllRemove (p.50 line 55) to remove CPosRgus from PosRguListSel and PosRguListUns (but not delete the CPosRgus) which meet the condition of its iterant; a POSITION input to IterateAllRemove excepts CPosRgus at the head end of PosRguListUns from removal. A CVidArea-owned rendering class calls IterateSelToUns (p.51 line 25) to apply SelToUns to all CPosRgus in PosRguListSel which meet its iterant condition. The CVidArea-owned rendering class calls IterateGrabDelta (p.51 line 37) to transfer CPosRgus in either direction between PosRguListSel and PosRguListUns when the condition of its DeltaTest iterant is met; when the condition is met, IterateGrabDelta also calls iterantUns (UnsToSel case) or iterantSel (SelToUns case) to perform additional per-CPosRgu work. An input flag canSelectHTML, when false, excepts CPosRgus with isHTMLCell turned on.

4) Iterant callers, cpr match finding (p.45 line 7, p.45 line 39): Protected function FindMatch (p.53 line 29) attempts to find a CPosRgu in its CPRList& input whose area contains the input point (mbxc,mbyc). The CVidArea-owned rendering class calls FindMatchUns (p.53 line 6) and FindMatchSel (p.53 line 17) to perform FindMatch on PosRguListUns and PosRguListSel respectively, and to call UnsToSel and SelToUns respectively for the matching CPosRgu when an optional iterant returns true.

5) Utility (p.45 line 13, p.45 line 42): Inline functions (p.45 line 14) CountSel and CountUns return the list lengths of PosRguListSel and PosRguListUns respectively. The function LoneCprSel (p.53 line 45) returns a pointer to the lone CPosRgu in PosRguListSel, or NULL if CountSel is 0 or more than 1. Class CRepArea (see below) calls the function get_PricePerSel (p.53 line 49) to obtain a price total for PosRguListSel. get_PricePerSel and various CCartConcat functions (see below) use protected function ItemPrice (p.54 line 2) to obtain a price datum through a CPosRgu. Various inline get and set functions in the CPosRguConcat class definition operate in the obvious manner.

Class CEntryCache

Class CEntryCache (files EntryCache.h, pp.55-56; EntryCache.cpp, p.57-63) manages RGU and MIO file data in a series of CTypedPtrLists (p.56 line 7) using perimeter-based algorithms. PanEntryList contains CPanEntry* elements; BlkEntryList, PagEntryList, SecEntryList, and SurEntryList contain CBpssEntry* elements for Blocks, Pages, Sections, and Surfaces respectively (see FIG. 8); RedMioEntryList and SubMioEntryList contain CMioEntry* elements for default and substitute MIO files respectively. The CEntryCache constructor (p.57 line 7) sets the base directory string basedir (p.56 line 4) to the empty string, (and sets basedirlen=0) pending a call to set_basedir.

The function readMio (p.58 line 1; called by PreloadOne, see below) calls SearchForMioEntry (p.58 line 17) to check whether a CMioEntry corresponding to its input MioFile already exists in RedMioEntryList, or SubMioEntryList if the input flag isSubMio is set. If the linked list entry does not already exist, readMio creates a new CMioEntry for MioFile (reading the file), and adds the CMioEntry* to the list. Class CReSuConcat calls SearchForBpssEntry (p.58 line 30) to check whether a CBpssEntry corresponding to its input RguFile already exists in one of the CBpssEntry* lists; SearchForBpssEntry uses the utility function GetRguType (p.59 line 30; also called by PreloadOne and elsewhere) to convert from file extension to rgutype value (rgutype values for Surfaces, Sections, Pages, Blocks, and Panels are 4, 3, 2, 1, and 0 respectively). The function AddEntry (p.59 line 6; called by PreloadOne, see below) adds a newly created CPanEntry or CBpssEntry to the linked list defined by its rgutype input. The CEntryCache destructor (p.57 line 14) calls PurgeZshFileEntries (p.57 line 21) and PurgeMioEntries (p.57 line 41) to delete all CZshFileEntrys and CMioEntrys respectively (and remove their pointers from the linked lists).

Under the control of CReSuConcat, the function PreloadChildren (p.59 line 50) reads the fraction of a parent RGU's components that lie within a programmable preload perimeter, and calls PreloadOne (p.60 line 39) for each such component newly within perimeter. PreloadOne in turn reads MIO files and child map information for the preloaded component, and calls CBpssEntry::InitPosRguList to create CPosRgu objects for all components of the child map information. PreloadChildren manages the preload state of every CPosRgu using three bits in CPosRgu::prebits; the INPERIMPRELOAD bit is set if and only if a CPosRgu is within the preload perimeter subsequent to PreloadChildren; the INMEMPRELOAD bit is set if and only if a CPosRgu's MIO images and child map information are residing in memory (the operations of PreloadOne) subsequent to PreloadChildren (or subsequent to root CPosRgu replacement; see class CReSuConcat below); the REMOVEPERIMPRELOAD bit is set if and only if the caller of PreloadChildren (CReSuConcat::PreloadChildrenAtLevel, see below) should remove a CPosRgu from PosRguListUns or PosRguListSel of the appropriate CPosRguConcat; removing such CPosRgus restores the property that PosRguListUns and PosRguListSel (combined) contain exactly those CPosRgus (from all parent-level CBpssEntry::PosRguListBpss members combined) that are within the preload perimeter.

In detail: PreloadChildren iterates through PosRguListBpss of its input, a parent CPosRgu* which must represent a CBpssEntry, not a CPanEntry. For each CPosRgu in the parent's PosRguListBpss, if CCoordSys::isInPerimPreload (member variable theCoordSys: p.56 line 1) returns false, and if the CPosRgu was previously INPERIMPRELOAD (p.60 line 5), PreloadChildren turns INPERIMPRELOAD off and sets the REMOVEPERIMPRELOAD bit to have the CPosRgu removed from PosRguListUns or PosRguListSel of the appropriate CPosRguConcat. If CCoordSys::IsInPerimPreload returns true and the CPosRgu is not already INPERIMPRELOAD (p.60 line 12), PreloadChildren turns INPERIMPRELOAD on, adds the CPosRgu to PosRguListUns of the appropriate CPosRguConcat (member variable PosRguListPreloadRec: p.56 line 16), and calls PreloadOne as long as INMEMPRELOAD is not already set. Upon preloading the CPosRgu, PreloadChildren overwrites RguFile of its CZshFileEntry, since the parent is known (and must not conflict with any RguUpward read from file), and sets INMEMPRELOAD.

In detail: PreloadOne first verifies that the RguFile member (relative pathname of .sur, .sec, .pag, .blk, or .pan file) of its input CPosRgu* is valid, returning false if invalid to indicate that preloading has failed. When RguFile is valid, PreloadOne calls readMio on RguFile to read the default MIO image, and sets CPosRgu::RedMioEntry to the resulting CMioEntry*. PreloadOne then creates either a new CPanEntry or a new CBpssEntry, depending on he result of GetRguType, sets CPosRgu::ZshFileEntry to the pointer returned by operator new, and calls AddEntry for the same (see above). In CBpssEntry cases, PreloadOne furthermore calls CBpssEntry::InitPosRguList (see above) to create CPosRgu objects for all components of the child map information, and to offset child map information; if input (and parameter to CBpssEntry::InitPosRguList) testbounds is set, CBpssEntry::InitPosRguList adds to CBpssEntry::PosRguListBpss only those components which pass a test on their bounding rectangle (see above). Finally, PreloadOne reads the substitute MIO image (as long as its pathname is valid), and returns true to indicate that preloading has succeeded.

The function PredecodeOne (p.61 line 26) decodes the MIO images of its input CPosRgu* if the CPosRgu lies within a programmable predecode perimeter, which is generally not larger than the programmable preload perimeter; class CReSuConcat calls PredecodeOne for all CPosRgus in PosRguListUns and PosRguListSel of a given CPosRguConcat. PredecodeOne manages the predecode state of every CPosRgu using two bits in CPosRgu::prebits; the INPERIMPREDECODE bit is set if and only if a CPosRgu is within the predecode perimeter subsequent to PredecodeOne; the INMEMPREDECODE bit is set if and only if a CPosRgu's decoded image data is residing in memory subsequent to PredecodeOne. If CCoordSys::IsInPerimPredecode (member variable theCoordSys) returns false, and if the CPosRgu was previously INPERIMPREDECODE (p.61 line 32), PredecodeOne turns INPERIMPREDECODE off. If CCoordSys::IsInPerimPredecodc returns true and the CPosRgu is not already INPERIMPREDECODE (p.61 line 37), PredecodeOne turns INPERIMPREDECODE on, and performs decoding as long as INMEMPREDECODE is not already set. Upon calling decode and downscaling functions for each of CPosRgu::RedMioEntry and CPosRgu::SubMioEntry, PredecodeOne sets INMEMPREDECODE.

Class CReSuConcat uses iterant functions RemoveRegardless (p.62 line 1) and RemovePerimPreload (p.62 line 9) in calls to the aforementioned CPosRguConcat::IterateAllRemove. RemovePerimPreload returns true whenever the REMOVEPERIMPRELOAD bit of CPosRgu::prebits is set, thereby causing the removal of a CPosRgu from PosRguListUns or PosRguListSel. If returning true, RemovePerimPreload also disengages any associated web browser software code with a call to the DeleteBrowser iterant (see below), and clears the REMOVEPERIMPRELOAD bit. RemoveRegardless always disengages any associated web browser software code, and always returns true; CReSuConcat uses RemoveRegardless as a prelude to repopulating PosRguListUns and PosRguListSel (see below).

Class CReSuConcat uses iterant functions DeleteBrowser (p.62 line 19), MoveBrowser (p.62 line 30), and BrowserOnOff (p.62 line 42) in calls to the aforementioned CPosRguConcat::IterateUns to manage the state of web browser software interfaces associated with CPosRgus of a given level. The function DeleteBrowser uninstantiates an instantiated CWebBrowser2 object by destroying its window and deleting the CWebBrowser2 object. The function MoveBrowser moves the CWebBrowser2's window responsively to lateral navigational actions (eg with the WM_MOVEBROWSERS message; see class CZooshCtrl above). If CCoordSys::IsInPerimPreload returns false, BrowserOnOff turns web browser processing off via DeleteBrowser; if CCoordSys::IsInPerimPreload returns true, BrowserOnOff tries to turn web browser processing on via protected function InstantiateBrowser (p.62 line 54). If CPosRgu::isHTMLCell is set, if the CPosRgu's CellURL string is valid, and if the CPosRgu does not already have an associated web browser interface, InstantiateBrowser creates a new CWebBrowser2 object using the CPosRgu's rectangle, and navigates to the CEcIURL; member variable parentCWnd (p.56 line 2) holds a pointer to the containing CVidWnd (see below).

Class CCoordSys

Class CCoordSys (files CoordSys.h, pp.64-69; CoordSys.cpp, pp.70-78) manages a variety of dimension and coordinate variables serving many different classes. CCoordSys determines a lower-order scaling ratio range (multiplierLim, multiplierMin: p.67 line 39) according to video memory limitations, computes buffer dimensions (vbwidth, vbheight, etc: p.68 line 4) according to the lower-order scaling ratio range and inputs (mbwround, mbhround: p.67 line 55) derived from client view dimensions (clientwidth, clientheight: p.67 line 45), computes source coordinates from destination coordinates and vice versa using integer-arithmetic linear transformations (multiplier, multiplierBase: p.67 line 37; xSrcFix, ySrcFix: p.68 line 18; macros xSrcFromDst, ySrcFromDst, etc: p.64 line 25), tracks within-view mouse position (xcurrent, ycurrent: p.67 line 49), tracks destination view coordinates (xDstViewTL, yDstViewTL: p.68 line 20) responsively to lateral navigation, updates source view coordinates and related values (xSrcViewTL, ySrcViewTL, etc: p.68 line 24; xViewAdj, yViewAdj: p.68 line 14) according to changes in destination view coordinates or transformation parameters, manages the higher-order (power of 2) part of the scaling ratio (scale, etc: p.67 line 32) and related values (xVVpad, yVVpad: p.68 line 12) under user control, maintains a set of restorable initial navigational values (initscale, etc: p.68 line 36), and manages all preload and predecode perimeter calculations (PerimPreload, PerimPredecode, etc: p.68 line 44; wPreloadConst, hPreloadConst, etc: p.68 line 52).

The CCoordSys constructor (p.70 line 5) determines a lower-order scaling ratio range, computes buffer dimensions, and computes preload and predecode perimeter rectangles. The lower-order scaling ratio is S=multiplier/multiplierBase, where multiplierMin<=multiplier<multiplierLim. The value of multiplierBase is currently fixed at CODEDUNITSIZE==0×10 (p.70 line 8), for convenience in working with widths and heights of macroblock granularity; in fact, calculations in the coordinate transformation macros (p.64 line 25) and elsewhere use bit shifts of CODEDUNITPOWER==4 bits, rather than explicitly multiplying or dividing by multiplierBase. Zoosh implements the higher-order scaling ratio as a power of 2 (ie scale==0=> no decimation, scale==1=> decimate source widths and heights by factor of 2, etc), so that the largest reasonable value of multiplierLim is multiplierBase * 2, and so that it is reasonable to assign multplierMin=multiplierLim/2 (p.70 line 20); multiplierSpan=multiplierLim−multiplierMin (p.70 line 21) is used in defining and interpreting vertical scrollbar increments in the mechanism that integrates user control of scaling and level jumping (function TrackScalePos; see below).

After storing input values for up-rounded client area width and height in macroblock units (mbwround, mbhround: p.70 line 15) and screen buffer width and height in macroblock units (mbwprimary, mbhprimary: p.70 line 17), the CCoordSys constructor calls protected function DetMultiplierLim (p.71 line 12) to calculate buffer dimensions, first reducing a suggested value of multiplierLim (p.71 line 36, p.71 line 43) if necessary. In general, Zoosh implements a primary buffer area composed of 4 separate quadrants, each with its own DirectDraw surface, due to the common inability to allocate video buffer widths larger than primary; this is independent of the 4 quadrants created by doubly circular wraparound (see below). DetMultiplierLim outputs the total width and height of all 4 buffers in macroblock units at scale 0 (mbwidth0, mbheight0: p.71 line 52), the total width and height in pixels independent of scale (vbwidth, vbheight: p.72 line 14), the width of the left column and height of the top row of buffers in macroblock units at scale 0 (mbxseam0, mbyseam0: p.72 line 1; see comment), and the widths of both columns and heights of both rows in pixels independent of scale (vbwleft, vbhtop, vbwright, vbhbottom: p.72 line 16). In the event that certain flags are set in its ddSystem* input, DetMultiplierLim sidesteps video card bugs with an assignment (p.72 line 11; see comment) that eliminates allocation of the bottom 2 buffers. DetMultiplierLim drives all of these outputs with the two quantities mbwreq, mbhreq, corresponding to one half the eventual mbwidth0, mbheight0; initial values of mbwreq, mbhreq are computed by transforming the total destination dimensions mbwround, mbhround into source dimensions using the suggested value of multiplierLim (with up-rounding), dividing by 2, and adding the predefined minimum padding amounts MBXVVPADREQ, MBYVVPADREQ (p.71 line 16). It is sometimes advantageous to have buffer sizes that are multiples of a power of two that is larger than CODEDUNITSIZE; DetMultiplierLim therefore rounds initial values of mbwreq, mbhreq upward using the constant GYROPOWERPIECEBIG (p.71 line 25). Finally, even with 4 buffers, it is conceivable that such mbwreq may be larger than mbwprimary, or that such mbhreq may be larger than mbhprimary; DetMultiplierLim therefore reduces both by the same factor if necessary, after determining which of the x or y axis is most limiting (p.71 line 34).

The CCoordSys constructor finally stores client view dimensions (clientwidth, clientheight: p.70 line 24) for later reference, stores initial values of within-view mouse position (xcurrent, ycurrent: p.70 line 26; rounded to even), stores the values of two flags (AllowingOddXSrc, AllowingOddXDst: p.70 line 29) defining whether odd x coordinates are permitted for source and destination respectively, and calculates destination widths and heights (wPreloadConst, hPreloadConst, etc: p.70 line 35) from which the positioned source rectangles PerimPreload and PerimPredecode will eventually be calculated. Current-level destination predecode perimeter width and height (wPredecodeConst, hPredecodeConst: p.70 line 33) are calculated by adding predefined constants (WPREDECODEAPRON, HPREDECODEAPRON: p.64 line 12) to the total buffer width and height (vbwidth, vbheight); similarly, current-level destination preload perimeter width and height (wPreloadConst, hPreloadConst; p.70 line 35) are calculated by adding predefined constants (WPRELOADAPRON, HPRELOADAPRON: p.64 line 14) to the total buffer width and height. In general, the preload apron width and height should not be smaller than the predecode apron width and height. Upward-level and downward-level destination perimeter widths and heights are calculated by successively scaling with separate predefined constants (APRONFACTORUP, APRONFACTORDOWN; p.64 line 16); thus for example, the preload perimeter for one level upward can be made smaller by an arbitrary factor, even though the level-to-level scaling factor is a power of 2 in each of width and height (factor of 4 in examples to follow). Using APRONFACTORUP=0.75>0.25 is a reasonable “excess” because the preload perimeter tree (like any tree) has fewer nodes toward the top, so that preloading more CPosRgus than necessary results in relatively little waste of memory and processing time. Conversely, using APRONFACTORDOWN=1.0<4.0 is a reasonable means of restricting the number of nodes at the bottom of the preload perimeter tree, and thereby limiting the expenditure of memory and processing time.

CCoordSys maintains a variable source-space scaling center (xSrcFix, ySrcFix: p.68 line 18), while the destination-space scaling center is always chosen as (0,0). Thus, macros xSrcFromDst and ySrcFromDst (p.64 line 25) convert destination coordinates to source coordinates by applying the lower-order scaling ratio S=multiplier/multiplierBase and then adding xSrcFix and ySrcFix respectively; conversely, macros xDstFromSrc and yDstFromSrc (p.64 line 28) convert source coordinates to destination coordinates by subtracting xSrcFix and ySrcFix respectively and then applying the lower-order scaling ratio (inverse). Macros SrcOffFromDstOff (p.64 line 27) and DstOffFromSrcOff (p.64 line 30) interconvert offsets and do not reference xSrcFix, ySrcFix. Using integer arithmetic and shifting by CODEDUNITPOWER instead of multiplying or dividing by multiplierBase speeds computation. The function UpdateFix (p.75 line 45; see comment) provides a means of updating xSrcFix, ySrcFix in such a way that it is not necessary to re-render the entire buffer when only the lower-order scaling ratio changes. UpdateFix operates by locating the new scaling center at approximately the center of the view region (with rounding: local destination-space variables col, row: p.76 line 18), and updating xSrcFix, ySrcFix (p.76 line 24) as well as xDstViewTL, yDstViewTL (p.76 line 22; see below) accordingly. Inputs upxDst, uwDst==1 <<upxDst, upyDst, uhDst==1<<upyDst represent the destination sizes of smallest blittable units, while inputs uwSrc, uhSrc represent source-space counterparts. If the input flag useMouse is set, UpdateFix locates the new scaling center at approximately the current mouse position instead; inline protected function GetCenter (p.67 line 4) returns (in its reference inputs) either the center of the view or the current mouse position, depending on input flag useMouse.

The function SetViewCoords (p.74 line 48) is called by CVidArea::OnMouseMove (see examples) to track within-view mouse position in xcurrent, ycurrent; SetViewCoords also stores the difference (xdcurr, ydcurr: p.74 line 50) between its inputs and xcurrent, ycurrent, rounded to even, and returns true if and only if xdcurr or ydcurr is nonzero. Keyboard-driven lateral navigation (eg arrow key message handling) uses the function SetViewDeltas (p.75 line 2) to set xdcurr, ydcurr without changing xcurrent, ycurrent. The function UpdateSrcTLCoords (p.74 line 11) uses xdcurr, ydcurr to drive top left destination view coordinates (xDstViewTL, yDstViewTL), which in turn drive top left source view coordinates (xSrcViewTL, ySrcViewTL) using the aforementioned transformation macros, which in turn drive a pixel-resolution “desired” video buffer top left (local variables xSrc, ySrc; see comment) through the addition of nominal padding amounts (xVVpad, yVVpad). However, since buffer top left coordinates change only in units of macroblock granularity, xSrc, ySrc are rounded to nearest (p.74 line 24) using mbunitpower (power of 2 representing size of macroblock as decreasing function of scale) and mbunithalf (half the macroblock size). The function SetScale (p.73 line 41; called during coordinate system initialization and scale tracking; see below) computes each of the values xVVpad, yVVpad, mbunitpower, and mbunithalf as functions of scale, in addition to setting scale and multiplier according to its inputs. UpdateSrcTLCoords stores source buffer top left coordinates in the niacroblock-granularity values mbxVideoTL, mbyVideoTL, and computes pixel-resolution padding adjustments xViewAdj, yViewAdj (p.74 line 28) which counteract the rounding done in computing xSrc, ySrc. FIG. 10 shows the general relationship between buffer coordinates and source view coordinates in a coordinate system whose origin is xSrcFix, ySrcFix (1010, 1020); buffer top left coordinates (xVideoTL, yVideoTL; 1011, 1021; see get-xVideoTL, get_yVideoTL: p.67 line 9) depend on mbxVideoTL, mbyVideoTL in the obvious manner; source view top left coordinates (xpSrc, ypSrc; 1012, 1022; see get-xpSrc, get_ypSrc: p.65 line 50) are formed by adding total padding amounts xVVpad+xViewAdj, yVVpad+yViewAdj to the buffer top left coordinates; and bottom right coordinates xmSrc, ymSrc, xVideoBR, yVideoBR (1013, 1023, 1014, 1024; see get functions) are computed similarly.

FIG. 10 also uses dotted lines to show quadrants of the source view and buffer areas as they appear in the coordinate system of the buffer itself, under the modulo arithmetic of doubly circular wraparound; the four quadrants (1030-1033) occupy reversed positions within the buffer 1002 as compared to the unwrapped coordinate space, as do four corresponding quadrants of margin area. UpdateSrcTLCoords computes the macroblock-granularity wraparound point (mbxVideoTLrem==mbxVideoTL modulo get_mbwidth, mbyVideoTLrem==mbyVideoTL modulo get_mbheight) using addition and subtraction instead of division (p.74 line 35, p.74 line 40). The pixel-resolution wraparound values xVideoTLrem, yVideoTLrem in FIG. 10 relate to mbxVideoTLrem, mbyVideoTLrem in the obvious manner.

Class CVidArea calls the function TrackScalePos (p.75 line 13) to calculate level, scale, and multiplier values from vertical scrollbar position (input scalepos), and to call SetScale for the resulting scale and multiplier values. The total number of increments in the vertical scrollbar mechanism is multiplierSpan (see above) * numscales, where numscales is generally rgutyperoot * SCALESPERLEVELJUMP (see CChildSwitch::SetScrollRangeVid; see below). The SCALESPERLEVELJUMP value of 2 used in all examples to follow means that the “level-to-level” scaling factor is 2 powers of 2, or 4 in each of width and height. A potential point of confusion is that “level” variables in class CReSuConcat and elsewhere increment by SCALESPERLEVELJUMP (not 1) for each jump between adjacent rgutypes at constant scale. Vertical scrollbar gradations are also inverted, so that smaller scale and level values correspond to larger scalepos values (closer to bottom of computer screen in vertical scrollbar). TrackScalePos thus first inverts its input scalepos using member variable scaleposmax (total number of increments less 1), then computes local variables scaleTarg and multTarg, and reference input levelTarg (return value used by caller) in the obvious manner. TrackScalePos finally calls SetScale, and returns the difference between new and previous scale values for caller's use. As described in classes CChildSwitch and CReSuConcat below, calls to UpdateFix and TrackScalePos are first steps taken by a mechanism which integrates user control of level jumping and finer-grained scaling.

The function DefInitCoords (p.72 line 51) copies initial navigational values from a CURLHistEntry object (see below) into member variables initscale, initmultiplier, initxSrcFix, initySrcFix, initxDstViewTL, and inityDstViewTL, and (eventually) calls protected function InitCoordSys (p.73 line 28) to initialize scale, multiplier, xSrcFix, ySrcFix, xDstViewTL, and yDstViewTL with same. InitCoordSys then calls protected function InitSrcTLCoords (p.73 line 53) to initialize source coordinate values which depend upon the initialized values (ie by calling UpdateSrcTLCoords; see above). InitSrcTLCoords defines an arbitrary modulo pairing (mbxVideoTL==mbxVideoTLrem==0, mbyVideoTL==mbyVideoTLrem==0) as preparation for the call to UpdateSrcTLCoords; any valid modulo pairing would suffice. The variables initscale, initmultiplier, etc, are not used as the actual data source in restoring initial values; CChildSwitch reinitializes by calling DefInitCoords a second time, third time, etc. The “init” values are member variables so that function CompareFixInit (p.77 line 6) can compare them to current values, returning true if and only if current and “init” values are equal; CompareFixInit and protected function CompareFix cut corners by checking only xSrcFix, ySrcFix, xDstViewTL, and yDstViewTL. When CChildSwitch first calls DefInitCoords (ie, right after the constructor call), it sets input flag doFixDest true; in this scenario, CReSuConcat has loaded an initial RGU file (CURLHistEntry::URL), but has not yet acted upon CURLHistEntry::LevelDelta, which instructs Zoosh to navigate some number of levels away from the initial RGU's level. In order to interpret initial coordinate values as applying to the RGU's URL-implied level+LevelDelta, DefInitCoords pre-compensates initxSrcFix, initySrcFix, initxDstViewTL, and inityDstViewTL (p.73 line 4; see comment and later example) using the macro FixDestCalc (p.72 line 25). FixDestCalc has the effect of scaling its (reference) inputs according the number of scale increments scaledelta, with respect to the center point xc, ye; scaledelta <0 leads to scaling as if descending levels, while scaledelta >0 leads to scaling as if ascending levels. DefInitCoords negates CURLHistEntry::LevelDelta in order to provide pre-compensation. The function FixDestScale (p.75 line 30), called by CChildSwitch when there is a change in level or scale (for example after CVidArea calls TrackScalePos, when necessary) uses FixDestCalc to modify values of xSrcFix, ySrcFix, xDstViewTL, and yDstViewTL which already exist: this is how Zoosh keeps its coordinate system consistent across changes in level and scale. FixDestScale also calls InitSrcTLCoords (p.75 line 41), since changes in scale mean changes in get_mbwidth and get_mbheight, which invalidates the existing modulo pairing (mbxVideoTL=> mbxVideoTLrem, mbyVideoTL=>mbyVideoTLrem). Although CompareFixInit (see above) is capable of incorporating a call to FixDestCalc, this capability is not currently in use.

Whenever navigational actions produce changes in view coordinates, CChildSwitch causes CReSuConcat to call DetPerimeters (p.77 line 41) to recalculate and store the positioned source rectangles PerimPreload and PerimPredecode; positioned source-space perimeter rectangles facilitate comparison against CPosRgu coordinates. DetPerimeters first initializes and loops for current and upward positioned perimeters (p.77 line 51), then initializes and loops for downward positioned perimeters (p.78 line 21). Only one PerimPreload rectangle and one PerimPredecode rectangle are calculated per rgutype, since scale is considered constant for purposes of preloading and predecoding at levels other than current (ie, the function IsInPerimPreload and the function IsInPerimPredecode use the same value of mbunitpower regardless of level; see below). DetPerimeters initializes local variables xSrcFixDP, ySrcFixDP, xDstViewTLDP, and yDstViewTLDP to the existing xSrcFix, ySrcFix, xDstViewTL, and yDstViewTL, then computes positioned destination perimeters from destination perimeter widths and heights (CCoordSys constructor; see above) and xDstViewTLDP, yDstViewTLDP so as to center each perimeter rectangle about the current view area (p.78 line 1, p.78 line 11, p.78 line 36, p.78 line 46), simultaneously applying specialized macros xSrcFromDstDP and ySrcFromDstDP to transform into positioned source perimeters (p.78 line 2, p.78 line 12, p.78 line 37, p.78 line 47). Prior to each increment of rgutype, DetPerimeters uses the macro FixDestCalc (see above) to compensate xSrcFixDP, ySrcFixDP, xDstViewTLDP, and yDstViewTLDP for the change in level (p.78 line 17, p.78 line 52). The function IsInPerimPreload (p.76 line 39; called by CEntryCache::PreloadChildren; see above) returns true if and only if its input (macroblock-unit) rectangle overlaps PerimPreload[rgutypeperim], given the mbunitpower of current scale. The function IsInPerimPredecode (p.76 line 51; called by CEntryCache::PredecodeOne; see above) returns true if and only if its input (macroblock-unit) rectangle overlaps PerimPredecode[rgutypeperim], given the mbunitpower of current scale. CReSuConcat controls rgutypeperim with inline set function set_rgutypeperim (p.66 line 54).

Class CReSuConcat

Class CReSuConcat (files ReSuConcat.h, pp.79-80; ReSuConcat.cpp, pp.81-87) manages a hierarchy with RGUTYPE_COUNT==5 rgutypes (see FIG. 8). The values of “rgutype” variables such as rgutyperoot and rgutypecurrent (p.80 line 27) lie in the range 0 to RGUTYPE_COUNT−1, whereas the values of “level” variables such as levelroot, levelcurrent, and levelinit (p.80 line 24) lie in the range 0 to LEVELMAX=(RGUTYPE_COUNT−1) * SCALESPERLEVELJUMP; ie, SCALESPERLEVELJUMP==2=>rgutype 0 corresponds to level values 0 and 1, rgutype 1 corresponds to level values 2 and 3, etc. The function SetLevelCurrent (p.85 line 57) sets levelcurrent and rgutypecurrent according to an input level value; the function SetLevelRoot (p.86 line 7) sets levelroot and rgutyperoot according to an input level value. The CReSuConcat constructor (p.81 line 5) initializes level and rgutype values to a consistent state, and creates the one and only CEntryCache object theEntryCache. CReSuConcat maintains CPosRgu lists in an array of CPosRguConcats Concats[RGUTYPE_COUNT], and is given access by CChildSwitch to CCoordSys* theCoordSys (p.80 line 10; see class descriptions above). CReSuConcat algorithms insure that at any given moment, all CPosRgus in Concats[ ] are progeny of a root CPosRgu cprRoot (p.80 line 20); this property does not hold for CMioEntries or CZshFileEntrys in theEntryCache (ie for the CPosRgus which reference them). A flag isRootDisembodied (p.80 line 21) is true if and only if cprRoot is not an element in any CBpssEntry::PosRguListBpss. The functions of CReSuConcat may be divided into the categories 1) cprRoot management, 2) preloading and predecoding, and 3) web browser cell management:

1) cprRoot management (p.79 line 35, p.79 line 51): CChildSwitch::GoToHistEntry calls the function ReadRootRgu (p.83 line 42) to initialize cprRoot according to the relative pathname of a CURLHistEntry, and to initialize levelroot and levelcurrent accordingly. ReadRootRgu converts the input relpname's file extension to an rgutype value using inline function GetRguType (p.79 line 32; identical to CEntryCache::GetRguType), and continues only when this is a recognized non-leaf rgutype. ReadRootRgu calls ReplaceRoot (p.84 line 44) to load a newly created cprRoot with data for the RGU specified by relpname, then initializes levelroot and levelcurrent to the levels of relpname's rgutype and next lower rgutype respectively. ReadRootRgu calls FollowRootPath (see below) to attempt to raise the level of cprRoot by (as much as) the programmable number of levels ROOTJUMPTARGET, following CprUpward and/or RguUpward links and loading file data as necessary for RGUs in the path to the desired root. Raising the level of cprRoot broadens the area covered by root progeny at any given level (with respect to levelcurrent in particular), thus potentially increasing the number of comparisons against preload and predecode perimeters. Finally, ReadRootRgu calls DetIsLevelMax (p.86 line 14) to clear the islevelmax flag of all CPosRguConcats except rgutyperoot-1, and clear that of rgutyperoot-1 if and only if there is some known means of jumping upward from cprRoot (ie if cprRoot has either nonNULL CprUpward or nonempty predefined upward link ZshFileEntry::RguUpward). Only initialization and upward level jumping (but not downward level jumping) can necessitate setting islevelmax of Concats[rgutyperoot-1].

The function ReplaceRoot (p.84 line 44; called only by ReadRootRgu and FollowRootPath) replaces the existing cprRoot with a new disembodied eprRoot loaded with data for the RGU specified by input RguFile. After saving a pointer to the previous cprroot in cprRootPrev, creating a blank cprRoot, and setting its RguFile member, ReplaceRoot checks whether the CBpssEntry for RguFile already exists in theEntryCache, using CEntryCache::SearchForBpssEntry (p.84 line 56); if so, ReplaceRoot stores a pointer to the found CBpssEntry in cprRoot::ZshFileEntry, and sets child CPosRgu::CprUpward fields to point to cprRoot (p.85 line 1; see CBpssEntry::SetCprUpwardOfChildren above); otherwise, ReplaceRoot preloads cprRoot from scratch (p.85 line 8; see CEntryCache::PreloadOne above). If the isRootDisembodied flag was set for cprRootPrev, ReplaceRoot calls the function DeleteRootPrev (p.85 line 48) to delete cprRootPrev and eliminate any CprUpward references to it, while leaving its cache entries intact. If the upconnect input is false (eg random jumping as in the call from ReadRootRgu), CprUpward references to cprRootPrev are replaced with NULL (local variable cprPrevSub: p.85 line 20). If the upconnect input is true (eg upward path traversal as in the call from FollowRootPath), then cache entries for some child of the new cprRoot already exist. ReplaceRoot therefore finds that child CPosRgu using CBpssEntry::FindChildEntry (p.85 line 23), stores the result in cprPrevSub for use by DeleteRootPrev in replacing CprUpward references to cprRootPrev, copies cache entry pointers into cprRoot members, and sets INMEMPRELOAD for cprRoot (p.85 line 28). If the CBpssEntry for RguFile (belonging to new cprRoot) was found to exist in theEntryCache, then isRootDisembodied should be false (for cprRootPrev), and upconnect is turned off because it is unnecessary (p.85 line 6).

The function FollowRootPath (p.84 line 9) raises the level of cprRoot one rgutype at a time (from levelroot up to at most input levelrootmax in increments of SCALESPERLEVELJUMP), reassigning cprRoot to another PosRguListBpss-contained CPosRgu as long as CprUpward links are available (p.84 line 22), then if necessary attempting to go further using RguUpward links (p.84 line 28; RGU files can contain predefined upward links; see class CZshFileEntry above). FollowRootPath terminates early if an RguUpward string is invalid, or if ReplaceRoot were to fail in forming a new disembodied cprRoot from RguUpward.

Protected function DescendLevels (p.81 line 50) attempts to lower levelcurrent by the input amount levelsdown, and to update cprRoot accordingly. Rather than (iteratively) selecting some child of the existing cprRoot according to a spatial criterion (eg closest to center of preload perimeter), DescendLevels simply attempts to find an INPERIMPRELOAD CPosRgu that it can follow upward to the new cprRoot. DescendLevels begins by calling the preload algorithm (PreloadChildrenAtLevel; see below) for one level below the existing levelcurrent (as long as the preloadingdownward flag is not generally causing this to happen automatically; p.81 line 54). DescendLevels then updates levelcurrent and levelroot reversibly, saving previous values in case they must later be restored (p.81 line 57); levelroot can remain unchanged if levelcurrent and levelroot differ by less than ROOTJUMPTARGET on input (due to an unusable RguUpward link). DescendLevels then selects the first available INPERIMPRELOAD CPosRgu, giving precedence to PosRguListUns over PosRguListSel, starting at the updated rgutypecurrent (CPosRgus potentially just preloaded by PreloadChildrenAtLevel) and trying successively higher rgutypes up to rgutyperoot as necessary (p.82 line 16; see comment). If no such INPERIMPRELOAD CPosRgu is found, DescendLevels restores levelcurrent and levelroot to their states on input, and returns a leveldelta of 0 (p.83 line 5); otherwise, DescendLevels follows the found CPosRgu upward to the new cprRoot (p.82 line 37), deletes the previous cprRoot if it is disembodied and different from the new cprRoot (p.82 line 49), calls EmptyTreePerim to empty all Concats[ ] of all CPosRgus prior to repopulation by PreloadTopDown (see below), and returns the realized leveldelta. The function DescendLevelsStepped (p.81 line 32) has the same signature and does essentially the same thing as DescendLevels, except that it insures a valid target levelcurrent, descends in increments of SCALESPERLEVELJUMP instead of all at once, and terminates early if any DescendLevels iteration returns 0; DescendLevelsStepped is currently the only caller of DescendLevels.

The function AscendLevels (p.83 line 13) attempts to raise levelcurrent by the input amount levelsup, and to update cprRoot accordingly. AscendLevels first calls FollowRootPath to raise the level of cprRoot if possible: a target levelroot is computed from the target levelcurrent by adding the desired separation ROOTJUMPTARGET between levelcurrent and levelroot, then limiting to LEVELMAX (p.83 line 17). The target levelroot will be greater than the existing levelroot if and only if the existing levelroot is less than LEVELMAX; in addition, FollowRootPath will generally fail to raise levelroot when the existing separation is not fully ROOTJUMPTARGET, unless an unusable RguUpward link has since been made usable. AscendLevels next calls DetIsLevelMax, which is generally called after FollowRootPath in upward level jumping or initialization (see above). Finally, whether or not FollowRootPath changes levelroot, AscendLevels attempts to raise levelcurrent by the input amount levelsup, subject only to the basic limitation rgutypecurrent <=rgutyperoot-1 (p.83 line 22). AscendLevels returns the realized leveldelta. The function ReinitLevelRoot (p.83 line 27) uses either DescendLevelsStepped or AscendLevels to restore levelcurrent to levelinit; CChildSwitch and the CReSuConcat constructor call inline function SetLevelInit (p.79 line 31) to determine levelinit.

2) Preloading and predecoding (p.79 line 42, p.80 line 2): Class CChildSwitch calls the function UpdatePerimeters (p.86 line 36) to update CPosRgu lists in Concats[ ] (ie PosRguListUns and PosRguListSel for all rgutypes) in response to navigational actions such as changes in level, scaling, and mouse-down lateral navigation. UpdatePerimeters first calls the function DetPerimeters (p.86 line 28), which calls CCoordSys::DetPerimeters (after setting the CCoordSys copies of rgutypecurrent and rgutyperoot) to update the positioned source rectangles PerimPreload and PerimPredecode (see above). UpdatePerimeters then calls the function PreloadTopDown (p.86 line 45) to update CPosRgu lists for Concats[rgutyperoot-1] down through Concats[rgutypecurrent]; PreloadTopDown calls the function PreloadChildrenAtLevel (p.86 line 53) for each such rgutype. PreloadChildrenAtLevel sets CEntryCache::PosRguListPreloadRec (receiver of new CPosRgus; see above) to PosRguListUns of the input rgutype, sets CEntryCache::rgutypeperim, and then calls CEntryCache::PreloadChildren either once or for each preloaded parent CPosRgu, using CPosRguConcat::IterateAll with CEntryCache::PreloadChildren as iterant (see above) unless input rgutype is the root child rgutype. PreloadChildrenAtLevel finishes the update by calling CPosRguConcat::IterateAllRemove with CEntryCache::RemovePerimPreload as iterant (see above) to remove any CPosRgus with the REMOVEPEPIMPRELOAD bit set, beginning ahead of any newly added CPosRgus (local variable poshold).

UpdatePerimeters next calls the function PredecodeBottomUp (p.87 line 24) to decode MIO images for CPosRgus in Concats[rgutypecurrent] up through Concats[rgutyperoot-1]; PredecodeBottomUp calls CPosRguConcat::IterateAll with CEntryCache::PredecodeOne as iterant for each such rgutype (see above; CEntryCache::PredecodeOne decodes for all CPosRgus newly within the programmable decode perimeter). Finally, if the optional flag preloadingdownward (p.80 line 31) is set, UpdatePerimeters calls PreloadAndDecodeDownward (p.87 line 34) to operate on Concats[rgutypecurrent-1], which uses the aforementioned PreloadChildrenAtLevel to preload and CPosRguConcat::IterateAll with CEntryCache::PredecodeOne as iterant to decode. Eventually, CChildSwitch will call the function EmptyTreePerim (p.87 line 15) to remove all CPosRgus from all CPosRguConcats; CChildSwitch calls EmptyTreePerim either from its destructor or in jumping to a new and potentially unrelated history entry. EmptyTreePerim calls CPosRguConcat::IterateAllRemove with CEntryCache::RemoveRegardless as iterant (see above), but does not modify the contents of CEntryCache.

3) web browser cell management (p.79 line 46): the functions DeleteBrowsers (p.87 line 56), BrowsersOnOff (p.87 line 45), and MoveBrowsers (p.87 line 52) call CPosRguConcat::IterateUns for rgutypecurrent with CEntryCache::DeleteBrowser, CEntryCache::BrowserOnOff, and CEntryCache::MoveBrowser respectively as iterant. Class CChildSwitch uses DeleteBrowsers to turn off (uninstantiate and possibly replace with an MIO image) all browser cells in (the current) PosRguListUns, uses BrowsersOnOff to switch browser cell states according to whether or not they are inside the preload perimeter, and uses MoveBrowsers to reposition browser cells after navigational actions such as mouse-down lateral navigation.

Class CURLHistEntry

Class CURLHistEntry (files URLHistEntry.h, p.88; URLHistEntry.cpp, p.89) stores a set of initial navigational values which together define an clement of navigational history: URL contains a relative pathname to be navigated to (as in parameters to CReSuConcat::ReadRootRgu and CWebBrowser2::Navigate); Config contains “configuration” bits which can be set from the control container environment, currently limited to the mall configuration bit CONFIGMALL (see mall example); LevelDelta instructs Zoosh to navigate some number of levels away from an initial RGU's level (see CChildSwitch::GoToHistEntry below, and CCoordSys::DefInitCoords above). Scale, Multiplier, xSrcFix, ySrcFix, xDstViewTL, and yDstViewTL contain initial scaling and coordinate values as discussed under class CCoordSys above. The CURLHistEntry constructor accepts input values for URL and Config, assigns to Scale and Multiplier the constants DEFINITSCALE and DEFINITMULTIPLIER respectively, and sets the remaining values to a default of 0; all CURLHistEntry member variables can be set from the control container environment (see get/set properties for class CChildSwitch, below).

Class CChildSwitch

Class CChildSwitch (files ChildSwitch.h, pp.90-92; ChildSwitch.cpp, pp.93-104) manages the division of Zoosh area amongst child windows, coordinate system initialization, hierarchical navigational actions, branching history, and toggling to and from a shopping cart display. The CChildSwitch constructor (p.93 line 7) creates the one and only CReSuConcat object theReSuConcat, creates the one and only CCartConcat object theCartConcat (shopping cart data; see below), NULLs a pointer to the one and only direct draw management object theddSystem, and NULLs a pointer to the one and only coordinate system object theCoordSys (pending creation of theddSystem and theCoordSys by InitChildAreas; see below). The CChildSwitch constructor then creates CWnd-derived child window objects theVidCWnd (class CVidWnd), theToolCWnd (class CToolWnd), and theRepCWnd (class CRepWnd) for managing the main content area, toolbar area 900, and reporting area 901 respectively (see FIG. 9A; ComputeChildRectangles will later compute the dimensions of these areas, and CreateChildWindows will provide their HWNDs). The CChildSwitch constructor also identifies theVidCWnd to theReSuConcat::theEntryCache as parent of embedded web browser controls (as in CEntryCache::InstantiateBrowser; see above), and allocates a CWebBrowser2 object theNoZoomBrowser which in some circumstances replaces theVidCWnd (case !inzoomingmode; sec below). The CChildSwitch constructor then sets the default values of three flags (p.92 line 34): inzoomingmode to false (inzoomingmode is not set true until successful return from CReSuConcat::ReadRootRgu; see GoToHistEntry below); inshoppingmode to true (case !inshoppingmode applies only to editing functions not disclosed herein), and inshoppingcart to false (indicating that a user will initially view the contents of theReSuConcat, not theCartConcat). Finally, the CChildSwitch constructor adds a blank first history entry to theURLHistory (one and only linked list of CURLHistEntry objects), initializes the current history entry position posURLHist, and creates a dummy history entry cheCart as a convenience for case inshoppingcart (see UpdateHistEntry and calls to CCoordSys::DefInitCoords below).

The CChildSwitch destructor (p.93 line 42) deletes CChildSwitch-owned objects in the reverse order of their handling by the CChildSwitch constructor, and calls cleanup functions as necessary to delete objects owned by CChildSwitch-owned objects. The CChildSwitch destructor calls protected function EmptyURLHistory (p.104 line 13) to delete all CURLHistEntry objects in theURLHistory, calls the function DeleteBrowsers (p. 100 line 33) to turn off (via CReSuConcat::DeleteBrowsers; see above) all browser cells in the current PosRguListUns, calls protected function CleanChildAreas (p.94 line 35) to delete buffers owned by theVidCWnd::theVidArea (rendering class CVidArea) and delete theCoordSys, calls protected function DestroyChildWindows (p.94 line 51) to destroy HWNDs, and deletes their associated CWnds (p.93 line 52). The CChildSwitch destructor finally calls CCartConcat::DeleteAll to delete all shopping cart CPosRgus (see below) before deleting theCartConcat (transmission of shopping cart data to server-side processing functions must precede this call), and calls protected function CleanReSu (p. 100 line 46) to remove all CPosRgus from theReSuConcat (via CReSuConcat::EmptyTreePerim; see above) before deleting theReSuConcat.

In a normal initialization sequence, CZooshCtrl first calls the CChildSwitch constructor, then script language statements in the control container environment set Zoosh properties to specify a base directory (OnZooshBaseChanged calls set_basedir) and override default initial navigational values in a first CURLHistEntry object, then CZooshCtrl::OnCreate passes CChildSwitch a pointer to the control's CWnd via the function InitChildSwitch (p.94 line 14) and calls the function GoToHistEntry. CChildSwitch get/set functions (p.90 line 48, p.91 line 6) implement activeX get/set properties for each CURLHistEntry member in the obvious manner. GoToHistEntry makes cleanup function calls (including turning off inshoppingcart if necessary), calls CReSuConcat::ReadRootRgu to initialize CReSuConcat::cprRoot according to CURLHistEntry::URL (see above), calls the function ReplaceChildAreas (p.94 line 24) to reinitialize theVidCWnd, theToolCWnd, and theRepCWnd (or theNoZoomBrowser), and jumps downward in level as necessary to implement CURLHistEntry::LevelDelta.

ReplaceChildAreas calls a series of functions which together reinitialize either theNoZoomBrowser or theVidCWnd, theToolCWnd, and theRepCWnd. ReplaceChildAreas begins with calls to the cleanup functions CleanChildAreas and DestroyChildWindows (see above), then calls protected function ComputeChildRectangles (p.95 line 9) to compute (or recompute) reetTool, rectRep, and rectVid (p.92 line 29). If the client area width can accomodate REPREQWIDTH in addition to TOOLREQWIDTH, ComputeChildRectangles puts rectRep at the top right of the client area, with height REPNOMHEIGHT (limited to client area height), and puts rectTool at the top left of the client area using whatever width is left over (ie width of rectTool is >=TOOLREQWIDTH); if the client area width is not sufficient to accomodate both REPREQWIDTH and TOOLREQWIDTH, ComputeChildRectangles puts rectRep below rectTool and makes them both as wide as the client area; rectVid covers whatever area remains. ReplaceChildAreas next calls protected function CreateChildWindows (p.96 line 30) to provide HWNDs for theToolCWnd and theRepCWnd, and for theVidCWnd if inzoomingmode is true (inzoomingmode is set when CReSuConcat::ReadRootRgu successfully reads an RGU file). If inzoomingmode is false, CreateChildWindows instead creates an HWND for theNoZoomBrowser using rectVid. ReplaceChildAreas finally calls protected function InitChildAreas (p.97 line 11) to reinitialize theCoordSys and theReSuConcat, and to reinitialize the CVidArea, CToolArea, and CRepArea members of theVidCWnd, theToolCWnd, and theRepCWnd respectively. InitChildAreas first creates the direct draw management object theddSystem (ddSystem creation would normally happen only once, but resides here temporarily due to a bug in the graphics hardware of a development system; see comment). If inzoomingmode, InitChildAreas next creates theCoordSys, using the macroblock-unit width and height of theVidCWnd's client area (local variables mbwround, mbhround; as in CCoordSys constructor, see above), and calls CCoordSys::DefInitCoords (see above) to initialize theCoordSys with navigational values from the (newly) current history entry (p.97 line 46). InitChildAreas then updates theReSuConcat's copy of theCoordSys, and calls the function UpdatePerimeters (p.97 line 50) to initially populate CPosRgu lists based on the new CReSuConcat::cprRoot (via CReSuConcat::UpdatePerimeters; see above). InitChildAreas also calls protected functions SetScrollRangeVid (p.98 line 33) and SetScrollPosVid (p.98 line 44) to initialize theVidCWnd's vertical scrollbar, and calls CVidArea::InitVidArea to perform initial rendering in the main content area. SetScrollRangeVid uses CWnd::SetScrollRange to set the total number of increments in the vertical scrollbar mechanism to multiplierSpan * rgutyperoot * SCALESPERLEVELJUMP (as used in CCoordSys::TrackScalePos etc; see above); SetScrollPosVid uses CWnd::SetScrollPos to set the initial scrollbar position based on initial level, scale and multiplier values (see above). If not inzoomingmode, InitChildAreas instead uses CWebBrowser2::Navigate to direct theNoZoomBrowser to URL of the (newly) current history entry (p.98 line 24). InitChildAreas also calls CToolArea::InitToolArea (p.98 line 7) to set up theToolArea's buttons and combobox (see below; local variables cangoback and cangoforward indicate whether theURLHistory contains a previous or next history entry respectively), causes theToolCWnd::theToolArea to perform initial rendering by sending WM_ENABLEBUTTONS to theToolCWnd, and calls CRepArea::InitRepArea to initialize theRepArea (see below).

GoToHistEntry is also called by the functions PareHistoryAndBranch (p.102 line 7) and JumpHistory (p.103 line 23), which in turn are called by CZooshCtrl::BranchToURL and CZooshCtrl::JumpHistory respectively in response to the WM_BRANCHTOURL and WM_JUMPHISTORY messages respectively. PareHistoryAndBranch first pares theURLHistory by deleting all history entries after posURLHist (p.102 line 10), then limits list length to URLHISTNENTRIESMAX by removing the head element if necessary (p.102 line 22). PareHistoryAndBranch then calls protected function UpdateHistEntry (p.102 line 29) to overwrite the current history entry with updated navigational values, and branches by creating a new history entry from inputs URL and Config, inserting the new CURLHistEntry* into theURLHistory after posURLHist, and finally calling GoToHistEntry. UpdateHistEntry saves current navigational values into either cheCart (case inshoppingcart) or the current history entry (case !inshoppingcart). If !inshoppingcart, UpdateHistory calculates LevelDelta using CReSuConcat::LevelDeltaFromInit (ie LevelDelta=levelcurrent−levelinit), so that upon returning to the current history entry GoToHistEntry will navigate to levelcurrent, and calls CReSuConcat::SetLevelInit (=>levelinit=levelcurrent) in lieu of reinitializing levelcurrent when toggling inshoppingcart off (see function CartToggle below); shopping cart LevelDelta is always 0. UpdateHistEntry finally overwrites CURLHistEntry members with the current values of (CCoordSys::) scale, multiplier, xSrcFix, ySrcFix, xDstViewTL, and yDstViewTL. JumpHistory jumps input n history entries away from posURLHist: if n is positive, JumpHistory moves forward n positions from posURLHist (stopping at tail position if necessary); if n is negative, JumpHistory moves backward |n| positions from posURLHist (stopping at head position if necessary). JumpHistory finishes by calling UpdateHistEntry (see above), updating posURLHist, and finally calling GoToHistEntry.

After calling CReSuConcat::ReadRootRgu and ReplaceChildAreas, GoToHistEntry automatically jumps downward by levelsdown=|CURLHistEntry::LevelDelta| levels if CURLHistEntry::LevelDelta is less than 0, indicating a downward jump. GoToHistEntry calls the function DescendLevels (p.99 line 12) to update CReSuConcat and CCoordSys according to levelsdown, then calls the function CCoordSys::DefInitCoords a second time (the first was in InitChildAreas upon CCoordSys creation; see above) in order to force initial navigational values to exactly reflect the current history entry (the first CCoordSys::DefInitCoords with parameter doFixDest true followed by downward level jumping leaves CCoordSys values only approximately equal to history entry values; see above). GoToHistEntry finally calls the function MoveBrowsers (p.100 line 41; calls CReSuConcat::MoveBrowsers) since CCoordSys::DefInitCoords may have changed xDstViewTL or yDstViewTL, and calls CReSuConcat::SetLevelInit to establish the original value of levelinit.

DescendLevels calls the function DeleteBrowsers (p.100 line 33; calls CReSuConcat::DeleteBrowsers) to turn off all currently active browser cells, and calls CReSuConcat::DescendLevelsStepped (see above) to lower cprRoot by levelsdown. DescendLevels then calls SetScrollRangeVid (see above) to reset the total number of increments in the vertical scrollbar mechanism (rgutyperoot has usually been lowered), and finally calls protected function ChangeLevelFinish (p.99 line 49), which groups together various function calls that are necessitated by a change in level or scale. ChangeLevelFinish calls CCoordSys::FixDestScale (see above; the parameter useMouse is passed into DescendLevels and from DescendLevels to ChangeLevelFinish) to modify xSrcFix, ySrcFix, xDstViewTL, and yDstViewTL according to the number of scale increments, calls UpdatePerimeters (see above) to recalculate perimeter rectangles and update CPosRgu lists accordingly, calls SetScrollPosVid (see above) to update the vertical scrollbar position (levelcurrent or scale has changed), and calls protected function SetConcat (p.100 line 3) to (completely) rerender into the video buffer (due to the change in levelcurrent or scale). SetConcat calls CVidArea::SetConcat to inform CVidArea of the new (current level) CPosRguConcat and rerender into the video buffer (when only scale has changed, the pointer returned by get_Concat is unchanged, but CVidArea::SetConcat still rerenders), calls the function BrowsersOnOff (p.100 line 37; calls CReSuConcat::BrowsersOnOff) to complete the rerendering (CVidArea::BrowsersOnOff sends WM_BROWSERSONOFF to this), and causes theToolCWnd::theToolArea to rerender by sending WM_ENABLEBUTTONS to theToolCWnd.

DescendLevels can also be called from CZooshCtrl in response to the WM_DESCENDLEVELSCENTER or WM_DESCENDLEVELSMOUSE events; the function AscendLevels (p.99 line 22) is called from CZooshCtrl in response to the WM_ASCENDLEVELSCENTER and WM_ASCENDLEVELSMOUSE events, and the function TrackLevels (p.99 line 32) is called from CZooshCtrl in response to the WM_TRACKLEVELSCENTER and WM_TRACKLEVELSMOUSE events. AscendLevels is identical to DescendLevels except that it calls CReSuConcat::AscendLevels (see above) to raise cprRoot by levelsup (instead of calling CReSuConcat::DescendLevelsStepped to lower cprRoot by levelsdown).

The CVidArea function which calls CCoordSys::UpdateFix and CCoordSys::TrackScalePos sends parameters levelTarg and scaledelta (the reference-type and formal return values respectively from CCoordSys::TrackScalePos; see above) to CZooshCtrl in either the WM_TRACKLEVELSCENTER or WM_TRACKLEVELSMOUSE message, which then passes levelTarg, scaledelta, and useMouse to the function TrackLevels (parallelling the calls to AscendLevels and DescendLevels, useMouse is true for WM_TRACKLEVELSMOUSE, false for WM_TRACKLEVELSCENTER). TrackLevels is similar to AscendLevels or DescendLevels except that in order to reduce delays in continuous scale tracking it does not attempt to raise or lower cprRoot (and hence need not call SetScrollRangeVid). TrackLevels calls DeleteBrowsers, computes a total scaledelta (local variable totdelta) for use by ChangeLevelFinish (by adding the scaledelta equivalent of levelTarg—levelcurrent to the input scaledelta), and defaults to the callback function CVidArea::TrackFinishMultDelta (followed by UpdatePerimeters) when there is neither a change in level nor a change in scale. CVidArea::TrackFinishMultDelta substitutes for CVidArea::SetConcat in those cases where only multiplier has changed, and it is not necessary to rerender into the entire video buffer; the call to UpdatePerimeters is necessary because a change in multiplier nonetheless affects perimeter rectangles.

In response to the WM_GOTOLEVELINIT event, CZooshCtrl calls the function GoToLevelInit (p.100 line 11) to reinitialize levelcurrent and other navigational parameters according to the (possibly updated) current history entry. When ineditingmode returns false (ie when !inshoppingcart, assuming inshoppingmode), GoToLevelInit also parallels AscendLevels or DescendLevels except that it substitutes CReSuConcat::ReinitLevelRoot as the cprRoot updating function, and calls CCoordSys::DefInitCoords instead of CCoordSys::FixDestScale. CReSuConcat::ReinitLevelRoot (see above) restores levelcurrent to levelinit using either the cprRoot-raising function of AscendLevels or the cprRoot-lowering function of DescendLevels. CCoordSys::DefInitCoords (see above) reinitializes theCoordSys with navigational values from the current history entry. When inshoppingcart (=>ineditingmode returns true, substitute cheCart for current history entry), GoToLevelInit has the effect of reinitializing scale and view top left, but without any changes in level since there is only one shopping cart CPosRguConcat (see class CCartConcat below); in this case GoToLevelInit just calls CCoordSys::DefInitCoords to reinitialize the coordinates, SetScrollPosVid in case scale has changed, and SetConcat to rerender.

In response to the WM_CARTTOGGLE message, CZooshCtrl calls the function CartToggle (p.101 line 5) to switch inshoppingcart either on or off and rerender accordingly. If !inshoppingcart on input, CartToggle first calls DeleteBrowsers to turn off browser cells in CReSuConcat. CartToggle then calls UpdateHistEntry to overwrite navigational values in either cheCart or the current history entry (cases inshoppingcart and !inshoppingcart respectively), and toggles the inshoppingeart bit; when turning inshoppingeart on, CartToggle calls the function CCartConcat::PoorMansRepack (see below) to automatically repack shopping cart CPosRgus. Finally, CartToggle (as in GoToLevelInit, case inshoppingcart) calls CCoordSys::DefInitCoords to reinitialize the coordinates, SetScrollPosVid in case scale has changed, and SetConcat to rerender. Other functions of GoToLevelInit are not required since (when turning inshoppingcart off) CReSuConcat::levelcurrent does not change (see above; UpdateHistory calls CReSuConcat::SetLevelInit when turning inshoppingcart on).

In response to changes in the size of the control's window, the MFC framework calls CZooshCtrl::OnSize, which in turn calls the function SizeChildWindows (p.101 line 28) to reallocate and rerender at the new size and position. SizeChildWindows first calls UpdateHistEntry (see below) to save coordinates into either cheCart or the current history entry, so that the upcoming call to CCoordSys::DefInitCoords in InitChildAreas will preserve coordinates. SizeChildWindows then performs the functions of ReplaceChildAreas (see above; DestroyChildWindows and CreateChildWindows are omitted since there is no need to destroy and recreate HWNDs on resizing). Since video buffer dimensions depend on client area dimensions, theCoordSys is deleted and recreated, and theVidCWnd::theVidArea is completely reinitialized (by InitChildAreas). Before calling InitChildAreas, SizeChildWindows calls protected function MoveChildWindows (p.101 line 40) to move and resize the HWND of each CWnd-derived object.

Class CVidWnd

Class CVidWnd (files VidWnd.h, pp.105-106; VidWnd.cpp, pp.107-110) is a CWnd-derived wrapper for class CVidArea, which manages rendering and message handling for the main content area. CVidWnd's only data members (p.106 line 15) are a pointer to the owned CVidArea theVidArea, and two HWNDs ToolHwnd and RepHwnd for passing messages to the toolbar area 900 and reporting area 901 wrapper classes respectively. The CVidWnd constructor (p.107 line 28) creates theVidArea and initially NULLs ToolHwnd and RepHwnd; CChildSwitch::CreateChildWindows and CChildSwitch::DestroyChildWindows then call inline functions set_ToolHwnd and set_RepHwnd (p.105 line 33) to respectively set and reNULL ToolHwnd and RepHwnd. The CVidWnd destructor (p.107 line 41) needs only to delete theVidArea. Further functions of CVidWnd are discussed in the examples to follow.

Class CCartConcat

Class CCartConcat (files CartConcat.h, p.111; CartConcat.cpp, pp.112-121) is derived from Class CPosRguConcat and manages operations on a set of CPosRgus representing the contents of a shopping cart, including adding and deleting selection ranges from the shopping cart, packing and repacking the CPosRgus in source-space coordinates, and computing item totals, order totals, etc. Base class members PosRguListUns and PosRguListSel contain the CPosRgus in the cart, member variable PosRguListNew (p.111 line 49) contains CPosRgus newly added to the cart but not yet incorporated into PosRguListUns or PosRguListSel, member variable theAudEffect (p.111 line 48) points to a CAudEffect object which stores and plays audio feedback for add and delete operations, and member variable SelUnsTotal (p.111 line 50) maintains a monetary total value for all CPosRgus in PosRguListUns and PosRguListSel combined. The CCartConcat constructor (p.112 line 5) zeros SelUnsTotal, creates theAudEffect, and sets islevelmin=islevelmax=iscart=true (all constant for CCartConcat). The CCartConcat destructor (p.112 line 16) deletes theAudEffect and all CPosRgus in PosRguListNew. CCartConcat functions can be divided into 3 categories as follows:

1) adding and deleting selections from the cart (p.111 line 24, p.111 line 39): The function AddSelToNew (p.120 line 12) adds a copy of PosRguListSel of its input Concat to PosRguListNew using CPosRguConcat function AddCopy. Class CVidArea calls the function DeleteSelOf (p.120 line 20) in response to the delete key, and its input Concat represents the CPosRguConcat currently being viewed by the user: if the user is viewing the contents of the cart, Concat->iscart is true and Concat is equivalent to the this pointer; otherwise, Concat->iscart is false and Concat points to an element of CReSuConcat::Concats[ ]. If Concat->iscart is false, DeleteSelOf first calls protected function IsOneOrMoreOf (p.117 line 33) with PosRguList=Concat->PosRguListSel to determine whether the cart contains one or more copies of PosRguList. IsOneOrMoreOf assumes that PosRguList contains no duplicate CPosRgus (ie same RguFile), which is normally true when PosRguList is from a CReSuConcat, and operates by calling protected function CountCopiesOf (three-parameter signature; p.118 line 35) for each CPosRgu in PosRguList with limitcount=1 and useSel turned on. CountCopiesOf returns the number of copies of its input refcpr contained in the cart (less PosRguListSel if input useSel is false), as defined by CPosRgu::RguFile, returning limitcount if limitcount is reached before completing the count. If IsOneOrMoreOf returns true, DeleteSelOf calls protected function DeleteCopyOf (CPRList* signature; p.119 line 14; calls DeleteCopyOf with CPosRgu* signature; p.119 line 23) with PosRguList=Concat->PosRguListSel to delete one copy of PosRguList from the cart, then calls the function PlaySoundDelta (p.120 line 51) to provide audio feedback, and returns true to indicate that a deletion took place; if IsOneOrMoreOf returns false, DeleteSelOf merely returns false. If Concat->iscart is true, as long as PosRguListSel (in this case the same as Concat->PosRguListSel) is not empty, DeleteSelOf calls PlaySoundDelta to provide audio feedback, calls protected function SubtractSelTotal (p.116 line 41) to subtract from SelUnsTotal according to PosRguListSel, and return true to indicate that a deletion should (still) be performed by the caller; if PosRguListSel is empty, DeleteSelOf merely returns false.

As in the function DeleteSelOf, the input Concat to PlaySoundDelta represents the CPosRguConcat currently being viewed by the user; the input unseen herein equivalent to !Concat->iscart (see comment; p.120 line 43), and the input isAdd is true for adding to cart, false for deleting (DSREADINGFROMFILE is not defined, meaning that CAudEffect functions play sounds that have been read in as resources, rather than reading them from file). In the case of deletions (ie the two calls from DeleteSelOf) with unseen=true, PlaySoundDelta uses IsOneOrMoreOf a second time to determine whether the deletion that has just occurred represents the last available deletion of that selection range: if not, PlaySoundDelta plays the DSINDBFIRE sound at normal frequency (input freqrat of CAudEffect::PlaySnowJob is 0.00); if it was the last deletion, PlaySoundDelta plays the DSINDBFIRE sound at 0.75 times the normal frequency (input freqrat of CAudEffect::PlaySnowJob is 0.75). In the case of deletions with unseen=false, PlaySoundDelta uses protected function IsOneOrMoreOfNonSel (p.117 line 52; similar in operation to IsOneOrMoreOf, see comment) to determine whether the upcoming deletion represents the last available deletion of that selection range: if not, as above, PlaySoundDelta plays the DSINDBFIRE sound at normal frequency; if it will be the last deletion, PlaySoundDelta plays the DSINDBFIRE sound at 0.75 times the normal frequency. In the case of additions, PlaySoundDelta plays the DSINDSBOUNCE sound at normal frequency unless unseen=true and IsOneOrMoreOf returns false (ie, unless the addition is the first of its kind, which necessarily must be from the CReSuConcat view); if the addition is the first of its kind, PlaySoundDelta plays the DSINDSBOUNCE sound at 0.75 times the normal frequency. The net effect of PlaySoundDelta is that additions of any given selection range (whether one or more than one CPosRgu, whether from the vantage point of CReSuConcat or CCartConcat) rise in frequency after the first instance, and that deletions of any given selection range (whether one or more than one CPosRgu, whether from the vantage point of CReSuConcat or CCartConcat) decline in frequency on the last instance.

2) Item total computations (p.111 line 20, p.111 line 34): Class CRepArea calls the function ComputeOrderTotal (p.116 line 48) to compute a monetary total for all shopping cart items, including PosRguListNew. Protected function GetItemsTotal (p. 117 line 3) returns the sum, over all CPosRgus in its input PosRguList, of the number of occurences in the shopping cart (as computed by CountCopiesOf; see above) times the value returned by protected base class function ItemPrice; bit DIDSEECPR of CPosRgu::didbits allows GetItemsTotal to keep track of which CPosRgus in its input PosRguList have already been accounted for. Class CRepArea calls the function GetItemsTotalSelOf (p.116 line 27) to obtain the GetItemsTotal sum for PosRguListSel of an input CPosRguConcat. Shopping cart CPosRgu packing functions (see below) call protected function ComputeSelUnsTotal (p.116 line 31) to sum SelUnsTotal from scratch. Protected function SubtractSelTotal (see above) is called from DeleteSelOf.

3) CPosRgu packing functions (p.111 line 17, p.111 line 30): CChildSwitch::CartToggle and CVidArea::CartRepack call the function PoorMansRepack (p.115 line 13) to define a packing arrangement of shopping cart CPosRgus in source-space coordinates. PoorMansRepack first calls protected function PackNewPosRgus (p.114 line 22), which uses protected function RecursivePack (p.112 line 44) to pack the CPosRgus in PosRguListNew into an area whose top left coordinate is just below the bottom left coordinate of the existing TotmbBounds, while adding the results to PosRguListUns. PoorMansRepack then sorts all CPosRgus in cart (PosRguListSel and PosRguListUns combined) according to MioEntry pointer, so that like CPosRgus are grouped together in sequence, copies the results of sorting back into PosRguListNew, and again calls RecursivePack to pack them back into PosRguListUns. RecursivePack implements an algorithm (see comment) that arranges groups of 4 CPosRgus together into a most-compact arrangement, then arranges 4 groups of 4 using the same compactness rule, and so on up to the largest power of 4 necessary. Since the algorithm is recursive, it begins by considering the largest power of 4 necessary, while the deepest part of the recursion handles individual CPosRgus.

Other classes

Class CAudEffect (files AudEffect.h, pp.122-123, AudEffect.cpp, pp.124-129) contains functions for reading and playing sound resources or files. Class CMioEntry (files MioEntry.h, pp.130-131, MioEntry.cpp, pp.132-138) contains functions for reading, decoding, and downscaling MIO files. The function CMioEntry::DecodeMio (p.134 line 56), in particular, is adapted from a distribution of the Berkeley MPEG Software Simulation Group (see files jrevdct.c, jrevdct.h, iquantvld.c, iquantvld.h, mfwddct.c, mfwddct.h of that distribution).

Methods for decoding MPEG I-frame data are numerous and well-understood in the art. Class CWebBrowser2 (Microsoft Visual C++ wrapper classes WebBrowser2.h, WebBrowser2.cpp) contains functions for controlling an Internet Explorer-style web browsing control whose parent is a CWnd. Class CToolArea (files ToolArea.h, pp.144-146, ToolArea.cpp, pp.147-155) contains functions for initializing, drawing, and handling events for the toolbar area 900. Class CRepArea (files RepArea.h, p.160, RepArea.cpp, pp.161-163) contains functions for initializing and drawing the reporting area 901. Class ddSystem (files ddSystem.h pp.164-165 line 0, ddSystem.cpp, pp.166-171) contains functions for allocating a DirectDraw object, determining its capabilities, retrieving primary (screen) surface data, managing clipping, checking the availability of FourCC (DirectDraw) codes, and creating offscreen (DirectDraw) buffers; class ddSystem does not own or render into the video buffers described herein.

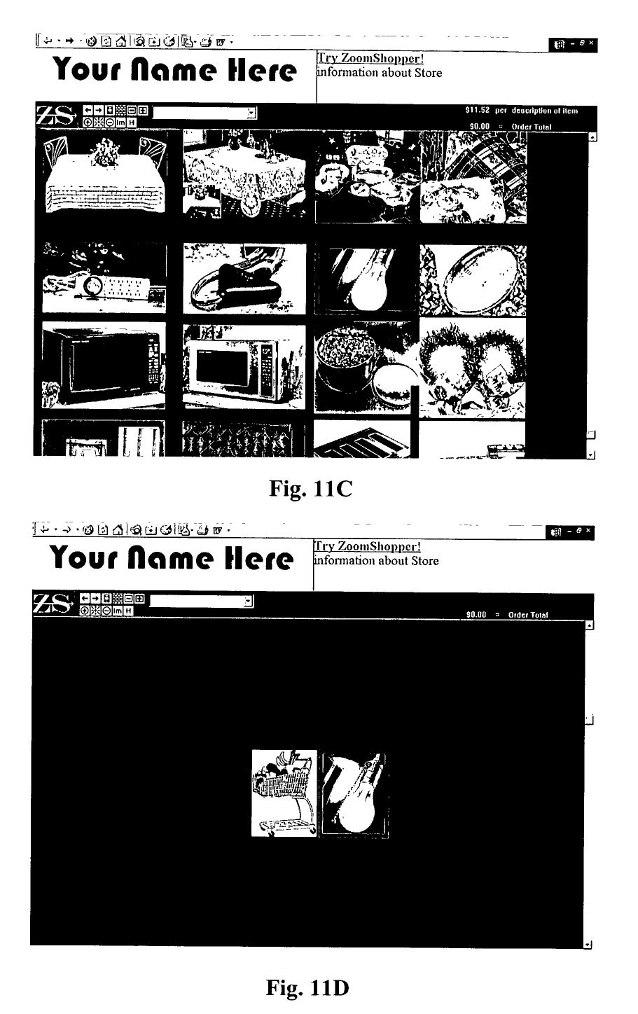

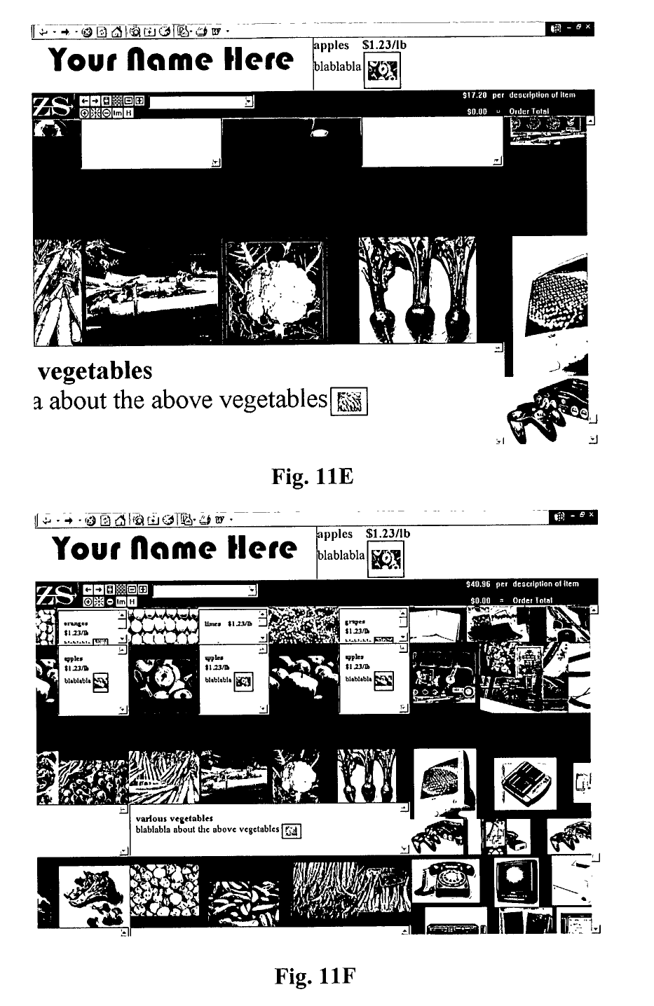

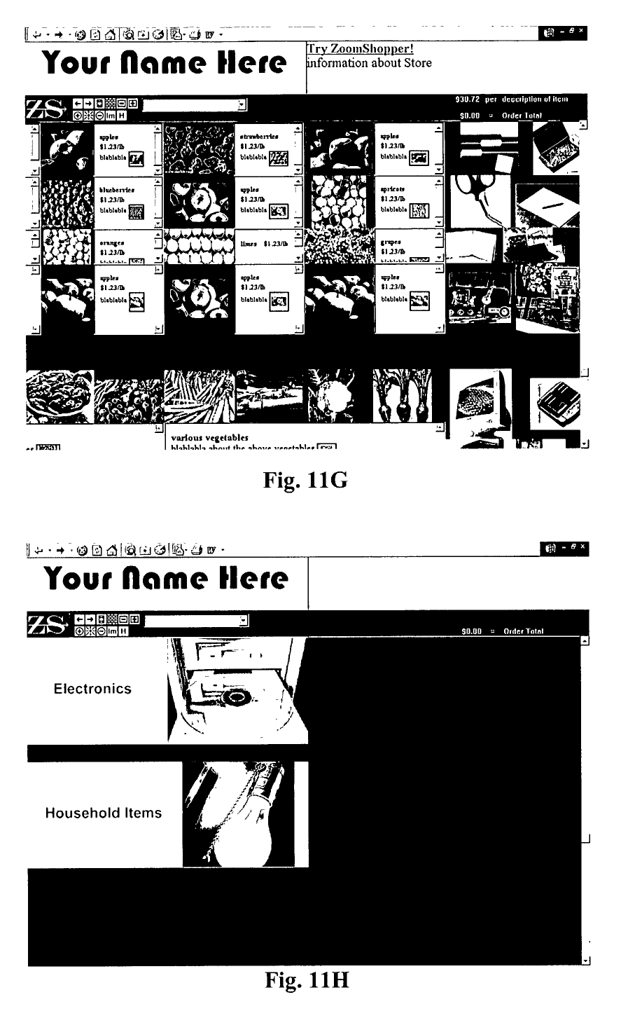

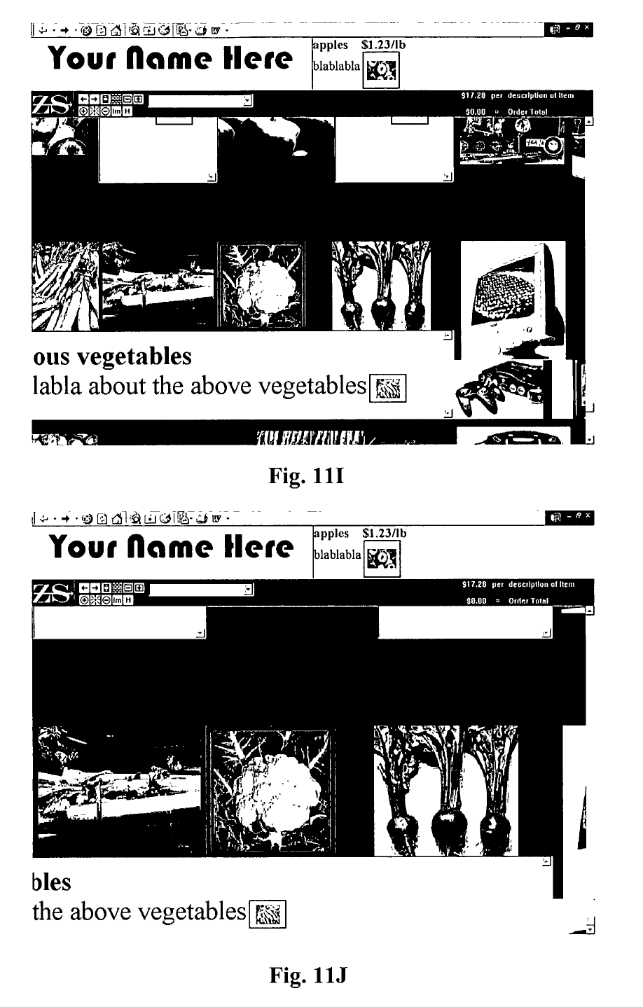

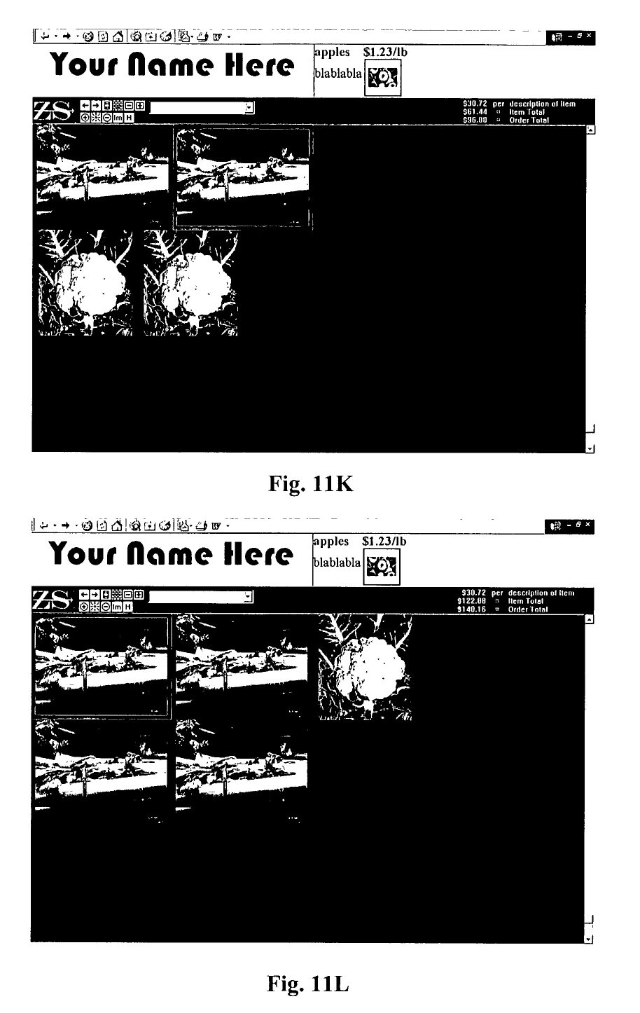

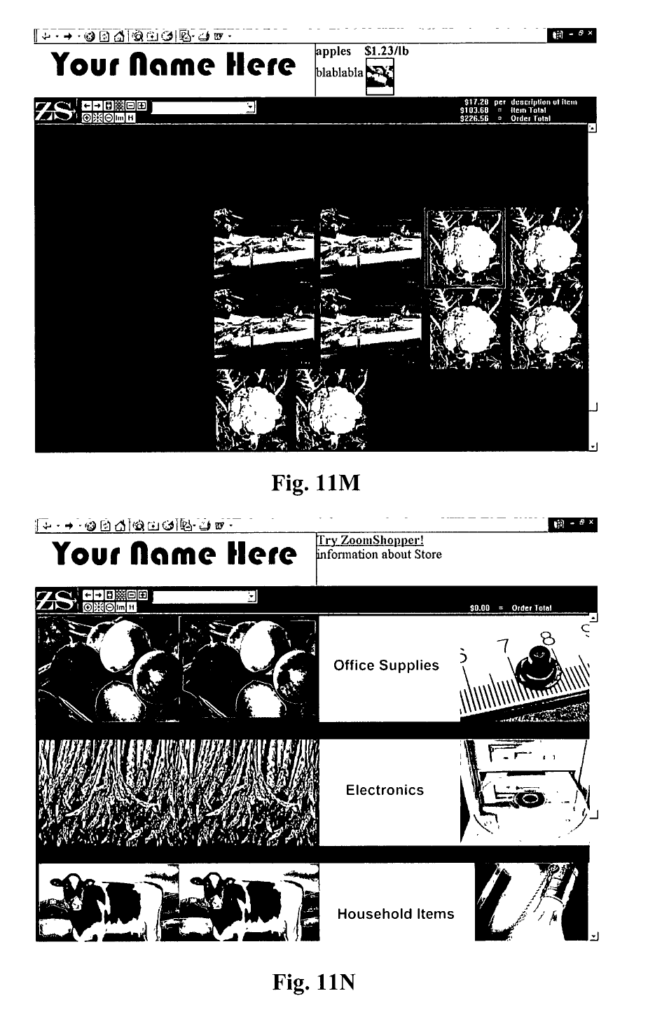

Screen Shots (FIGS. 11A -11N)

Note: due to difficulties in attaching a debugger to Internet Explorer, data for the following examples has been obtained from a debugger attached to a different container application. Therefore, clientwidth and clientheight of the Zoosh control's window (and dependent quantities) differ slightly from what is seen in the screen shots. Also, amounts of mouse-down lateral navigation in the x and y directions leading to the views seen in the screen shots (and dependent effects) differ slightly from those recorded in the examples. The screen shots of FIG. 11 are an inexact, best-effort attempt to reproduce the conditions of the Example scenarios, and are for illustrative purposes only. The following list summarizes the screen shots of FIG. 11:

11A) after loading stores.sec in Basic Initialization

11B) after jumping downward using Enter key in Example #1

11C) after MDLN to bring Panels into view in Example #3 (after twice using “square +”; note black stripes where some decoded material is absent due to WPREDECODEAPRON=0, etc)

11D) after MDLN to bring Pages roughly to center of view in Example #4

11E) after jumping downward to Panels using “square +” in Example #5 (after FIG. 11D)

11F) after contracting using “round −” in Example #5 (after FIG. 11E)

11G) after using “round −” and MDLN at Panels level in Example #6 to approximate FIG. 7 (note absence of black stripes)

11H) after initial LevelDelta, xDstViewTL, and yDstViewTL as in Example #7

11I) after contracting with the “−” key (3 times) in Examples #9(e)

11J) after expanding with the “+” key (3 times) in Examples #9(f)

11K) after toggling to cart in Examples #10(e)

11L) after repacking in Examples #10(f)

11M) after a series of shopping cart edits subsequent to Examples #10

11N) after using “Images priority” in Examples #12

Example Scenarios

In a first set of example scenarios, the user enters the hierarchy at Section-of-Pages level by pointing the Internet Explorer web browser to Zsh/framesetOCXDirect.htm (p.208); in these scenarios, the parallel HTML example of FIGS. 4-6 and 3A is bypassed (does not serve as the entry point, as it does in later examples). Nonetheless, framesetOCXDirect.htm creates the same frameset as framesetPatExample.htm, which again yields the dimensions shown in FIG. 4 when the browser window is 1024×608 (client area dimensions in the descriptions to follow are slightly different from FIG. 4), again loads website logo logostore.gif into frames[0] 400, and again initially loads toprightMain.htm into frames[1] 401. The essential difference is that framesetPatExample.htm loads tableMain.htm into frames[2] 402, while framesetOCXDirect.htm loads linktoOCX.htm (p. 207) into frames[2] 402. In linktoOCX.htm, the statement (p.207 line 16)

<object ID=“Zoosh1” WIDTH=100% HEIGHT=100%

CLASSID=“CLSID:9307C47E-B40D-11D2-ADF1-C455E0E43C02”22 </object>

tells Internet Explorer to insert an object of the given Class ID into frames[2], to name it “Zoosh1” for later reference, and that it should occupy 100% of the frames[2] area. Internet Explorer finds this Class ID in the system registry under HKEY_CLASSES_ROOT\CLSID, and creates the Zoosh ActiveX control; the m_clsid parameter to CZooshCtrl::CZooshCtrlFactory::UpdateRegistry (p.22 line 33) is defined in an IMPLEMENT_OLECREATE_EX call (p.12 line 39). After calling CZooshApp::InitInstance (p.6 line 23), the MFC framework calls the CZooshCtrl constructor (p.13 line 3), creating CZooshCtrl::theChildSwitch and all of its subordinate objects. Javascript statements (p.207 line 20) in linktoOCX.htm then set the Zoosh1 property ZooshBase to a base directory string (whatever precedes “HTMLfiles/PatExample/Zsh/linktoOCX.htm” in the full pathname), set the Zoosh1 property ZooshLoc to “Sections/Stores.sec”, and set the Zoosh1 properties Config, LevelDelta, Scale, xViewTL, and yViewTL according to the window.parent values defined in framesetOCXDirect.htm (all 0). The function CZooshCtrl::OnZooshLocChanged (p.19 line 52) and CZooshCtrl set functions (p.9 line 23) then call CChildSwitch set functions (p.91 line 7) to overwrite values in the current (and thus far only) history entry. The MFC framework then calls CZooshCtrl::OnCreate (p.18 line 22), which leads to CChildSwitch::GoToHistEntry (see above).

Basic Initialization: Current-Level Perimeter Sizes Equal to Buffer Size; Preloading Pages During Initialization

CZooshCtrl::OnCreate calls CChildSwitch::GoToHistEntry. In CReSuConcat::ReadRootRgu, relpname is “Sections/stores.sec”, leading to rgutype=RGUTYPE_SEC=3. ReplaceRoot creates a new disembodied cprRoot having RguFile=“Sections/stores.sec”, and calls PreloadOne to read “Sections/stores.mio” for cprRoot's RedMioEntry (which readMio adds to RedMioEntryList) and “Sections/stores.sec” for cprRoot's ZshFileEntry (which AddEntry adds to SecEntryList); no SubMioImage can be inferred from RguFile). In PreloadOne's call to CBpssEntry::InitPosRguList, (mbxbase, mbybase)=(0×0, 0×0) because operator new of class CPosRgu earlier set (mbxRguTL, mbyRguTL) of cprRoot to the default (0×0, 0×0). Local variable tempptr points to file data which yields ncomponents=2 Pages: “Pages/groceries.pag” with (mbw, mbh)=(0×8, 0×a) at (mbxRguTL, mbyRguTL)=(0×0, 0×0) and “Pages/general.pag” with (mbw, mbh)=(0×8, 0×a) at (mbxRguTL, mbyRguTL)=(0×8, 0×0). The CPosRgu for “Pages/general.pag” has SubMioImage “SubMios/sublightbulb.mio”, and the CPosRgu for “Pages/groceries.pag” has SubMiolmage “SubMios/subgroceries.mio”; neither has any nonempty CellURL[ ] strings. Since input testbounds is false, both CPosRgus are added to PosRguListBpss, offset by the initial (mbxbase, mbybase)=(0×0, 0×0), and assigned CprUpward=cprRoot. At the end of ReplaceRoot, isRootDisembodied becomes true. Since ReplaceRoot returns true, SetLevelRoot sets levelroot=6 and rgutyperoot=3, SetLevelCurrent sets levelcurrent=4 and rgutypecurrent=2, and FollowRootPath attempts to raise levelroot to 8. However, since CprUpward of the initial cprRoot is NULL, and RguUpward of the initial cprRoot::ZshFileEntry is the empty string, FollowRootPath cannot raise levelroot.

CChildSwitch::GoToHistEntry calls CChildSwitch::ReplaceChildAreas. Working from (top, bottom, left, right) a clientrect of (0×0, 0×28a, 0×0, 0×3f5), ComputeChildRectangles yields rectVid=(0×30, 0×28a, 0×1, 0×3f5), rectTool=(0×0, 0×30, 0×0, 0×2f4), and rectRep=(0×0, 0×30, 0×2f4, 0×3f4). InitChildAreas computes (clientwidth, clientheight)=(0×3e4, 0×25a) (CVidWnd's clientwidth is less than Zoosh's due to vertical scrollbar), (mbwround, mbhround)=(0×3f, 0×26), then creates theCoordSys. The CCoordSys constructor sets multiplierBase=0×10, multiplierLim=0×1a, (mbwround, mbhround)=(0×3f, 0×26), (mbwprimary, mbhprimary)=(0×40, 0×30), then calls DetMultiplierLim. DetMultiplierLim computes (mbwreq, mbhreq)=(0×36, 0×22), which are less than mbwprimary and mbhprimary respectively (so that neither axis is limiting to multiplierLim), yielding (mbwidth0, mbheight0)=(0×6c, 0×44). DetMultiplierLim then computes (mbxseam0, mbyseam0)=(0×36, 0×22), (vbwidth, vbheight)=(0×6c0, 0×440), vbwleft=0×360, vbwright=0×360, vbhtop=0×220, and vbhbottom=0×220. The CCoordSys constructor then computes multiplierMin=0×d and multiplierSpan=0×d, and saves input values in (clientwidth, clientheight) and (xcurrent, ycurrent). Using the values:

WPREDECODEAPRON 0×0

HPREDECODEAPRON 0×0

WPRELOADAPRON 0×0

HPRELOADAPRON 0×0

APRONFACTORUP 0.75

APRONFACTORDOWN 1.0

the CCoordSys constructor finally sets wPredecodeConst=wPreloadConst=vbwidth=0×6c0 and hPredecodeConst=hPreloadConst=vbheight=0×440, and computes wPredecodeUp[ ], hPredecodeUp[ ], wPreloadUp[ ], and hPreloadUp[ ] according to APRONFACTORUP. Because all “apron” constants are 0×0, both the preload and predecode perimeters for the current level will coincide with video buffer boundaries, so that navigational actions such as scaling and mouse-down lateral navigation will result in loading and decoding of material that is displayed shortly thereafter. Such loading and decoding is responsive to a navigational input, although their results may not actually be displayed until the next in a sequence of co-directional inputs; later examples will demonstrate a broader anticipation of navigational inputs by the use of larger preload and predecode perimeters. In this example, CReSuConcat::preloadingdownward is turned off, so that wPredecodeDown[ ], hPredecodeDown[ ], wPreloadDown[ ], and hPreloadDown[]] are not needed by CReSuConcat::UpdatePerimeters. However, CReSuConcat::DescendLevels does use wPredecodeDown[1]=wPreloadDown[1]=0×6c0 and hPredecodeDown[1]=hPreloadDown[1]=0×440 (same as 0th values because APRONFACTORDOWN=1.0).

InitChildAreas calls CCoordSys::DefInitCoords, which sets initscale, initmultiplier, initxSrcFix, initySrcFix, initxDstViewTL, and inityDstViewTL according to corresponding values in the first history entry (all 0 except initmultiplier=0×10; see linktoOCX.htm). Since doFixDest is true, DefInitCoords uses FixDestCalc to scale initxSrcFix, initySrcFix, initxDstViewTL, and inityDstViewTL with respect to (xc, ye)=(0×1f2, 0×12d) but LevelDelta is 0 so these remain unchanged. DefInitCoords finally calls InitCoordSys, which initializes (xSrcFix, ySrcFix) and (xDstViewTL, yDstViewTL) with the their “init” values, and calls SetScale and InitSrcTLCoords. SetScale similarly initializes scale=0×0 and multiplier=0×10, and computes mbunitpower=0×4, mbunithalf=0×8, xVVpad=0×168, and yVVpad=0×f0. InitSrcTLCoords calls UpdateSrcTLCoords, which computes (xSrcViewTL, ySrcViewTL)=(0×0, 0×0), (xSrc, ySrc)=(0×fffffe98, 0×ffffff10) (local), (mbxVideoTL, mbyVideoTL)=(0×ffffffea, 0×fffffff1), (xViewAdj, yViewAdj)=(0×fffffff8, 0×0), and (mbxVideoTLrem, mbyVideoTLrem)=(0×56, 0×35).

InitChildAreas calls UpdatePerimeters, which calls CReSuConcat::UpdatePerimeters, which calls DetPerimeters, which calls CCoordSys::DetPerimeters, which computes (top, bottom, left, right):

PerimPreload[2]=PerimPredecode[2]=(0×fffffffd, 0×34d, 0×fffffe92, 0×552)

PerimPreload[1]=PerimPredecode[1]=(0×294, 0×6d4, 0×468, 0×28)

PerimPreload[0]=PerimPredecode[0]=(0×10b0, 0×14f0, 0×1bc0, 0×2280)

Only PerimPreload[2] and PerimPredecode[2] are used in the initialization sequence, since CReSuConcat::preloadingdownward is turned off. CReSuConcat::UpdatePerimeters next calls PreloadTopDown, which calls PreloadChildrenAtLevel for rgutype=rgutypecurrent=2. PreloadChildrenAtLevel calls CEntryCache::PreloadChildren to preload children of cprRoot, iterating through a PosRguListBpss which contains the 2 Page-of-Blocks CPosRgus inserted by CBpssEntry::InitPosRguList, and adding to an initially empty PosRguListUns.

PreloadChildren first encounters the CPosRgu with RguFile=“Pages/general.pag” and mbRgu=(0×0, 0×a, 0×8, 0×10), finds that IsInPerimPreload returns true and INPERIMPRELOAD is not set, sets INPERIMPRELOAD, adds the CPosRgu to PosRguListPreloadRec (PosRguListUns of CReSuConcat::PreloadChildrenAtLevel), finds that INMEMPRELOAD is not set, calls PreloadOne to preload the CPosRgu, overwrites an empty RguUpward with cprRoot::RguFile, and sets INMEMPRELOAD. PreloadOne reads “Pages/general.mio” for the RedMioEntry (which readMio adds to RedMioEntryList), “Pages/general.pag” for the ZshFileEntry (which AddEntry adds to PagEntryList), and “SubMios/sublightbulb.mio” for the SubMioEntry (which readMio adds to SubMioEntryList). In PreloadOne's call to CBpssEntry::InitPosRguList, (mbxbase, mbybase)=(0×20, 0×0) because the top left of the component at level 4 is (0×8, 0×0) and SCALESPERLEVELJUMP is 2. Local variable tempptr points to file data which yields ncomponents=3 Blocks:

| | | (mbxRguTL, | |
|---|---|---|---|
| RguFile | (mbw, mbh) | mbyRguTL) | SubMioImage |
| “Blocks/officesupplies.blk” | (0x20, 0xc) | (0x0, 0x0) | “SubMios/subwideruler.mio” |
| “Blocks/electronics.blk” | (0x20, 0xc) | (0x0, 0xe) | “SubMios/subwideCDdrive.mio” |
| “Blocks/householditems.blk” | (0x20, 0xc) | (0x0, 0x1c) | “SubMios/subwidelightbulb.mio” |

None of the 3 Blocks has nonempty CellURL[ ] strings. Since each of the CPosRgus is contained within mbBounds=(0×0, 0×28, 0×0, 0×20), each is added to PosRguListBpss, offset by (mbxbase, mbybase)=(0×20, 0×0), and assigned CprUpward=cprThis (ie the CPosRgu of “Pages/general.pag). Each of the 3 Blocks thus ends up with mbxRguTL=0×20 (not 0×0).

Similarly, PreloadChildren encounters the CPosRgu with RguFile=“Pages/groceries.pag” and mbRgu=(0×0, 0×a, 0×0, 0×8), again finds that IsInPerimPreload returns true and INPERIMPRELOAD is not set, again sets INPERIMPRELOAD and adds the CPosRgu to PosRguListPreloadRec, again finds that INMEMPRELOAD is not set and calls PreloadOne, again overwrites an empty RguUpward with cprRoot::RguFile, and again sets INMEMPRELOAD. PreloadOne reads “Pages/groceries.mio” for the RedMioEntry, “Pages/groceries.pag” for the ZshFileEntry, and “SubMios/subgroceries.mio” for the SubMioEntry. In PreloadOne's call to CBpssEntry::InitPosRguList, (mbxbase, mbybase)=(0×0, 0×0) because the top left of the component at level 4 is (0×0, 0×0) and SCALESPERLEVELJUMP is 2. Local variable tempptr points to file data which yields ncomponents=6 Blocks (3 of the 6 Blocks have nonempty CellURL[0]):

| | | (mbxRguTL, | |
|---|---|---|---|
| RguFile | (mbw, mbh) | mbvRguTL) | SubMioImage |
| “Blocks/vegetablesright.blk” | (0x10, 0xc) | (0x10, 0xe) | “SubMios/substasparagus2.mio” |
| “Blocks/fruitright.blk” | (0x10, 0xc) | (0x10, 0x0) | “SubMios/substpeaches2.mio” |
| “Blocks/dairyright.blk” | (0x10, 0xc) | (0x10, 0xc) | “SubMios/substcowpainting2.mio” |
| “Blocks/dairyleft.blk” | (0x10, 0xc) | (0x0, 0x1c) | “SubMios/substcowpainting.mio” |
| “Blocks/vegetablesleft.blk” | (0x10, 0xc) | (0x0, 0xe) | “SubMios/substasparagus.mio” |
| “Blocks/fruitleft.blk” | (0x10, 0xc) | (0x0, 0x0) | “SubMios/substpeaches.mio” |

| RguFile | CellURL[0] |
|---|---|
| “Blocks/vegetablesright.blk” | — |
| “Blocks/fruitright.blk” | — |
| “Blocks/dairyright.blk” | — |
| “Blocks/dairyleft.blk” | “HTMLfiles/PatExample/Zsh/embframedairy.htm” |
| “Blocks/vegetablesleft.blk” | “HTMLfiles/PatExample/Zsh/embframevegetables.htm” |
| “Blocks/fruitleft.blk” | “HTMLfiles/PatExample/Zsh/embframefruit.htm” |

Since each of the CPosRgus is contained within mbBounds=(0×0, 0×28, 0×0, 0×20), each is added to PosRguListBpss, offset by the initial (mbxbase, mbybase)=(0×0, 0×0), and assigned CprUpward=cprThis (ie the CPosRgu of “Pages/groceries.pag).

PreloadChildrenAtLevel finally calls CPosRguConcat::IterateAllRemove, but since PreloadChildren did not set any REMOVEPERIMPRELOAD bits, there are no CPosRgus to remove from PosRguListUns or PosRguListSel. PreloadTopDown stops at rgutype=2 because rgutypecurrent=2. CReSuConcat::UpdatePerimeters next calls PredecodeBottomUp, which uses CPosRguConcat::IterateAll to call CEntryCache::PredecodeOne for each of the two Page-of-Blocks CPosRgus in Concats[2]. PredecodeOne first encounters the CPosRgu with RguFile=“Pages/groceries.pag” and mbRgu=(0×0, 0×a, 0×0, 0×8), finds that IsInPerimPredecode returns true and INPERIMPREDECODE is not set, sets INPERIMPREDECODE, finds that INMEMPREDECODE is not set, calls CMioEntry::DecodeMio followed by CMioEntry::DownscaleFromScaleZero for the CPosRgu's RedMioEntry (CMidEntry for “Pages/groceries.mio”), and sets INMEMPREDECODE. PredecodeOne similarly encounters the CPosRgu with RguFile=“Pages/general.pag” and mbRgu=(0×0, 0×a, 0×8, 0×10), again finds that IsInPerimPredecode returns true and INPERIMPREDECODE is not set, again sets INPERIMPREDECODE and finds that INMEMPREDECODE is not set, again calls CMioEntry::DecodeMio followed by CMioEntry::DownscaleFromScaleZero for the CPosRgu's RedMioEntry (CMioEntry for “Pages/general.mio”), and again sets INMEMPREDECODE.

CReSuConcat::UpdatePerimeters skips PreloadAndDecodeDownward, because preloadingdownward is false. CChildSwitch::InitChildArea's calls SetScrollRangeVid, which computes numscales=0×6 and nScaleGrads=0×4e, makes the call to CWnd::SetScrollRange, and sets CCoordSys::scaleposmax to 0×4d. CChildSwitch::InitChildAreas calls SetScrollPosVid, which computes subscalepos=0×3, levelpos=0×34, and scalepos=0×16, and makes the call to CWnd::SetScrollPos. CChildSwitch::InitChildAreas calls CVidArea::InitVidArea to initialize rendering-related data structures and perform initial rendering into the video buffer. CChildSwitch::InitChildAreas computes cangoback=cangoforward=false, calls CToolArea::InitToolArea to initialize toolbar-related data structures, calls CToolWnd::ComboAddString to add items to the toolbar area combobox, and sends WM_ENABLEBUTTONS to CToolWnd to (via CToolArea::EnableButtons) to calculate the enable states of toolbar buttons and render them accordingly. CChildSwitch::InitChildAreas finally calls CRepArea::InitRepArea, which merely provides theRepCWnd::theRepArea with a pointer to theVidCWnd::theVidArea. Finally, CChildSwitch::GoToHistEntry finds levelsdown=0 and therefore skips CReSuConcat::DescendLevels, etc (LevelDelta of linktoOCX.htm is 0), and calls CReSuConcat::SetLevelInit to set CReSuConcat::levelinit=0.

CCoordSys tracks the position of the mouse in (xcurrent, ycurrent). CVidWnd::OnMouseMove calls CVidArea::OnMouseMove, which calls CCoordSys::SetViewCoords, which updates xcurrent and ycurrent to the CPoint input of OnMouseMove (and also sets (xdcurr, ydcurr)). While the mouse is up, Zoosh does not perform navigational shifting. However, CVidArea::OnMouseMove calls functions (ultimately CPosRguConcat::FindMatchUns and CPosRguConcat::SelToUnsTail) which implement a one-CPosRgu mouseover-driven automatic selection range (“autoselect”), which can cause redistribution of CPosRgus between PosRguListUns and PosRguListSel of a given CPosRguConcat, and reordering of CPosRgus within either PosRguListUns or PosRguListSel. Therefore, in the descriptions below, the order of CPosRgus considered during an iteration is arbitrary. CVidWnd::OnMouseMove also calls CVidWnd::ProcessDidFlags, which sends the WM_SHOWDATAURL message to the Zoosh control's window whenever a shopping cart or other non-mall PosRguListSel has one and only one CPosRgu that has just been selected (DIDUNSTOSEL of CVidArea::DidFlags set, eg due to autoselect on mouseover). CZooshCtrl::ShowDataURL fires Zoosh's ShowDataURL event as long as its DataURL string is nonempty, causing the information in DataURL to be displayed in frames[1]. FIG. 11A shows Zoosh after loading stores.sec (note xDstViewTL=yDstViewTL=0); the Page CPosRgu whose SubMioImage is “SubMios/subgroceries.mio” is hilited, and frames[1] is unchanged because DataURL for the hilited CPosRgu is empty.

### EXAMPLE #1

Preloading Blocks Responsively to Downward Level Jump; Downward Level Jump Using Enter Key

In order to jump downward from Pages level to Blocks level, the user presses the Enter key. CZooshCtrl::OnKeyDown calls CVidWnd::ProcessKeyDown, which calls CVidArea::OnKeyDown, which calls CVidArea::doEnterKeyDown, which posts a WM_DESCENDLEVELSMOUSE message to the parent of theVidCWnd (ie to the Zoosh control's window), with parameter SCALESPERLEVELJUMP (=>descend one rgutype). CVidWnd::ProcessKeyDown sends WM_ENABLEBUTTONS to the toolbar area's window (though no toolbar enable state has yet changed), but does not send WM_DRAWREPAREA to the reporting area's window because iscartupdate is false. CZooshCtrl::DescendLevelsMouse (handler for WM_DESCENDLEVELSMOUSE) calls CChildSwitch::DescendLevels, which calls CReSuConcat::DescendLevelsStepped. DescendLevelsStepped computes leveltarget=2 (levelcurrent is 4), and calls CReSuConcat::DescendLevels only once. DescendLevels calls PreloadChildrenAtLevel with rgutype=1, which uses CPosRguConcat::IterateAll to call CEntryCachc::PreloadChildren for each of the two Page-of-Blocks CPosRgus in Concats[2] (the order of which varies depending upon mouse-up autoselect activity). PreloadChildren calls IsInPerimPreload for each of the 9 Block-of-Panels CPosRgus listed above, finding for each in turn that IsInPerimPreload returns false (mbRgu lies outside the perimeter) and INPERIMPRELOAD is not set. For example, the CPosRgu with RguFile “Blocks/householditems.blk” is nearest, with (mbxRguBR, mbyRguBR)=(0×40, 0×28) so that its bottom right pixel-scale coordinates are (0×200, 0×140); however, the top left coordinates of PerimPreload[1] (which have not yet been updated in response to the downward level jumping) are (0×294, 0×468), so that mbRgu does not overlap the preload perimeter. Thus PreloadChildren takes no action for any of the 9 CPosRgus.

CReSuConcat::DescendLevels sets levelprev=4, levelcurrent=2, levelrootprev=6, and levelroot=6; ie, the call to SetLevelCurrent lowers levelcurrent, but the call to SetLevelRoot does not lower levelroot, because levelroot was limited to less than levelcurrent+ROOTJUMPTARGET at initialization time due to the absence of a predefined upward link in “Sections/stores.sec”. CReSuConcat::DescendLevels does not find a CPosRgu in either PosRguListUns or PosRguListSel of Concats[1] (none of the 9 Block-of-Panels CPosRgus were loaded above), then finds and assigns to cprRoot the CPosRgu for “Pages/general.pag” in Concats[2] (this can vary depending upon mouse-up autoselect activity). CReSuConcat::DescendLevels follows this CPosRgu upward for one rgutype, ending up where it began, ie cprRoot=cprRootPrev, and DescendLevelsStepped returns leveldelta=0×fffffffe (ie—SCALESPERLEVELJUMP as expected). CChildSwitch::DescendLevels finally calls SetScrollRangeVid (nScaleGrads does not change because levelroot did not change) and ChangeLevelFinish. ChangeLevelFinish calls CCoordSys::FixDestScale with scaledelta=0×fffffffe and useMouse true, which uses CCoordSys::GetCenter to obtain the current mouse position (xc, ye)=(0×46, 0×e) (arbitrary result of mouse-up cursor movement). FixDestCalc computes (xSrcFix, ySrcFix)=(0×0, 0×0) (no change), and (xDstViewTL, yDstViewTL)=(0×d2, 0×2a), thus lowering the level of the coordinate system by SCALESPERLEVELJUMP. FixDestScale finally calls InitSrcTLCoords, which calls UpdateSrcTLCoords, which computes (xSrcViewTL, ySrcViewTL)=(0×d2, 0×2a), (xSrc, ySrc)=(0×ffffff6a, 0×ffffff3a), (mbxVideoTL, mbyVideoTL)=(0×fffffff7, 0×fffffff4), (xViewAdj, yViewAdj)=(0×fffffffa, 0×fffffffa), and (mbxVideoTLrem, mbyVideoTLrem)=(0×63, 0×38).

ChangeLevelFinish calls CChildSwitch::UpdatePerimeters, which calls CReSuConcat::UpdatePerimeters, which calls CReSuConcat::DetPerimeters, which calls CCoordSys::DetPerimeters after updating the CCoordSys copies of rgutyperoot (no change) and rgutypecurrent (2 to 1). CCoordSys::DetPerimeters recomputes:

PerimPreload[2]=PerimPredecode[2]=(0×fffffebd, 0×1ed, 0×fffffe28, 0×338)

PerimPreload[1]=PerimPredecode[1]=(0×ffffff37, 0×377, 0×ffffff64, 0×624)

PerimPreload[0]=PerimPredecode[0]=(0×33c, 0×77c, 0×7b0, 0×e70)

PerimPreload[2] and PerimPredecode[2] are now smaller than before, due to APRONFACTORUP (hPreloadUp[1]=0×330=0.75 * hPreloadUp[0], and wPreloadUp[1]=0×510=0.75 * wPreloadUp[0]), and all of the new positioned perimeter rectangles reflect changes to (xDstViewTL, yDstViewTL).

CReSuConcat::UpdatePerimeters next calls PreloadTopDown, which calls PreloadChildrenAtLevel first for rgutype=2 then for rgutype=1. In the case rgutype=2, PreloadChildrenAtLevel calls CEntryCache::PreloadChildren to preload children of cprRoot, iterating through the same PosRguListBpss as before, but now adding to a PosRguListUns which (along with its associated PosRguListSel) already contains both Page-of-Blocks CPosRgus. In both cases, IsInPerimPreload returns true but INPERIMPRELOAD is already set, so PreloadChildren takes no action. In the case rgutype=1, PreloadChildrenAtLevel uses CPosRguConcat::IterateAll to call CEntryCache::PreloadChildren for each of the two Page-of-Blocks CPosRgus in Concats[2]. For each of the 9 Block-of-Panels CPosRgus in turn, PreloadChildren finds that IsInPerimPreload returns true and INPERIMPRELOAD is not set, sets INPERIMPRELOAD, adds the CPosRgu to PosRguListUns, finds that INMEMPRELOAD is not set, calls PreloadOne to preload the CPosRgu, overwrites an empty RguUpward with cprRoot::RguFile, and sets INMEMPRELOAD. For each of the 9 Block-of-Panels CPosRgus, PreloadOne reads an MIO file from the “Blocks” directory for the RedMioEntry, reads a BLK file from the “Blocks” directory for the ZshFileEntry, and reads an MIO file from the “SubMios” directory for the SubMioEntry (see list of Block-of-Panels CPosRgus above). For example, when CPosRgu::RguFile is “Blocks/householditems.blk”, PreloadOne reads “Blocks/householditems.mio” for the RedMioEntry, “Blocks/householditems.blk” for the ZshFileEntry, and “SubMios/subwidelightbulb.mio” for the SubMioEntry. In PreloadOne's call to CBpssEntry::InitPosRguList, (mbxbase, mbybase)=(0×80, 0×70) because the top left of the component at level 4 is (0×20, 0×1c) and SCALESPERLEVELJUMP is 2. Local variable tempptr points to file data which yields ncomponents=0×20 Panels (same layout as in FIG. 6F; see file listing for householditems.blk in Appendix 2), each of which is found to be within bounds, added to PosRguListBpss, and offset by (mbxbase, mbybase)=(0×80, 0×70). To continue the example, when CPosRgu::RguFile is “Blocks/electronics.blk”, PreloadOne reads “Blocks/electronics.mio” for the RedMioEntry, “Blocks/electronics.blk” for the ZshFileEntry, and “SubMios/subwideCDdrive.mio” for the SubMioEntry. In PreloadOne's call to CBpssEntry::InitPosRguList, (mbxbase, mbybase)=(0×80, 0×38) because the top left of the component at level 4 is (0×20, 0×e) and SCALESPERLEVELJUMP is 2. Local variable tempptr points to file data which yields ncomponents=0×20 Panels (same layout as in FIG. 6E; see file listing for electronics.blk in Appendix 2), each of which is found to be within bounds, added to PosRguListBpss, and offset by (mbxbase, mbybase)=(0×80, 0×38).

PreloadChildrenAtLevel finally calls CPosRguConcat::IterateAllRemove, but since PreloadChildren did not set any REMOVEPERIMPRELOAD bits, there are no CPosRgus to remove from PosRguListUns or PosRguListSel. CReSuConcat::UpdatePerimeters calls PredecodeBottomUp, which uses CEntryCache::PredecodeOne to decode for RedMioEntry and SubMioEntry members of Block-of-Panels (rgutype=1) CPosRgus in the aforedescribed fashion. PredecodeBottomUp also calls CEntryCache::PredecodeOne for Page-of-Blocks (rgutype=2) CPosRgus. With the particular mouse position (xcurrent, ycurrent)=(0×46, 0×e) PredecodeOne finds, for each of the 2 Page-of-Blocks CPosRgus, that IsInPerimPredecode returns true and INPERIMPREDECODE is already set, and takes no action. For other mouse positions PredecodeOne would find, for one or both of the Page-of-Blocks CPosRgus, that IsInPerimPredecode returns false and would take then clear INPERIMPREDECODE. CReSuConcat::UpdatePerimeters does not call PreloadAndDecodeDownward because preloadingdownward is false. CChildSwitch::ChangeLevelFinish finally calls SetScrollPosVid and SetConcat. SetScrollPosVid computes subscalepos=0×3, levelpos=0×1a (levelcurrent has changed), and scalepos=0×30, and makes the call to CWnd::SetScrollPos. SetConcat calls CVidArea::SetConcat to rerender into the video buffer (CVidArea::SetConcat also calls CWnd::Invalidate so that CVidWnd::OnPaint will ultimately update the screen), calls BrowsersOnOff to complete rerendering by instantiating web browser objects for the 3 CPosRgus with nonempty CellURL[0] (ie dairyleft.blk, vegetablesleft.blk, and fruitleft.blk, containing embframedairy.htm, embframevegetables.htm, and embframefruit.htm respectively; see above), and causes theToolCWnd::theToolArea to recompute enable states and rerender by sending WM_ENABLEBUTTONS to theToolCWnd. BrowsersOnOff calls CVidArea::BrowsersOnOff, which sends WM_BROWSERSONOFF to the Zoosh control's window, which ultimately leads (9 times) to CEntryCache::BrowserOnOff. For example, CEntryCache::BrowserOnOff finds for the CPosRgu with RguFile=“Blocks/dairyleft.blk” that IsInPerimPreload returns true and calls InstantiateBrowser. InstantiateBrowser finds that theWebBrowser=NULL, get_isHTMLCell returns true, and get_CellURL[scale=0] is nonempty. InstantiateBrowser therefore creates a new web browser object using operator new, gives it an HWND by calling CWebBrowser2::Create with rectangle cr=(0×196, 0×256, 0×ffffff2e, 0×2e), and causes the web browser object to render CellURL[0] by calling CWebBrowser2::Navigate. FIG. 11B shows Zoosh after jumping downward using the Enter key; DataURL for the hilited CPosRgu is again empty.

### EXAMPLE #2

Preloading Blocks Responsively to Navigational Shift; Downward Level Jump Using “Square +” Tool; Mouse-Down Lateral Navigation

In order to jump downward from Pages level to Blocks level, the user clicks the mouse over the “square +” tool 915. CToolWnd::OnLButtonDown calls CToolArea::OnLButtonDown, which calls TakeButtonAction with index=5=TOOLBMPDOCRGULOWER. TakeButtonAction posts the WM_DESCENDLEVELSCENTER message with parameter SCALESPERLEVELJUMP to the Zoosh control's window, which CZooshCtrl eventually routes to CZooshCtrl::DescendLeveIsCenter, which calls CChildSwitch::DescendLevels with levelsdown=SCALESPERLEVELJUMP and useMouse false. Downward level jumping by one rgutype proceeds as with useMouse true (Enter key; see Example #1), but ChangeLevelFinish now calls CCoordSys::FixDestScale with useMouse false, which calls GetCenter with useMouse false, which returns view center (xc, yc)=(0×1f2, 0×12d) instead of the current mouse position. FixDestCalc computes (xSrcFix, ySrcFix)=(0×0, 0×0) (no change), and (xDstViewTL, yDstViewTL)=(0×5d6, 0×387), thus lowering the level of the coordinate system by SCALESPERLEVELJUMP. FixDestScale finally calls InitSrcTLCoords, which calls UpdateSrcTLCoords, which computes (xSrcViewTL, ySrcViewTL)=(0×5d6, 0×387), (xSrc, ysrc)=(0×46e, 0×296), (mbxVideoTL, mbyVideoTL)=(0×47, 0×29), (xViewAdj, yViewAdj)=(0×fffffffe, 0×6), and (mbxVideoTLrem, mbyVideoTLrem)=(0×47, 0×29).

As in case useMouse true, ChangeLevelFinish calls CChildSwitch::UpdatePerimeters, which calls CReSuConcat::UpdatePerimeters, which calls CReSuConcat::DetPerimeters, which calls CCoordSys::DetPerimeters after updating the CCoordSys copies of rgutyperoot (no change) and rgutypecurrent (2 to 1). CCoordSys::DetPerimeters now recomputes:

PerimPreload[2]=PerimPredecode[2]=(0×ffffff95, 0×2c5, 0×ffffff6a, 0×47a)

PerimPreload[1]=PerimPredecode[1]=(0×294, 0×6d4, 0×468, 0×b28)

PerimPreload[0]=PerimPredecode[0]=(0×10b0, 0×14f0, 0×1bc0, 0×2280) As in case useMouse true, CReSuConcat::UpdatePerimeters calls PreloadTopDown, which calls PreloadChildrenAtLevel first for rgutype=2 then for rgutype=1. Again in the case rgutype=2, IsInPerimPreload returns true and INPERIMPRELOAD is already set for both Page-of-Blocks CPosRgus, so PreloadChildren takes no action. In the case rgutype=1, PreloadChildren now finds that none of the 9 Block-of-Panels CPosRgus are within perimeter: in each of the 9 cases, IsInPerimPreload returns false, INPERIMPRELOAD is not set, and PreloadChildren takes no action. PredecodeBottomUp now has nothing to decode at rgutype=1, and finds again at rgutype=2 that, for both Page-of-Blocks CPosRgus, IsInPerimPredecode returns true and INPERIMPREDECODE is already set. CChildSwitch::ChangeLevelFinish proceeds as in case useMouse true, except that BrowsersOnOff has no effect since there are no Block-of-Panels web browser objects to instantiate, (and the Images button 919 is no longer enabled; see later examples).

In order to initiate mouse-down lateral navgation for the purpose of bringing Block-of-Panels CPosRgus into view, the user clicks the mouse button somewhere inside the main content area of Zoosh. CVidWnd::OnLButtonDown calls CVidArea::OnLButtonDown, which calls CCoordSys::SetViewCoords, which updates (xcurrent, ycurrent) to the CPoint input of OnLButtonDown. CVidArea::OnLButtonDown sets a flag (the “N” bit) which indicates that mouse-down lateral navigation is occurring (and calls functions that, under other circumstances, would update the video buffer and screen display according to changes in hilite state, etc). While holding down the mouse button, the user moves the mouse in the general direction of the bottom right comer of the screen. The MFC framework repeatedly calls CVidWnd::OnMouseMove, which calls CVidArea::OnMouseMove, which calls CCoordSys::SetViewCoords to update (xcurrent, ycurrent) and set (xdcurr, ydcurr). CVidArea::OnMouseMove calls CCoordSys::UpdateSrcTLCoords to update (xDstViewTL, yDstViewTL), (xSrcViewTL, ySrcViewTL), (mbxVideoTL, mbyVideoTL), (xViewAdj, yViewAdj), and (mbxVideoTLrem, mbyVideoTLrem). CVidArea::OnMouseMove updates the video buffer and screen display (scrolling and redrawing other than through CVidWnd::OnPaint) according to changes in (mbxVideoTL, mbyVideoTL), and posts a WM_UPDATEPERIMETERS message to the parent of theVidCWnd (ie to the Zoosh control's window). CZooshCtrl::UpdatePerimeters calls CChildSwitch::UpdatePerimeters, which calls CReSuConcat::UpdatePerimeters, which calls DetPerimeters, PreloadTopDown, etc as if called from CChildSwitch::ChangeLevelFinish. Eventually, CEntryCache::PreloadChildren begins to encounter Block-of-Panels CPosRgus that are within perimeter (and for which INPERIMPRELOAD is not already set).

For example, PreloadChildren finds that the CPosRgu with RguFile=“Blocks/householditems.blk” and mbRgu=(0×1c, 0×28, 0×20, 0×40) is within PerimPreload[1]=(0×266, 0×6a6, 0×3fc, 0×abc), and that INPERIMPRELOAD is not already set. Later on (after more calls to CVidWnd::OnMouseMove), PreloadChildren finds that the CPosRgu with RguFile=“Blocks/electronics.blk” and mbRgu=(0×e, 0×1a, 0×20, 0×40) is within PerimPreload[1]=(0×19e, 0×5de, 0×290, 0×950), and that its INPERIMPRELOAD is not already set. In both cases, as described above, PreloadChildren sets INPERIMPRELOAD, adds the CPosRgu to PosRguListUns, finds that INMEMPRELOAD is not set, calls PreloadOne to preload the CPosRgu, overwrites an empty RguUpward with cprRoot::RguFile, and sets INMEMPRELOAD. PreloadOne calls InitPosRguList to create CPosRgus and offset the top left coordinates of each, as described in Example #1. Eventually, the user releases the mouse button, the MFC framework calls CVidWnd::OnLButtonUp, which calls CVidArea::OnLButtonUp, which clears the “N” bit and sends a WM_BROWSERSONOFF message to the parent of theVidCWnd (to reduce rendering latencies, web browser objects are not automatically instantiated during mouse-down lateral navigation). CZooshCtrl::BrowsersOnOff calls CChildSwitch::BrowsersOnOff, which calls CReSuConcat::BrowsersOnOff, which leads to CEntryCache::BrowserOnOff as in Example #1.

### EXAMPLE #3

Preloading Blocks and Panels in Topdown Fashion Responsively to Navigational Shift; Lowering of cprRoot

As in Example #2, in order to jump downward from Pages level to Blocks level, the user clicks the mouse over the “square +” tool 915, and PreloadChildren finds that none of the 9 Block-of-Panels CPosRgus are within perimeter. Now the user clicks the “square +” tool 915 a second time to jump downward from Blocks level to Panels level. CReSuConcat::DescendLevels calls SetLevelCurrent to lower levelcurrent from 2 to 0 and rgutypecuitent from 1 to 0, and calls SetLevelRoot to lower levelroot from 6 to 4 and rgutyperoot from 3 to 2 (lowering of rgutyperoot is now successful because levelroot and levelcurrent are separated by ROOTJUMPTARGET on input). CReSuConcat::DescendLevels fails to find a CPosRgu in either PosRguListUns or PosRguListSel of Concats[0] or Concats[1], then finds and assigns to cprRoot the CPosRgu for “Pages/general.pag” in Concats[2]. In contrast to the case of Example #1, CReSuConcat::DescendLevels does not follow this cprRoot upward, because it is already at rgutype=rgutyperoot=2. EmptyTreePerim removes all CPosRgus from all Concats[ ] in preparation for a complete repopulation by PreloadTopDown (the CPosRgu for “Pages/groceries.pag” in Concats[2] no longer belongs in the Concat because it is a sibling of cprRoot, while only progeny of cprRoot are permitted in the preload perimeter tree; the CPosRgu for “Pages/general.pag” itself is also removed because it is unnecessary in that PreloadTopDown does not reference Concats[rgutyperoot], and because it doesn't technically have to be within perimeter anyway). Since isRootDisembodied is true and cprRoot is being replaced (cprRoot is not equal to cprRootPrev), CReSuConcat::DeleteRootPrev NULLs CprUpward of all children of cprRootPrev::ZshFileEntry (while retaining the dissociated ZshFileEntry in CEntryCache for possible later use), and deletes the previous cprRoot (a disembodied cprRoot). CReSuConcat::DescendLevels and CReSuConcat::DescendLevelsStepped each return leveldelta=0×fffffffe as expected. PerimPreload[1] is (0×31b, 0×64b, 0×540, 0×a50), and PreloadChildren again finds that none of the 9 Block-of-Panels CPosRgus are within perimeter. Since no Block-of-Panels CPosRgus have been preloaded, Concats[1] cannot contain any Block CPosRgus, and CReSuConcat::PreloadTopDown cannot (through PreloadChildrenAtLevel) make any PreloadChildren calls for Concats[0]. CToolArea::EnableButtons disables TOOLBMPDOCRGULOWER, since islevelmin is now true.

The user again initiates mouse-down lateral navigation, and moves the mouse in the general direction of the bottom right corner of the screen. Eventually, CEntryCache::PreloadChildren begins to encounter Block-of-Panels CPosRgus that are within perimeter (and for which INPERIMPRELOAD is not already set). For example, PreloadChildren finds that the CPosRgu with RguFile=“Blocks/householditems.blk” and mbRgu=(0×1c, 0×28, 0×20, 0×40) is within PerimPreload[1]=(0×267, 0×597, 0×3fe, 0×90e), and preloads the CPosRgu as described above. CReSuConcat::PreloadTopDown calls PreloadChildrenAtLevel with rgutype=0, and in this example CEntryCache::PreloadChildren now finds that no children of the preloaded Block-of-Pages CPosRgu are yet within PerimPreload[0]=(0×de2, 0×1222, 0×16be, 0×1d7e). As the user continues to move the mouse, PreloadTopDown is called repeatedly, sometimes resulting in one or more Panels entering the perimeter, sometimes one or more Blocks, sometimes both, sometimes neither (when preloading Panels, PreloadOne creates a new CPanEntry instead of a new CBpssEntry, and does not call InitPosRguList). For example, the following sequence is observed (excluding mouse moves which result in neither Panels nor Blocks being added):

| RguFile(s) | PerimPreload[1] | PerimPreload[0] |
|---|---|---|
| “Blocks/householditems.blk” | (0x267, 0x597, 0x3fe, 0x90e) | (0xde2, 0x1222, 0x16be, 0x1d7e) |
| “Blocks/electronics.blk” | (0x19d, 0x4cd, 0x29a, 0x7aa) | (0xaba, 0xefa, 0x112a, 0x17ea) |
| “Panels/toaster2.pan” | (0x16f, 0x49f, 0x240, 0x750) | (0x9fc, 0xe3c, 0xfc0, 0x1680) |
| “Panels/toaster1.pan” | (0x15b, 0x48b, 0x21e, 0x72e) | (0x9b2, 0xdf2, 0xf3c, 0x15fc) |
| “Panels/lightbulb2.pan” | (0x10b, 0x43b, 0x1be, 0x6ce) | (0x86e, 0xcae, 0xdba, 0x147a) |
| “Panels/lightbulb1.pan” | same mouse move as above | same mouse move as above |
| “Panels/powerstrip2.pan” | same mouse move as above | same mouse move as above |
| “Panels/pail2.pan” | same mouse move as above | same mouse move as above |
| “Panels/pail1.pan” | same mouse move as above | same mouse move as above |
| “Panels/sponge2.pan” | same mouse move as above | same mouse move as above |
| “Panels/microwave2.pan” | same mouse move as above | same mouse move as above |
| “Panels/sofa2.pan” | same mouse move as above | same mouse move as above |
| “Panels/sofa1.pan” | same mouse move as above | same mouse move as above |
| “Panels/table2.pan” | same mouse move as above | same mouse move as above |
| “Panels/sponge1.pan” | same mouse move as above | same mouse move as above |
| “Panels/powerstrip1.pan” | same mouse move as above | same mouse move as above |
| “Panels/table1.pan” | same mouse move as above | same mouse move as above |
| “Panels/microwave1.pan” | same mouse move as above | same mouse move as above |
| “Panels/rotisserie2.pan” | (0xdd, 0x40d, 0x16e, 0x67e) | (0x7b6, 0xbf6, 0xc7e, 0x133e) |
| “Panels/fan2.pan” | same mouse move as above | same mouse move as above |
| “Panels/mop2.pan” | same mouse move as above | same mouse move as above |
| “Panels/lamp2.pan” | same mouse move as above | same mouse move as above |
| “Blocks/officesupplies.blk” | (0x6d, 0x39d, 0x172, 0x682) | (0x5f8, 0xa38, 0xc8a, 0x134a) |
| “Panels/CDplayer2.pan” | same mouse move as above | same mouse move as above |
| “Panels/speakers2.pan” | same mouse move as above | same mouse move as above |
| “Panels/amplifier2.pan” | same mouse move as above | same mouse move as above |
| “Panels/boombox2.pan” | same mouse move as above | same mouse move as above |
| “Panels/telephone2.pan” | same mouse move as above | same mouse move as above |
| “Panels/television2.pan” | same mouse move as above | same mouse move as above |
| “Panels/printer2.pan” | same mouse move as above | same mouse move as above |
| “Panels/scanner2.pan” | same mouse move as above | same mouse move as above |

FIG. 11C shows Zoosh after a series of mouse-down lateral navigations similar to the above, bringing Panels from householditems.blk into view; note black stripes where some decoded material is absent due to WPREDECODEAPRON=0, etc: see Example #6).

### EXAMPLE #4

Preloadingdownward Turned on; Preloading Blocks and Panels in Anticipation of Level Jump

Proceeding as in the Basic Initialization except with preloadingdownward turned on (set true in CReSuConcat constructor), the call to CReSuConcat::UpdatePerimeters during initialization finds preloadingdownward=true and calls PreloadAndDecodeDownward, which calls PreloadChildrenAtLevel for rgutype=1. However, for each of the 9 Block-of-Panels CPosRgus, CEntryCache::PreloadChildren takes no action after finding that IsInPerimPreload returns false and INPERIMPRELOAD is not set.

The user initiates mouse-down lateral navigation, and moves the mouse in the general direction of the bottom right corner of the screen until the 2 Pages are displayed at approximately the center of the screen. Along the way, CReSuConcat: UpdatePerimeters is calling PreloadAndDecodeDownward, which is calling PreloadChildrenAtLevel with rgutype=1, which is calling PreloadChildren for each CPosRgu in Concats[2], which is encountering Block-of-Panels CPosRgus that are within perimeter and preloading them. After an OnMouseUp call, PerimPreload[1]=(0×ffffff1c, 0×35c, 0×fffffea0, 0×560), all 9 blocks have been preloaded and remain within perimeter, and Concats[0]::PosRguListUns (as well as CEntryCache::PanEntryList) is still empty because CReSuConcat::PreloadAndDecodeDownward operates only on rgutypedownward=rgutypecurrent−1. PreloadandDecodeDownward has furthermore called PredecodeOne for each preloaded Block, so that all 9 INPERIMPREDECODE and INMEMPREDECODE bits arc set. FIG. 11D shows Zoosh after the two Pages have been moved roughly to the center of view.

The user clicks the mouse on the “square +” tool 915 in order to jump downward from Pages level to Blocks level, CChildSwitch::DescendLevels calls CReSuConcat::DescendLevelsStepped to lower levelcurrent (CReSuConcat::DescendLevels does not use PreloadAndDecodeDownward because preloadingdownward is true), then calls ChangeLevelFinish, which eventually leads to CReSuConcat::UpdatePerimeters, which calls DetPerimeters to set PerimPreload[1]=(0ffffff24, 0×364, 0×fffffe70, 0×530) and PerimPreload[0]=(0×2f0, 0×730, 0×3e0, 0×aa0), and does call PreloadAndDecodeDownward, wherein rgutypedownward=0. After PreloadAndDecodeDownward's call to PreloadChildrenAtLevel(0), Concats[0]::PosRguListUns contains 0×2a leaf-level CPosRgus, indicating that PreloadChildren found 0×2a components from various Blocks' PosRguListBpss lists to be within perimeter. For example, Concats[0]::PosRguListUns contains a CPosRgu with RguFile=“Panels/tacks1.pan”, whose mbRgu of (0×20, 0×30, 0×90, 0×a4) overlaps PerimPreload[0]. However, CEntryCache::PanEntryList contains only 0×20 CPanEntrys, because 0×a of the PosRguListUns CPosRgus represent components which have RguFile=“” and nonempty CellURL[0]; ie, they are HTML-only components. For example, PosRguListUns contains a CPosRgu with RguFile=“” and CellURL[0]=“HTMLfiles/vegetables/cellframes/vegright118a.htm”, whose mbRgu of (0×44, 0×50, 0×40, 0×80) overlaps PerimPreload[0]. PreloadAndDecodeDownward finishes by decoding Panel image data. ChangeLevelFinish calls SetConcat, which calls CVidArea::SetConcat, which updates the video buffer using Block image data that was predecoded during lateral navigation (only Panel image data was decoded responsively to the downward level jump).

### EXAMPLE #5

Preloading Panels Responsively to Scaling with “Round −” Tool

Using ROOTJUMPNRGUTYPES=3 instead of 2 (so that ROOTJUMPTARGET is 6 instead of 4; in order to prevent cprRoot from dropping below Section-of-Pages level as happened in Example #3), and continuing from where Example #4 leaves off, the user clicks the mouse on the “square +” tool 915 a second time in order to jump downward from Blocks level to Panels level. Unlike Example #3, CReSuConcat::DescendLevels leaves rgutyperoot=3 and does not lower cprRoot, and PreloadTopDown operates on rgutypes 2, 1, and 0. PerimPreload[0]=(0×2f0, 0×730, 0×3e0, 0×aa0) does not change because the previous calculation of PerimPreload[0] used APRONFACTORDOWN=1.0. PreloadChildrenAtLevel(0) therefore preloads no new leaf-level PosRguListBpss components. In PreloadAndDecodeDownward, no action is taken because rgutypedownward=−1 (leaf rgutype=0 is the lowest rgutype, so downward preloading is impossible). FIG. 11E shows Zoosh after jumping downward to Panels level from the position shown in FIG. 11D; upon downward jumping, a CPosRgu with nonempty DataURL happens to have been hilited, resulting in the update to frames[1] (the user has also in this case moved the mouse over a different CPosRgu, and clicked the mouse once to instantiate an uninstantiated web browser object).

In order to apply counteractive decimation (resolution reduction) by a factor of 2, the user clicks the mouse over the “round −” tool 918. CToolArea::TakeButtonAction calls CVidArea::TrackScalePosSpan with the parameter nSpans=−1, which calls CVidArea::TrackScalePos with parameters posdelta=0×fffffff3 and useMouse=false. TrackScalePos reads scaleposA=0×4a, makes the call to CWnd::SetScrollPos (as in CChildSwitch::SetScrollPosVid), and reads back the updated scaleposB=0×3d (under some circumstances, scaleposB can be unequal to scaleposA+posdelta, due to range limitations established by CChildSwitch::SetScrollRange). TrackScalePos calls CCoordSys::UpdateFix with parameters upxDst=0×6 and upyDst=0×6, uwDst=0×40 and uhDst=0×40 (2 to the powers upxDst and upyDst respectively), uwSrc=0×40 and uhSrc=0×40 (meaning smallest blittable unit sizes are the same for source and dest, since multiplier=CODEDUNITPOWER; see discussion of class CCoordSys; CVidArea::theVidLens represents a rendering class not disclosed herein). CCoordSys::UpdateFix updates (xDstViewTL, yDstViewTL) to (0×fffffe0e, 0×fffffee3) from (0×54e, 0×3e3), and updates (xSrcFix, ySrcFix) to (0×740, 0×500) from (0×0, 0×0) in the change of coordinate systems; the parameter useMouse=false means that the scaling center is chosen to be near the center of the view, rather than near the position of the mouse. CCoordSys::TrackScalePos computes realpos=0×10, scaleTarg=0×1, levelTarg=0×0 (second return value), multTarg=0×10, and scaledelta=0×1 (primary return value). CCoordSys::SetScale updates scale from 0 to 1, lowers mbunitpower from 4 to 3, and lowers mbunithalf from 8 to 4; multiplier, xVVpad, and yVVpad remain unchanged. CVidArea::TrackScalePos finally sends a WM_TRACKLEVELSCENTER message to the parent of theVidCWnd with parameters levelTarg=0×0 and scaledelta=0×1.

CZooshCtrl::TrackLevelsCenter calls CChildSwitch::TrackLevels, which calls DeleteBrowsers to uninstantiate all active web browser objects (for example, the web browser object associated with the CPosRgu whose CellURL[0]=“HTMLfiles/vegetables/cellframes/vegright118a.htm”), computes leveldelta=0 and therefore does not call CReSuConcat::SetLevelCurrent, computes totdelta=0×1, and calls ChangeLevelFinish. CCoordSys::FixDestScale(0×1, false) halves (xSrcFix, ySrcFix) to (0×3a0, 0×280), and slightly modifies (xDstViewTL, yDstViewTL) to (0×fffffe0e, 0×fffffcda); scaledelta=0×1<SCALESPERLEVELJUMP is a within-rgutype scaledelta. FixDestScale calls InitSrcTLCoords, which calls UpdateSrcTLCoords, which computes (xSrcViewTL, ySrcViewTL)=(0×1ae, 0×15a), (xSrc, ySrc)=(-0×46, 0×6a), (mbxVideoTL, mbyVideoTL)=(0×9, 0×d), (xViewAdj, yViewAdj)=(0×fffffffe, 0×2), and (mbxVideoTLrem, mbyVideoTLrem)=(0×9, 0×d).

In CReSuConcat::UpdatePerimeters, DetPerimeters sets PerimPreload[0]=(0×67, 0×4a7, 0×40, 0×700). PreloadChildrenAtLevel(0), through CEntryCache::PreloadChildren, preloads 0×66 new leaf-level PosRguListBpss components (for a total of 0×90; at least one new within-perimeter CPosRgu comes from each of the 9 different Blocks), 0×5O of which result in new CPanEntrys (for a total of 0×70), 0×16 of which do not; for example, PreloadChildren encounters a CPosRgu with RguFile=“Panels/scissors1.pan”, whose mbRgu of(0×c, 0×18, 0×80, 0×90) overlaps PerimPreload[0]. PredecodeBottomUp decodes for the new CPanEntrys, and PreloadAndDecodeDownward again does nothing because rgutypedownward=−1. CChildSwitch::SetScrollPosVid computes subscalepos=0×10, levelpos=0×0, and scalepos=0×3d, and makes the call to CVidWnd::SetScrollPos. SetConcat calls CVidArea to rerender into the video buffer from scratch (CCoordSys::scale has changed, which affects among other things the pointers returned by CMioEntry::get_YUVdata), and sends (via class CVidArea) a WM_BROWSERSONOFF message to the parent of theVidCWnd (to reverse the effects of the call to DeleteBrowsers at the outset of CChildSwitch::TrackLevels). When CEntryCachc::BrowserOnOff calls InstantiateBrowser, local variable scale is now 1 instead of 0, CCoordSys::rectViewFromSrcUnit returns downscaled browser window areas (mbunitpower depends on scale), and UR-L parameters to CWebBrowser2::Navigate are now drawn from CellURL[1], not CellURL[0]. FIG. 11F shows Zoosh after the user has contracted using the “round −” tool, beginning from the position of FIG. 11E.

After further mouse-down lateral navigation in various directions, it is confirmed that CEntryCache::PanEntryList contains a total of 0×90 CPanEntrys (0×10+0×10+0×10+0×20+0×20+0×20; see FIGS. 6A-6F respectively). It is furthermore confirmed that after an appropriate series of mouse-down lateral navigations, the display adheres to the general layout of FIG. 7. Throughout such additional navigation, some CPosRgus are entering the preload and predecode perimeters while others are leaving it. For a CPosRgu that leaves the preload perimeter, CEntryCache::PreloadChildren finds that IsInPerimPreload returns false but that INPERIMPRELOAD is set, and therefore sets REMOVEPERIMPRELOAD and clears INPERIMPRELOAD; CEntryCache::RemovePerimPreload later calls DeleteBrowser for the CPosRgu in case it has an active web browser object, and returns true so that CPosRguConcat::IterateAllRemove will remove the CPosRgu from either PosRguListUns or PosRguListSel. For a CPosRgu that enters the preload perimeter after CEntryCache::PanEntryList reaches 0×90 CPanEntrys, CEntryCache::PreloadChildren finds that IsInPerimPreload returns true but that INPERIMPRELOAD is false, and therefore sets INPERIMPRELOAD and once again adds the CPosRgu to PosRguListUns, before finding that INMEMPRELOAD is already set. Confining PosRguListUns and PosRguListSel to a working set defined by the preload perimeter saves processing resources in iterations such as those performed by PreloadTopDown and PredecodeBottomUp; iterating exhaustively through CBpssEntry::PosRguListBpss via CEntryCache would be much more computationally expensive.

### EXAMPLE #6

Current-Level Perimeter Sizes Larger than Buffer Size; Preloading Blocks and Panels in Anticipation of Shifting or Scaling

During mouse-down lateral navigation with apron constants all 0×0, it is observed that areas just moving into view often lack decoded data (herein a programmable background color), especially when mouse movement is rapid. CVidArea::OnMouseMove posts (does not send) the WM_UPDATEPERIMETERS message to the Zoosh control's window (whenever mbxVideoTL or mbyVideoTL changes, due to macroblock granularity of video buffer updates), so that in some cases decoded data is not available at the time of rendering into the video buffer. The problem is compounded when additional mouse move messages from the Operating System intervene before the processing of WM_UPDATEPERIMETERS, and rapid mouse movement leading to large mouse position deltas leads to greater widths or heights of undecoded area. Proceeding as in Example #5, except using the values:

WPREDECODEAPRON 0×400

HPREDECODEAPRON 0×400

WPRELOADAPRON 0×600

HPRELOADAPRON 0×600

the CCoordSys constructor sets (wPredecodeConst, hPredecodeConst)=(0×ac0, 0×840) and (wPreloadConst, hPreloadConst)=(0×cc0, 0×a40), computes wPredecodeUp[ ], hPredecodeUp[ ], wPreloadUp[ ], and hPreloadUp[ ] according to APRONFACTORUP, and computes wPredecodeDown[ ], hPredecodeDown[ ], wPreloadDown[ ], and hPreloadDown[ ] according to APRONFACTORDOWN, (vbwidth, vbheight)=(0×6c0, 0×440) stays the same. Because apron constants are no longer 0×0, the current-level predecode perimeter is now larger than the video buffer, and each preload perimeter is now larger than its corresponding predecode perimeter; as long as the size of mouse moves (combined in sequence if queued before WM_UPDATEPERIMETERS) is not on the order of the size of apron constants, decoded data will be available at the time of video buffer updating. CCoordSys::DetPerimeters computes:

PerimPreload[2]=(0×fffffc0d, 0×64d, 0×fffffb92, 0×852)

PerimPreload[1]=(0×ffffff94, 0×9d4, 0×168, 0×e28)

PerimPredecode[2]=(0×fffffd0d, 0×54d, 0×fffffc92, 0×752)

PerimPredecode[1]=(0×94, 0×8d4, 0×268, 0×d28)

PreloadTopDown preloads the 2 Page-of-Blocks CPosRgus, and this time PreloadAndDecodeDownward finds 6 of the 9 Block-of-Panels CPosRgus (all but “Blocks/fruitleft.blk”, “Blocks/vegetablesleft.blk”, and “Blocks/dairyleft.blk”) at initialization time (prior to any lateral navigation). Centering the 2 Pages at approximately the center of the screen, with,PerimPreload[1]=(0×fffffc2c, 0×66c, 0×fffffb98, 0×858), brings all 9 Blocks within perimeter.

The user clicks the mouse on the “square +” tool 915 in order to jump downward from Pages level to Blocks level, yielding PerimPreload[1]=(0×fffffc2c, 0×66c, 0×fffffb98, 0×858) (no change) and PerimPreload[0]=(0×10, 0×a50, 0×180, 0×e40). After PreloadAndDecodeDownward, Concats[0]::PosRguListUns contains 0×98 CPosRgus (instead of 0×2a with previous apron constants), CEntryCache::PanEntryList contains 0×74 (instead of 0×20) CPanEntrys, and CEntryCache::RedMioEntryList gets 0×74 new RedMioEntrys (0×80 entries, up from 0×c). The user clicks the mouse on the “square +” tool 915 a second time in order to jump downward from Blocks level to Panels level, PerimPreload[0] stays the same because downward preloading used APRONFACTORDOWN=1.0, and no further Panels are preloaded. Further use of the “round −” tool 918 and/or mouse-down lateral navigation alters the contents of Concats[0] according to PerimPreload[0] (and sets and clears the INPERIMPRELOAD bit accordingly), sets and clears the INPERIMPREDECODE bit of CPosRgus near the boundaries of PerimPredecode[0], causes additional preloading of leaf-level CPosRgus up to a point, and supports rendering in which decoded data is always available. FIG. 11G shows Zoosh after using “round −” and MDLN at Panels level in such a manner as to approximate the appearance of FIG. 7 (note absence of black stripes).

### EXAMPLE #7

Initial LevelDelta; Initial xDstViewTL, yDstViewTL; Control of Window.Parent-Owned Javascript Variables by Frames[2] Content

In a second set of example scenarios, the user enters the hierarchy at Page-of-Blocks level by first pointing the Internet Explorer web browser to framesetPatExample.htm (p.175; see FIGS. 4-6 and 3A); like framesetOCXDirect.htm in the earlier examples, framesetPatExample.htm creates a frameset with the dimensions shown in FIG. 4 when the browser window is 1024×608 (client area dimensions in the descriptions to follow are slightly different from FIG. 4), loads website logo logostore.gif into frames[0] 400, and again initially loads toprightMain.htm into frames[1] 401. However, framesetPatExample.htm loads tableMain.htm (pp.176-177) into frames[2] 402, while framesetOCXDirect.htm loaded linktoOCX.htm. Javascript statements in tableMain.htm (p.177 line 29) handle onmouseover events for each of 12 links (one for each of the 256×192 areas shown in FIG. 5) by directing new content to frames[1]. For example, if the user moves the mouse over either the Peaches.jpg image or the text “Fruit” as shown in FIG. 5, an onmouseover handler directs toprightFruit.htm to frames[1]. Similarly, “Vegetables” and Asparagus.jpg onmouseover handlers direct toprightvegetables.htm to frames[1], “Dairy” and Cowpainting.gif onmouseover handlers direct toprightDairy.htm to frames[1], and so on for toprightHouseholdltems.htm, toprightElectronics.htm, and toprightOfficeSupplies.htm. When the user clicks on the “Try ZoomShopper!” link in any of the “topright/ . . . ” frames, the onClick event handler LinkToOCX( ) directs linktoOCX.htm to frames[2]. The “object ID=. . . >” tag in linktoOCX.htm works the same way it did in earlier examples, and javascript statements (p.207 line 20) again set the property ZooshBase to a base directory string (whatever precedes “HTMLfiles/PatExample/Zsh/linktoOCX.htm” in the full pathname), set the property ZooshLoc to Sections/Stores.sec, and set the properties Config, LevelDelta, Scale, xViewTL, and yViewTL according to window.parent values. However, in this case, the window.parent values, while initially defined in framesetPatExample.htm, have been overwritten by javascript statements in the originating “topright/ . . . ” frame.

For example, the user moves the mouse over either the text “Electronics” or CDdrive.gif (see FIG. 5), an onmouseover handler in tableMain.htm direct toprightElectronics.htm to frames[1], javascript statements in toprightElectronics.htm set window.parent values (LevelDelta=−2, xViewTL=512+wspace, yViewTL=192+hspace, where wspace=0 and hspace=32) as the page is loaded into frames[1], the user clicks on “Try ZoomShopper!” in frames[1], the onClick handler LinkToOCX( ) in toprightElectronics.htm directs linktoOCX.htm to frames[2], the “object ID=. . . >” tag tells Internet Explorer to insert a Zoosh OCX object named Zoosh1 into frames[2] occupying 100% of its area, and initialization proceeds as described earlier (though now with LevelDelta=−2, xViewTL=512, and yViewTL=224, instead of all 0).

With preloadingdownward once again turned off, ROOTJUMPNRGUTYPES=3 as in Example #5, and apron constants as in Example #6, CChildSwitch::GoToHistEntry behaves as usual (ReplaceRoot creates a disembodied cprRoot having RguFile=“Sections/stores.sec”) until InitChildAreas calls CCoordSys::DefInitCoords with che->xDstViewTL=0×200, che->yDstViewTL=0×e0, and che->LevelDelta=−2. Since doFixDest is true, DefInitCoords uses FixDestCalc to modify (initxSrcFix, initySrcFix)=(0×0, 0×0) and (initxDstViewTL, inityDstViewTL)=(0×200, 0×e0) according to LevelDelta and view center (xc, yc)=(0×1f2, 0×12d), yielding (initxSrcFix, initySrcFix)=(0×0, 0×0) and (initxDstViewTL, inityDstViewTL)=(0×ffffff0a, 0×ffffff56); that is, since Zoosh interprets its properties xDstViewTL and yDstViewTL as applying to Pages level (input is .sec)+LevelDelta=4−2=2, and since UpdatePerimeters will first operate at Pages level (input is .sec), then FixDestCalc should reverse-compensate (xDstViewTL, yDstViewTL) using scaledelta=−LevelDelta=+2. InitCoordSys calls InitSrcTLCoords, which calls UpdateSrcTLCoords, which yields correspondingly different values of (xDstViewTL, yDstViewTL), (xSrcViewTL, ySrcViewTL), (mbxVideoTL, mbyVideoTL), etc. In CReSuConcat::UpdatePerimeters (wherein rgutypecurrent is 2, not yet 1), PreloadTopDown finds both Page-of-Blocks CPosRgus given PerimPreload[2]=(0×fffffb63, 0×5a3, 0×fffffa9c, 0×75c), but Concats[19 and CEntryCache::BlkEntryList remain empty because preloadingdownward is false. CVidArea::InitVidArea initializes the video buffer (wastefully, it will later turn out) according to rgutypecurrent=2, and ReplaceChildAreas eventually returns to GoToHistEntry.

GoToHistEntry now calls CChildSwitch::DescendLevels with levelsdown=2, which calls CReSuConcat::DescendLevelsStepped, which calls CReSuConcat::DescendLevels, which preloads all 9 Block-of-Panels CPosRgus via PreloadAndDecodeDownward (since preloadingdownward is false; if preloadingdownward were true, this would have been done by UpdatePerimeters above; PerimPreload[1]=(0×fffffcec, 0×72c, 0×fffffd90, 0×a50)). SetLevelCurrent udpates levelcurrent from 4 to 2 and rgutypecurrent from 2 to 1; SetLevelRoot leaves levelroot=6 and rgutyperoot=3. CReSuConcat::DescendLevels eventually finds cprRoot=cprRootPrev and returns −2 as expected. SetScrollRangeVid computes numscales=6 and nScaleGrads=0×4e, and makes the call to CWnd::SetScrollRange. ChangeLevelFinish calls CCoordSys::FixDestScale with scaledelta=−2, which yields (xSrcFix, ySrcFix)=(0×0, 0×0) and (xDstViewTL, yDstViewTL)=(0×1fe, 0×df), and calls InitSrcTLCoords as usual. ChangeLevelFinish calls UpdatePerimeters, which has no net effect on CReSuConcat::Concats[ ] or theEntryCache because PerimPreload[2] and PerimPreload[1] continue to encompass both Page-of-Blocks CPosRgus and all 9 Block-of-Panels CPosRgus respectively. ChangeLevelFinish calls SetScrollPosVid, which computes subsealepos=0×3, levelpos=0×1a, and scalepos=0×30, and makes the call to CWnd::SetScrollPos; ChangeLevelFinsh finally calls SetConcat, which reinitializes the video buffer according to rgutypecurrent=1 (overwriting the video buffer initialization performed by CVidArea::InitVidArea; see above). GoToHistEntry calls CCoordSys::DefInitCoords a second time (first was in InitChildAreas) to force initial navigational values to exactly reflect the initial history entry. In DefInitCoords it is confirmed that (xDstViewTL, yDstViewTL) are modified slightly, from (0×1fe, 0×df) to (0×200, 0×e0). GoToHistEntry finally calls MoveBrowsers to update web browser object positions according to this slight modification, and CReSuConcat::SetLevelInit to establish CReSuConcat::levelinit=2 (as opposed to 4 in previous examples). The Zoosh OCX initially displays electronics.blk at the top right corner of frames[2], because the Zoosh properties xViewTL=512 and yViewTL=224 represent its top left coordinates (see FIG. 5). FIG. 11H shows Zoosh after initializing by the above-described route.

### EXAMPLE #8

Predefined Upward Link from Page to Section

In toprightElectronics.htm, window.parent.LevelDelta=0 (instead of −2), and in linktoOCX.htm, Zoosh1.ZooshLoc=“Pages/general.pag” (instead of “Sections/Stores.sec”). In addition, general.pag is modified to prepend the predefined upward link “Pages/general.pag” (see ZshFileEntry.cpp, p.30 line 37), and stores.sec is modified to prepend the predefined upward link “” (ie no link). GoToHistEntry calls CReSuConcat::ReadRootRgu with relpname=“Pages/general.pag”, which computes rgutype=2 and calls ReplaceRoot. ReplaceRoot calls PreloadOne, which preloads the RedMioEntry and ZshFileEntry (CBpssEntry) for a CPosRgu with RguFile=“Pages/general.pag”, but not the SubMioEntry because RguFile does not imply a pathname for SubMioImage; CBpssEntry::InitPosRguList uses (mbxbase, mbybase)=(0×0, 0×0) as usual for disembodied cprRoots. ReadRootRgu calls SetLevelRoot to set levelroot=4 and rgutyperoot=2, calls SetLevelCurrent to set levelcurrent=2 and rgutypecurrent=1, and calls FollowRootPath with levelrootmax=8. FollowRootPath find that the cprRoot on input (having RguFile=“Pages/general.pag”) has NULL cprUpward, then finds RguUpward=“Sections/stores.sec” and calls ReplaceRoot with upconnect=true. ReplaceRoot now creates a new disembodied cprRoot to replace the old (disembodied) cprRoot, uses SearchForBpssEntry to find that theEntryCache does not already contain a CBpssEntry for “Sections/stores.sec”, and calls PreloadOne to preload the RedMioEntry and ZshFileEntry (CBpssEntry) for the new disembodied cprRoot, but again not the SubMioEntry because RguFile does not imply a pathname for SubMioImage. Again in CBpssEntry::InitPosRguList, (mbxbase, mbybase)=(0×0, 0×0). Since upconnect is true, ReplaceRoot sets RguFilePrev=“Pages/general.pag” and uses FindChildEntry to obtain a cprPrevSub from the PosRguListBpss of the newly read CBpssEntry whose RguFile is RguFilePrev; ReplaceRoot then reassigns ZshFileEntry, RedMioEntry, and SubMioEntry of cprRootPrev to cprPrevSub, and sets the INMEMPRELOAD flag of cprPrevSub::prebits, and calls CBpssEntry::RecursiveJog to realign (mbxRguTL, mbyRguTL) of cprRootPrev progeny with the new (mbxRguTL, mbyRguTL) for RguFile=“Pages/general.pag”. CBpssEntry::RecursiveJog has no effect in the y dimension, but adds 0×8 <<SCALESPERLEVELJUMP=0×20 macroblock units to each Block-of-Panels (mbxRguTL, mbyRguTL), and 0×20<<SCALESPERLEVELJUMP=0×80 macroblock units to each leaf-level (mbxRguTL, mbyRguTL). ReplaceRoot finally calls DeleteRootPrev to set CprUpward of cprRootPrev's 3 Block components to cprPrevSub (ie sets CprUpward to the replacement CPosRgu for RguFile=“Pages/general.pag”, which now exists in a higher-level PosRguListBpss instead of being disembodied), and deleting cprRootPrev. FollowRootPath finally raises levelrootcand from 4 to 6, finds on the second time through the loop that both cprUpward=NULL and RguFile=“” and therefore breaks the loop before reaching levelrootmax, and calls SetLevelRoot to set levelroot to 6 and rgutyperoot to 3. ReadRootRgu finally calls DetIsLevelMax, which sets islevelmax for Concats[2], as it did in earlier examples when ZooshLoc was “Sections/Stores.sec” with LevelDelta=0.

GoToHistEntry calls ReplaceChildAreas, leads to CReSuConcat::UpdatePerimeters, which calls PreloadTopDown, which operates on rgutyperoot−1=2 and rgutypecurrent=1. PreloadTopDown finds the second Page-of-Blocks CPosRgu having RguFile “Pages/groceries.pag” and each of its 6 additional Block-of-Panels CPosRgus, using PerimPreload[2]=(0×fffffcab, 0×45b, 0×fffffc34, 0×5c4) and PerimPreload[19 =(0×fffffced, 0×72d, 0×fffffd92, 0×a52) respectively; PredecodeBottomUp then decodes for these new CPosRgus. SetScrollRangeVid computes numscales=6 and nScaleGrads=0×4e, and makes the call to CWnd::SetScrollRangc (same as Example #7); SetScrollPosVid computes subscalepos=0×3, levelpos=0×1a, and scalepos=0×30, and makes the call to CWnd::SetScrollPos (same as Example #7); InitChildAreas calls CVidArea::InitVidArea to perform initial rendering into the video buffer. GoToHistEntry finally skips DescendLevels since LevelDelta=0, and sets CReSuConcat::levelinit to 2.

### EXAMPLES #9

Other User Interface Elements for Level Jumping, Scaling, and Shifting

Continuing from where Example #4 leaves off (though using ROOTJUMPNRGUTYPES=3 as in Example #5 and the larger apron values of Example #6), the user clicks on the “square +” tool a second time in order to jump downward from Blocks level to Panels level, then alternatively 9a) uses the “square −” tool 914 to jump upward in level, 9b) presses the Escape key to jump upward in level, 9c) first uses the “round −” tool 918 to contract in scale by a factor of 2 (as is done in Example #5), then uses the “round +” tool 916 to re-expand in scale by a factor of 2, 9d) uses the “realign” tool 917 to restore initial navigational values contained in the current history entry, 9e) presses the “−” key to effect fine-grained contraction in scale, 9f) presses the “+” key to effect fine-grained expansion in scale, 9g) exercises the integrated scaling and level-jumping mechanism using the vertical scrollbar 903, 9h) exercises the integrated scaling and level-jumping mechanism using any of the aforementioned tools and keys, and 9i) presses the “arrow” keys to control lateral navigation by fixed amounts.

9a) The user clicks on the “square −” tool 914 to jump upward in level. CToolWnd::OnLButtonDown calls CToolArea::OnLButtonDown, which calls TakeButtonAction with index=TOOLBMPDOCRGUHIGHER, which sends the WM_ASCENDLEVELSCENTER message with parameter SCALESPERLEVELJUMP to the parent of theToolCWnd (Zoosh control's window). CZooshCtrl::AscendLevelsCenter calls CChildSwitch::AscendLevels with levelsup=2 and useMouse=false, which first calls DeleteBrowsers to turn off all active web browser objects (as did CChildSwitch::DescendLevels), and calls CReSuConcat::AscendLevels with levelsup=2. CReSuConcat::AscendLevels calls FollowRootPath with levelrootmax=8, which begins at levelrooteand=6 (existing levelroot). FollowRootPath returns without affecting levelroot because the existing cprRoot has cprUpward=NULL and RguUpward=“”, and DetIsLevelMax has no effect because rgutyperoot does not change. SetLevelCurrent updates levelcurrent to 2 from 0 and rgutypecurrent to 1 from 0, and CReSuConcat returns leveldelta=2 as expected. SetSerollRangeVid computes numscales=6 and nScaleGrads=0×4e, and makes the call to CWnd::SetScrollRange. ChangeLevelFinish calls CCoordSys::FixDestScale with useMouse false, which calls GetCenter with useMouse false, which returns view center (xc, ye)=(0×1f2, 0×12d). FixDestCalc updates (xDstViewTL, yDstViewTL), thus raising the level of the coordinate system by SCALESPERLEVELJUMP. FixDestScale finally calls InitSrcTLCoords, and UpdateSrcTLCoords updates (xDstViewTL, yDstViewTL), (xSrcViewTL, ySrcViewTL), (mbxVideoTL, mbyVideoTL), etc. UpdatePerimeters has no net affect in this particular situation, but under other circumstances (different apron constant values), UpdatePerimeters could alter the contents of Concats[0], Concats[1], or Concats[2]. SetScrollPosVid computes subscalepos=0×3, levelpos=0×1a, and scalepos=0×30, and makes the call to CWnd::SetScrollPos. ChangeLevelFinish finally calls SetConcat to perform initial rendering into the video buffer (CVidWnd::OnPaint will render to screen). 9b) The user presses the Escape key to jump upward in level. CVidWnd::ProcessKeyDown calls CVidArea::OnKeyDown, which posts WM_ASCENDLEVELSMOUSE with parameter SCALESPERLEVELJUMP to the Zoosh control's window. CZooshCtrl::AscendLevelsMouse calls CChildSwitch::AscendLevels with levelsup=2 and useMouse=false. Processing is the same as with the square “−” tool 914, except that in CCoordSys::FixDestSeale, GetCenter returns the current mouse position in (xc, yc) instead of the view center, and UpdatePerimeters uses accordingly different perimeters (eg, PerimPreload[0] changes even when APRONFACTORDOWN=1.0).

9c) After using the “round −” tool 918 to contract in scale by a factor of 2 as in Example #5, the user clicks on the “round +” tool 916 to re-expand in scale by a factor of 2. CToolWnd::OnLButtonDown calls CToolArea::OnLButtonDown, which calls TakeButtonAction with index=TOOLBMPSCALEP1, which calls CVidArea::TrackScalePosSpan with nSpans=1 and useMouse=false, which calls CVidArea::TrackScalePos with posdelta=multiplierSpan=0×d and useMouse=false. CVidArea::TrackScalePos (see discussion for “round −” tool 918 in Example #5) reads scaleposA=0×3d and scaleposB=0×4a (inverting the effect of the prior contraction in scale), and CCoordSys::UpdateFix leaves (xDstViewTL, yDstViewTL) and (xSrcFix, ySrcFix) unchanged. CCoordSys::TrackScalePos computes realpos=0×3, scaleTarg=0×0, levelTarg=0×0 (second return value), multTarg=0×10, and scaledelta=−1 (primary return value). CCoordSys::SetScale updates scale from 1 to 0, raises mbunitpower from 3 to 4, and raises mbunithalf from 4 to 8 (all inverting the effect of the prior contraction in scale); multiplier, xVVpad, and yVVpad remain unchanged. CVidArea::TrackScalePos finally sends a WM_TRACKLEVELSCENTER message to the parent of theVidCWnd (Zoosh control's window) with parameters levelTarg=0×0 and scaledelta=−1. CZooshCtrl::TrackLevelsCenter calls CChildSwitch::TrackLevels, which calls CChildSwitch::ChangeLevelFinish with scaledelta=−1 and useMouse=false. CCoordSys::FixDestScale(−1, false) performs a scale-descending change of coordinates (essentially inverting the effect of the prior scale-ascending change of coordinates), UpdatePerimeters removes some CPosRgus from Concats[0] as would be expected in a scale expansion (same perimeter encloses less source material), and SetScrollPosVid inverts the effect of the prior contraction as expected (scalepos=0×4a).

9d) The user clicks on the “realign” tool 917 to restore initial navigational values contained in the current history entry. CToolWnd::OnLButtonDown calls CToolArea::OnLButtonDown, which calls TakeButtonAction with index=TOOLBMPREALIGN, which sends the WM_GOTOLEVELINIT message to the parent of theToolCWnd. CZooshCtrl::GoToLevelInit calls CChildSwitch::GoToLevelInit, which begins with a call to DeleteBrowsers for the same reason as DescendLevels, AscendLevels, and TrackLevels. CChildSwitch::GoToLevelInit calls CReSuConcat::ReinitLevelRoot, which computes leveldelta=−4 (levelinit was 4 and levelcurrent is 0) and calls CReSuConcat::AscendLevels, which calls FollowRootPath with levelrootmax=8, which has no net effect since levelroot is already 6 and there is no RguUpward link from stores.sec. SetLevelCurrent sets levelcurrent to 4 from 0 and rgutypecurrent to 2 from 0, and CReSuConcat::AscendLevels returns leveldelta=4 as expected. CChildSwitch::GoToLevelInit calls CCoordSys::DefInitCoords, which ultimately resets (xDstViewTL, yDstViewTL)=(0×0, 0×0), (xSrcFix, ySrcFix)=(0×0, 0×0), scale=0×0, mbunitpower=0×4, mbunithalf=0×8, multiplier=0×10, (xVVpad, xVVpad)=(0×168, 0×f0), and so on via InitSrcTLCoords. In this particular example, all but (xDstViewTL, ypstViewTL) have these values on input already, but GoToLevelInit would reinitialize them in any case. For example, in the fine-grained scaling examples to follow, changes in multiplier impact (xVVpad, yVVpad) and all coordinate transformations between source and destination spaces; even after fine-grained scaling, GoToLevelInit restores multiplier=0×10 and all dependencies. CChildSwitch::GoToLevelInit finally calls UpdatePerimeters to refigure Concats[2] and Concats[1], SetScrollPosVid (subscalepos=0×3, levelpos=0×34, and scalepos=0×16), and SetConcat.

9e) The user presses the “−” key to effect fine-grained contraction in scale. CVidWnd::ProcessKeyDown calls CVidArea::OnKeyDown, which calls CVidArea::TrackScalePos with posdelta=−1 and useMouse=true. CVidArea::TrackScalePos (see discussion for “round −” tool 918 in Example #5 and “round +” 916 above) reads scaleposA=0×4a and scaleposB=0×49, and CCoordSys::UpdateFix updates (xDstViewTL, yDstViewTL) and (xSrcFix, ySrcFix) in a manner similar to Example #5, except that useMouse=true yields (xc, yc)=current mouse position instead of view center, so that contraction is centered about the current mouse instead of about the center of the view. CCoordSys::TrackScalePos computes realpos=0×4, scaleTarg=0×0, levelTarg=0×0 (second return value), multTarg=0×11, and scaledelta=0 (primary return value). CCoordSys::SetScale updates multiplier from 0×10 to 0×11, and updates (xVVpad, yVVpad) to (0×148, 0×xdd) from (0×168, 0×f0): although scale, mbunitpower, and mbunithalf remain unchanged, the value of multiplier is incremented, which affects all subsequent transformations between source and destination coordinate spaces. The amount of marginal padding in the video buffer decreases slightly, because the same amount of destination (view) area now corresponds to more source area. The size of the video buffer remains the same, and complete rerendering of the video buffer is not required, in spite of the change in multiplier. CVidArea::TrackScalePos sends a WM_TRACKLEVELSMOUSE message to the parent of theVidCWnd (Zoosh control's window) with parameters levelTarg=0×0 and scaledelta=0. CZooshCtrl::TrackLevelsCenter calls CChildSwitch::TrackLevels, which finds totdelta=0 and calls CVidArea::TrackFinishMultDelta followed by UpdatePerimeters instead of ChangeLevelFinish. CVidArea::TrackFinishMultDelta calls CCoordSys::UpdateSrcTLCoords to update source-space variables such as (mbxVideoTL, mbyVideoTL) that depend on the new multiplier value, renders into the video buffer if necessary (small marginal amounts defined by (mbxVideoTLDelta, mbyVideoTLDelta), if any), and calls CWnd::Invalidate to eventually cause repainting of the screen (as does CVidArea::SetConcat). Depending on mouse position, UpdatePerimeters adds some CPosRgus to Concats[0] (PerimPreload[0] enlarges to enclose slightly more source material), but fewer than in contracting in scale by a factor of 2. FIG. 11I shows Zoosh after contracting with the “−” key 3 times, beginning from a position similar to that of FIG. 11E.

9f) The user presses the “+” key to effect fine-grained expansion in scale. CVidWnd::ProcessKeyDown calls CVidArea::OnKeyDown, which calls CVidArea::TrackScalePos with posdelta=1 and useMouse=true. CVidArea::TrackScalePos reads scaleposA=0×4a and scaleposB=0×4b, and CCoordSys::UpdateFix updates (xDstViewTL, yDstViewTL) and (xSrcFix, ySrcFix) as in the “−” key example above. CCoordSys::TrackScalePos computes realpos=0×2, scaleTarg=0×0, levelTarg=0×0 (second return value), multTarg=0×f, and scaledelta=0 (primary return value). CCoordSys::SetScale updates multiplier from 0×10 to 0×f, and updates (xVVpad, yVVpad) to (0×187, 0×103) from (0×168, 0×f0): although scale, mbunitpower, and mbunithalf remain unchanged, the value of multiplier is decremented, which affects all subsequent transformations between source and destination coordinate spaces. The amount of marginal padding in the video buffer increases slightly, because the same amount of destination (view) area now corresponds to less source area. The size of the video buffer remains the same, and complete rerendering of the video buffer is not required, in spite of the change in multiplier. This example illustrates the effect of using a multiplierLim that is less than multiplierBase <<1=0×20 (see CCoordSys constructor): since multiplierMin=multiplierLim >>1, a range of multiplier values less than multiplierBase is permitted, which means the video buffer supports both contraction and expansion without complete rerendering. CVidArea::TrackScalePos sends a WM_TRACKLEVELSMOUSE message to the parent of theVidCWnd (Zoosh control's window) with parameters levelTarg=0×0 and scaledelta=0, which CZooshCtrl::TrackLevelsCenter handles in essentially the same was as for the “−” key. Depending on mouse position, UpdatePerimeters can remove some CPosRgus from Concats[0] (PerimPreload[0] contracts to enclose slightly less source material), but fewer than in expanding in scale by a factor of 2. FIG. 11J shows Zoosh after expanding with the “+” key 3 times, beginning from a position similar to that of FIG. 11E.

9g) The user exercises the integrated scaling and level-jumping mechanism using the vertical scrollbar 903. CVidWnd::OnVScroll calls CVidArea::TrackScalePos with useMouse=false and a posdelta that depends on scrollbar part: for up and down arrows, posdelta is −1 and +1 respectively (as in “−” and “+” keys but with useMouse=false); for up and down scrollbar “page” areas, posdelta is −SCALESPERLEVELJUMP * multiplierSpan and +SCALESPERLEVELJUMP * multiplierSpan respectively (as in “round −” and “round +” tools only with nspans=SCALESPERLEVELJUMP=2 instead of 1); and for general thumb tracking, posdelta is an arbitrary difference between user-driven and pre-existing position readings. When multiplier rolls over past multiplierLim in the positive-going direction, CCoordSys::TrackScalePos computes an increase in scale and/or level (and the video buffer must be completely rerendered). When multiplier rolls over past multiplierMin in the negative-going direction, CCoordSys::TrackScalePos computes a decrease in scale and/or level (and the video buffer must be completely rerendered). Otherwise, fine-grained scaling operations preserve the contents of the video buffer (and web browser processing is suspended), yielding a dramatic increase in rendering efficiency. When scrollbar tracking ends (nSBCode=SB_ENDSCROLL in CVidWnd::OnVScroll), web browser processing is turned back on. 9h) The user exercises the integrated scaling and level-jumping mechanism using any of the aforementioned tools and keys, including the “realign” tool 917: see descriptions above for individual tools and keys.

9i) The user presses the “arrow” keys to control lateral navigation (not mouse-down) by fixed amounts. For example, the user presses the left-pointing arrow key. CVidArea::OnKeyDownExtended finds nChar=EXTENDED_ARROWLE_DELL, and calls CVidArea::doArrowStride with (xStride, yStride)=(CCoordSys::clientwidth/2, 0×0)=(0×1f2, 0×0), which calls CCoordSys::SetViewDeltas to set (xdcurr, ydcurr)=(0×1f2, 0×0), then calls CCoordSys::UpdateSrcTLCoords to subtract (xdcurr, ydcurr) from (xDstViewTL, yDstViewTL) and update source-space coordinates. CVidArea::doArrowStride sends the WM_MOVEBROWSERS message and posts the WM_UPDATEPERIMETERS message to the Zoosh control's window before rendering into the new video buffer margins ((mbxVideoTL, mbyVideoTL) are updated by UpdateSrcTLCoords). The right-pointing arrow key leads to (xStride, ystride)=(−CCoordSys::clientwidth/2, 0×0); the up-pointing arrow key leads to (xStride, ystride)=(0×0, CCoordSys::clientheight/2); the down-pointing arrow key leads to (xStride, yStride)=(0×0, −CCoordSys::clientheight/2).

### EXAMPLES #10

Shopping Cart Functions and Reporting Area

While at leaf level with CChildSwitch::inshoppingcart=false (and CReSuConcat::Concats[0]::ismall=false), the user sequentially 10a) moves the mouse over a CPosRgu, selecting it and causing price data for the item to be displayed by the Reporting area, 10b) adds 3 of the selected item to the cart by pressing the Enter key 3 times, 10c) deletes all 3 of the added items by pressing the delete key 3 times, 10d) adds a selection with 2 CPosRgus to the cart three times and deletes I copy, 10e) clicks on the “cart toggle” tool 912 to switch to the shopping cart view, 10f) adds 2 copies of one CPosRgu, deletes one of the other CPosRgu, and clicks on the “repack” tool 913 to repack and redisplay all shopping cart CPosRgus, and 10h) clicks on the “cart toggle” tool 912 to switch back to the CReSuConcat view.

10a) The user moves the mouse over a CPosRgu to select it and cause price data for the item to be displayed by the Reporting area. CVidWnd::OnMouseMove, after calling CVidArea::OnMouseMove, sends the WM_DRAWREPAREA message to CRepWnd. CRepWnd::DrawRepArea finds singleitem=true, PricePer=0×c00=3072, ItemsTotal=0, and OrderTotal=0, and outputs “$30.72 per description of item” for the PricePer line, nothing for the ItemsTotal line, and “$0.00=Order Total” for the OrderTotal line. The “$30.72” and “$0.00” (column 0) are in yellow, the “per” and “=” (column 1) are in magenta, and the “description of item” (placeholder text only) and “Order Total” (column 2) are in light blue.

10b) The user adds 3 of the selected item to the cart by pressing the Enter key 3 times. CZooshCtrl::OnKeyDown calls CVidWnd::ProcessKeyDown, which calls CVidArea::OnKeyDown, which calls CVidArea::doEnterKeyDown, which finds iscart=false but theConcat->islevelmin=true (and theConcat->ismall=false). CVidArea::doEnterKeyDown calls CCartConcat::PlaySoundDelta with isAdd=true and unseen=true, which plays the DSINDSBOUNCE sound at 0.75 times normal frequency after CCartConcat::IsOneOrMoreOf returns false (no copies of the lone CPosRgu in Concat->PosRguListSel already exist in the cart). CVidArea::doEnterKeyDown uses CCartConcat::AddSelToNew to add Concat->PosRguListSel (the one CPosRgu) to theCartConcat->PosRguListNew, and sets iscartupdate=true. CVidWnd::ProcessKeyDown finds iscartupdate=true and therefore sends the WM_DRAWREPAREA message to CRepWnd. CRepWnd::DrawRepArea outputs “$30.72 per description of item” for the PricePer line, “$30.72=Item Total” for the ItemsTotal line, and “$0.00=Order Total” for the OrderTotal line. After the second and third presses of the Enter key, CCartConcat::IsOneOrMoreOf returns true and CCartConcat::PlaySoundDelta plays DSINDSBOUNCE sound at the normal frequency. Item Total and Order Total rise to $61.44 after the second addition and $92.16 after the third.

10c) The user deletes all 3 of the added items by pressing the delete key 3 times. CZooshCtrl::OnKeyDown calls CVidWnd::ProcessKeyDown, which calls CVidArea::OnKeyDownExtended, which calls CVidArea::doDeleteKeyDown, which calls CCartConcat::DeleteSelOf, which finds that Concat->iscart=false and IsOneOrMoreOf returns true. CCartConcat::DeleteSelOf calls DeleteCopyOf to delete 1 copy of the single-CPosRgu Concat->PosRguListSel, and calls CCartConcat::PlaySoundDelta with isAdd=false and unseen=true. CCartConcat::PlaySoundDelta plays the DSINDBFIRE sound at the normal frequency after CCartConcat::IsOneOrMoreOf returns true (two copies of the lone CPosRgu in Concat->PosRguListSel remain in the cart after one is deleted). CCartConcat::DeleteSelOf returns true and CVidArea::doDeleteKeyDown sets iscartupdate=true. CVidWnd::ProcessKeyDown finds iscartupdate=true and therefore sends the WM_DRAWREPAREA message to CRepWnd. CRepWnd::DrawRepArea outputs “$30.72 per description of item” for the PricePer line, “$61.44 =Item Total” for the ItemsTotal line, and “$61.44=Order Total” for the OrderTotal line. After the second press of the delete key, CCartConcat::PlaySoundDelta again plays DSINDBFIRE sound at the normal frequency because 1 copy of the CPosRgu remains in the cart. On the third press, CCartConcat::IsOneOrMoreOf returns false, and CCartConcat::PlaySoundDelta plays the DSINDBFIRE sound at 0.75 times normal frequency. Item Total and Order Total fall to $30.72 after the second delete; after the third, Order Total is $0.00 and the Item Total line is not shown (as before any additions).

10d) The user adds a selection with 2 CPosRgus to the cart 3 times and deletes 1 copy. The first 3 additions proceed as in 10b), except that in CCartConcat::PlaySoundDelta, CCartConcat::IsOneOrMoreOf operates on a PosRguList with 2 CPosRgus instead of 1, on the first addition returning false because the first CPosRgu it tests for is not found in cart (CountCopiesOf returns 0), and on the second and third additions returning true after both CPosRgus are found in cart (CountCopiesOf returns nonzero); CCartConcat::AddSelToNew must also add 2 CPosRgus instead of 1. Again, CCartConcat::PlaySoundDelta plays DSINDSBOUNCE at 0.75 times the normal frequency on the first addition, then DSINDSBOUNCE at the normal frequency on the second and third additions. CRepArea output is similar except that reported data reflects the combined price data for a selection with 2 CPosRgus instead of 1; for example, after the third addition, CRepWnd::DrawRepArea outputs “$48.00 per Selection” for the PricePer line, “$144.00=Items Total” for the ItemsTotal line, and “$144.00=Order Total” for the OrderTotal line. The deletion proceeds as in the first deletion of 10c), except that in CCartConcat::DeleteSelOf, CCartConcat::IsOneOrMoreOf operates on a PosRguList with 2 CPosRgus instead of 1, calling CountCopiesOf twice before returning true; CCartConcat::DeleteCopyOf must also delete 2 CPosRgus instead of 1. CCartConcat::PlaySoundDelta plays DSINDBFIRE at the normal frequency. After the delete, Items Total and Order Total fall to $96.00.

10e) The user clicks on the “cart toggle” tool 912 to switch to the shopping cart view. CZooshCtrl::CartToggle calls CChildSwitch::CartToggle, which uses CChildSwitch::UpdateHistEntry to store initial navigational values into the current history entry for use upon returning to the CReSuConcat display. CChildSwitch::UpdateHistEntry updates che->LevelDelta from 0 to 0×fffffffc, and in this example che->xDstViewTL to 0×3cc and che->yDstViewTL to 0×2b1 (values for Scale, Multiplier, xSrcFix, and ySrcFix could just as easily have been changed by navigational actions prior to toggling). CChildSwitch::CartToggle sets inshoppingcart=true, and calls CCartConcat::PoorMansRepack, which (while transferring from PosRguListNew to PosRguListUns) yields the macroblock-unit rectangles (top, bottom, left, right) (0×0, 0×c, 0×0, 0×10) and (0×0, 0×c, 0×10, 0×20) for the first pair of like CPosRgus (RguFile=“Panels/celery.pan”), and (0×c, 0×18, 0×0, 0×c) and (0×c, 0×18, 0×c, 0×18) for the second pair of like CPosRgus (RguFile=“Panels/cauliflower.pan”). CChildSwitch::CartToggle calls CCoordSys::DefInitCoords with the initial cheCart data (all values 0×0 except che->Multiplier=0×10), which reinitializes CCoordSys accordingly. CChildSwitch::CartToggle calls SetScrollPosVid (subscalepos=0×3, levelpos=0×0, scalepos=0×4a), and calls SetConcat to perform a complete rerendering into the video buffer and make the call to CWnd::Invalidate. FIG. 11K shows Zoosh after toggling to cart, after making the above-described additions and deletions.

10f) The user adds 2 copies of one CPosRgu, deletes one of the other CPosRgu, and clicks on the “repack” tool 913 to repack and redisplay all shopping cart CPosRgus. On each of the additions, CVidArea::doEnterKeyDown finds iscart=true (was previously false), and theConcat points to CChildSwitch::theCartConcat instead of CReSuConcat::Concats[0]. CVidArea::doEnterKeyDown calls CCartConcat::PlaySoundDelta with isAdd=true and unseen=false, which plays the DSINDSBOUNCE sound at normal frequency (it is unnecessary to call IsOneOrMoreOf because there is always one or more of a CPosRgu being added from cart). Both of the added CPosRgus go into PosRguListNew and are not yet visible in the display. After the first addition, CRepWnd::DrawRepArea outputs “$30.72 per Selection” for the PricePer line, “$92.16=Item Total” for the ItemsTotal line, and “$126.72=Order Total” for the OrderTotal line; after the second addition (with the added CPosRgu still selected), the Item Total rises to $122.88 and the Order Total rises to $157.44. With the other CPosRgu selected (on mouse over), PricePer switches to $17.28 and Item Total switches to $34.56. On the deletion, CVidArea::doDeleteKeyDown calls CCartConcat::DeleteSelOf, which (again not calling IsOneOrMoreof) calls CCartConcat::PlaySoundDelta with isAdd=false and unseen=false. PlaySoundDelta does call IsOneOrMoreOfNonSel, to check whether there is a copy of the CPosRgu to be deleted in non-PosRguListSel cart CPosRguConcats (ie PosRguListUns or PosRguListNew). IsOneOrMoreOfNonSel returns true, and PlaySoundDelta plays the DSINDBFIRE sound at normal frequency; if IsOneOrMoreOfNonSel had returned false, PlaySoundDelta would have played the same sound at 0.75 times the normal frequency to indicate that it was the last copy being deleted. After the deletion, Item Total drops to $17.28 and Order Total drops to $140.16; the display is updated for the deletion, but still has not incorporated the new CPosRgus in PosRguListNew. After the user clicks on “repack” tool 913, CToolArea::OnLButtonDown calls CToolArea::TakeButtonAction with index=TOOLBMPPACK, which calls CVidArea::CartRepack, which calls CCartConcat::PoorMansRepack, which (while transferring from both PosRguListNew and PosRguListSel to PosRguListUns) yields the macroblock-unit rectangles (0×0, 0×c, 0×0, 0×10), (0×0, 0×c, 0×10, 0×20), (0×c, 0×18, 0×0, 0×10), and (0×c, 0×18, 0×10, 0×20) for the CPosRgu with RguFile=“Panels/celery.pan”, and (0×0, 0×c, 0×20, 0×2c) for the CPosRgu with RguFile=“Panels/cauliflower.pan”, thus grouping the four like CPosRgus together as a block of 4, and placing the remaining CPosRgu to the right and aligned with the top of the block. FIG. 11L shows Zoosh's shopping cart view after this repacking. FIG. 11M shows the shopping cart view after adding 5 more cauliflower.pan CPosRgus, repacking, contracting using “round −” tool 918, expanding using the “+” key 8 times, and mouse-down lateral navigation.

10h) The user clicks on the “cart toggle” tool 912 to switch back to the CReSuConcat view (without performing the additional actions whose results are shown in FIG. 11M). CToolArea::OnLButtonDown calls CToolArea::TakeButtonAction with index=TOOLBMPSHOPPINGCART, which sends the WM_CARTTOGGLE message to the Zoosh control's window. CZooshCtrl::CartToggle calls CChildSwitch::CartToggle, which uses CChildSwitch::UpdateHistEntry to store initial navigational values into the shopping cart data for use upon returning to the CCartConcat display (for example, mouse-down lateral navigation subsequent to repacking could lead to new cheCart values for (xDstViewTL, yDstViewTL); scaling could lead to new cheCart values for Scale or Multiplier, as well as (xSrcFix, ySrcFix) and (xDstViewTL, yDstViewTL). CChildSwitch::CartToggle sets inshoppingcart=false, and calls CCoordSys::DefInitCoords, which redefines all 6 “init” values according to the values saved when the user toggled inshoppingcart on: initscale=0×0, initmultiplier=0×10, initxSrcFix=0×0, initySrcFix=0×0, initxDstViewTL=0×3cc, and inityDstViewTL=0×2b1; che->LevelDelta=−4, but doFixDest=false, so CCoordSys::DefInitCoords does not invoke FixDestCalc with scaledelta=+4. CChildSwitch::CartToggle calls SetScrollPosVid (subscalepos=0×3, levelpos=0×0, scalepos=0×4a), and calls SetConcat to perform a complete rerendering into the video buffer and make the call to CWnd::Invalidate.

### EXAMPLES #11

History Mechanism, Mall Configuration, Combobox Branching

The user points Internet Explorer to a different webpage (not linktoOCX.htm or framesetPatExample.htm), in which the Zoosh property ZooshLoc is different (not “Sections/stores.sec” or any of its progeny) and the Zoosh property Config has the CONFIGMALL bit set; CChildSwitch::GoToHistEntry calls CReSuConcat::set_ismall to set the ismall flag of all Concats[ ] elements (in particular that of Concats[0]). The user navigates to leaf level (staying at scale 0), and presses the Enter key when a single CPosRgu (Panel) is selected, for which CellURL[0] is nonempty. CVidArea::doEnterKeyDown (with iscart=false) finds that Concat->islevelmin is true, Concat->ismall is true, and Concat::LoneCprSel returns the CPosRgu* of the one and only selected CPosRgu. CVidArea: doEnterKeyDown sets CellURL to CellURL[0] of this CPosRgu, and posts the WM_BRANCHTOURL message with parameters CellURL and Config=0 to the Zoosh control's window. CZooshCtrl::BranchToURL calls CChildSwitch::PareHistoryAndBranch with the same two parameters (now URL and Config), which calls UpdateHistEntry to save navigational values for the current history entry, creates a new history entry newche using URL and Config and appends it to the history list, and calls GoToHistEntry. CReSuConcat::ReadRootRgu returns false after finding that rgutype=RGUTYPE_NONRGUEXT after GetRguType, and calls GoToHistEntry calls ReplaceChildAreas with inzoomingmode=false (and ismall bits of CReSuConcats::Concats[ ] now false). Because inzoomingmode is false, CreateChildWindows does not create an HWND for theVidCWnd, but does create one for theNoZoomBrowser (which is a CWebBrowser2* in contrast to CVidWnd* theVidCWnd) using rectVid. InitChildAreas then skips all of the CVidWnd-related initialization (including CCoordSys creation, UpdatePerimeters, CVidArea::InitVidArea, etc, and instead uses CWebBrowser2::Navigate to initialize the contents of theNoZoomBrowser according to che->URL (what was CellURL[0] above).

Inside the web page rendered by theNoZoomBrowser, the user clicks on a link whose pathname ends in “.sur”, “see”, “.pag”, “.blk”, or “.pan” (for example “Sections/stores.sec” as in earlier examples). CZooshCtrl::OnBeforeNavigate2 intercepts the link, finds that CChildSwitch::GetRguType indeed returns an rgutype other than RGUTYPE_NONRGUEXT, posts the WM_BRANCHTOURL message to itself with parameters URL=pathname from link and Config=0, and cancels the within-browser navigation; CZooshCtrl::OnBeforeNavigate2 must post (rather than send) this message because its handler will delete the CWebBrowser2 object which is generating the event that leads to CZooshCtrl::OnBeforeNavigate2. CZooshCtrl::BranchToURL again calls CChildSwitch::PareHistoryAndBranch, which again creates a new history entry, appends it to the history list, and calls GoToHistEntry. As described in earlier examples, GoToHistEntry finds that CReSuConcat::ReadRootRgu returns true, sets inzoomingmode=true, makes use of initial navigational values in the new history entry, etc.

After taking various navigational actions, the user clicks on the “go backward” tool 910. CToolArea::TakeButtonAction, given index=TOOLBMPZOOMBACK, posts the WM_JUMPHISTORY message with parameter n=−1 to the Zoosh Control's window. CZooshCtrl::JumpHistory calls CChildSwitch::JumpHistory with n=−1, which calls UpdateHistEntry to save navigational values in case the user eventually wishes to return to the current history entry (eg using the “go forward” tool 911), and updates posURLHist to point to the previous history entry, in this case the history entry which led to inzoomingmode=false and nonNULL theNoZoomBrowser. CZooshCtrl::JumpHistory finally calls GoToHistEntry, which operates as described earlier. If the user clicks on the “go backward” tool 910 a second time, Zoosh navigates backward to the mall-configuration hierarchy, and uses CCoordSys::DefInitCoords to restore navigational values to the jumping-off point contained in its history entry. If the user clicks on the “go forward” tool 911, index=TOOLBMPZOOMFORWARD in CToolArea::TakeButtonAction, the WM_JUMPHISTORY message has parameter n=+1, CChildSwitch::JumpHistory updates posURLHist to point to the next history entry (eg with URL=“Sections/stores.sec”), and CCoordSys::DefInitCoords restores navigational values to the jumping-off point contained in its history entry. If the user types text into the text area 931 of combobox 930, or uses the pulldown menu of combobox 930, CToolWnd::ComboEnter posts the WM_BRANCHTOURL message to the Zoosh control's window with Config=0 and URL parameter derived from the combobox text; WM_BRANCHTOURL is handled by CZooshCtrl::BranchToURL as described earlier, resulting in a new history entry which the user can depart from or arrive at like any other history entry using the “go backward” tool 910 and “go forward” tool 911.

### EXAMPLES #12

Miscellaneous

The “Images priority” tool 919 gives precedence to MIO images over URLs in all visible CPosRgus. For example when ZooshLoc=“Sections/stores.sec” and the user has navigated to Blocks level, certain of the Block CPosRgus (ie the 3 whose RguFiles end in “left.blk”) are initially rendered by web browser objects even though RedMioImage is nonempty and RedMioEntry is nonNULL, since CPRPRIORITYRULE=0 and nonempty CellURL[0] leads to CPosRgu::isHTMLCell=true in the CPosRgu constructor. If the user presses the “Images priority” tool 919, index=TOOLBMPTOIMAGES in CToolArea::TakeButtonAction, which calls CVidArea::ToHTMLCells with toHTML=false, which sends WM_DELETEBROWSERS to the Zoosh control's window, then uses CPosRguConcat::IterateUns and CPosRguConcat::IterateSel with an iterant that turns isHTMLCell off (as long as RedMioEntry or SubMioEntry is valid), and renders into the video buffer (and to screen) accordingly. FIG. 11N shows Zoosh after using “Images priority” tool 919 at Blocks level; compare to lefthand side of FIG. 11B. If the user then presses the “HTML priority” tool 920, index=TOOLBMPTOHTMLCELLS in CToolArea::TakeButtonAction, which calls CVidArea::ToHTMLCells with toHTML=true, which uses CPosRguConcat::IterateSelToUns to first unselect (move from PosRguListSel to PosRguListUns) those CPosRgus for which a web browser object can be instantiated, then uses CPosRguConcat::IterateUns with an iterant that turns isHTMLCell on, and sends the WM_BROWSERSONOFF message to the Zoosh control's window to cause rerendering. Different values of CPRPRIORITYRULE (eg CPRPRIORITYRULE=1) produce different initial precedences between CellURL[ ], RedMioImage, and SubMioImage within a given CPosRgu.

An Operating System provides various means of resizing the Zoosh control's window, most often by resizing the window of its container. CZooshCtrl::OnSize calls CChildSwitch::SizeChildWindows, which first calls UpdateHistEntry to record the current navigational state, then calls a series of functions similar to that of ReplaceChildAreas: SizeChildWindows substitutes MoveChildWindows instead of the combination of DestroyChildWindows followed by CreateChildWindows, but is otherwise the same as ReplaceChildAreas. MoveChildWindows moves and resizes windows according to newly computed rectVid, rectTool, and rectRep; InitChildAreas then creates a new CCoordSys based on new values of mbwround and mbhround, initializes theCoordSys with the just-saved navigational values in the current history entry, calls UpdatePerimeters to preload and predecode according to perimeters based on the new values of clientwidth and clientheight, etc.

Zoosh provides a method of directing information about a CPosRgu to frames[1] in response to its being selected as the lone CPosRgu in PosRguListSel. CVidWnd::OnMouseMove calls CVidArea::OnMouseMove, which initially clears a variable DidFlags, then sets a bit DIDUNSTOSEL in DidFlags if and only if one or more CPosRgus are switched from PosRguListUns to PosRguListSel (eg via mouseover-driven autoselect). The user moves the mouse over a selectable CPosRgu; CVidWnd::OnMouseMove calls CVidWnd::ProcessDidFlags, which finds finds that the DIDUNSTOSEL bit is set, finds that either Concat->iscart is true or Concat->ismall is false, finds that PosRguListSel contains one and only one CPosRgu, and sends the WM_SHOWDATAURL message with parameter DataURL=CellURL[0] (to become a separate string, eg DataURL[0]; see comment) to the Zoosh control's window. CZooshCtrl::ShowDataURL finds that DataURL is nonempty and calls CZooshCtrl::FireShowDataURL with DataURL as parameter. CZooshCtrl::FireShowDataURL fires the OCX event eventidShowDataURL with DataURL as parameter, and the javascript function Zoosh1_ShowDataURL(dataURL) in linktoOCX.htm executes the statement “Window.parent.frames(1). location.href=dataURL”, directing Internet Explorer to render dataURL into frames[1].

What is claimed is:

1. A method of enabling navigation of hierarchical network information, comprising:
decoding for a region of a first level of said hierarchical network information, said first level comprising first map information associated with a first area of a higher level of said hierarchical network information, said higher level further comprising a second area associated with second map information of said first level,
receiving a user signal which directs one of lateral navigation, scaling, or level jumping,
joining said first map information with said second map information to produce joined map information, such that the vector difference between a reference point for said first map information and a reference point for said second map information is expanded relative to said higher level, and
decoding for a region of said joined map information.

2. A method according to claim 1 further comprising joining said first map information with said second map information responsively to said user signal.

3. A method according to claim 1 further comprising joining said first map information with said second map information in anticipation of said user signal.

4. A method according to claim 1 further comprising adding a first offset to position information of a component of said first map information, and adding a second offset to position information of a component of said second map information.

5. A method according to claim 1 comprising reading a first parent component, and later reading child map information of said first parent component thereby reading said first map information, and comprising reading a second parent component, and later reading child map information of said second parent component thereby reading said second map information.

6. A method according to claims 4 and 5 wherein said first offset equals scaled position information of said first parent component, and wherein said second offset equals scaled position information of said second parent component.

7. A method according to claim 6 wherein said first offset equals the scaled top left coordinates of said first parent component, and wherein said second offset equals the scaled top left coordinates of said second parent component.

8. A method according to claim 1 wherein said vector difference is expanded by a power of two in each of width and height.

9. A method according to claim 1 wherein said first map information and said second map information each comprise a plurality of components, and wherein each of said components comprises position, width, and height information.

10. A method according to claim 1 wherein said first map information and said second map information each comprise a plurality of components, and wherein each of said components comprises a file path of image information.

11. A method according to claim 10 wherein each of said components comprises a relative URL.

12. A method according to claim 1 wherein said first map information and said second map information each comprise a plurality of components, and wherein each of said components comprises a file path of child map information.

13. A method according to claim 12 wherein each of said components comprises a relative URL.

14. A method according to claim 1 wherein a component of said first map information or said second map information comprises a plurality of file paths each corresponding to a distinct scale value.

15. A method according to claim 1 wherein said displaying of said region of said joined map information comprises rendering by web browser software code.

16. A method according to claim 1 wherein said displaying of said region of said joined map information comprises displaying interactive content, and wherein said method further comprises receiving and processing user input related to said interactive content.

17. A method according to claim 1 wherein a component of map information may be content-wise associated with both image information suitable for rendering by web browser software code and image information not suitable for rendering by web browser software code, further comprising user means for assigning priority to image information suitable for rendering by web browser software code.

18. A method according to claim 1 wherein a component of map information may be content-wise associated with both image information suitable for rendering by web browser software code and image information not suitable for rendering by web browser software code, further comprising user means for assigning priority to image information not suitable for rendering by web browser software code.

19. A method according to claim 1 further comprising decompressing compressed image information to provide said decompressed image information, said compressed image information comprising information in an MPEG Intraframe coding format.

20. A method according to claim 1 wherein said displaying of said region of said first level comprises displaying default image information, wherein a file path for said default image information differs by only a file extension from a file path in a component of said first map information.

21. A method according to claim 1 wherein said displaying of said region of said higher level comprises displaying reduced-size decompressed image information which is reduced in size relative to, and is otherwise similar to, image information contained in a region of said joined map information.

22. A method according to claim 21 wherein said reduced-size decompressed image information comprises decompressed image information representing a decimated concatenation of a plurality of images each corresponding to a component of said first map information.

23. A method according to claim 1 further comprising reading said first map information and said second map information responsively to said user signal.

24. A method according to claim 1 further comprising reading said first map information and said second map information in anticipation of said user signal.

25. A method according to claim 1 further comprising reading said first map information from local disk and reading said second map information from local disk.

26. A method according to claim 1 further comprising reading said first map information over a network and reading said second map information over a network.

27. A method according to claim 1 further comprising reading root map information, wherein said first map information and said second map information are progeny map information of said root map information.

28. A method according to claim 27 further comprising identifying said root map information by following upward links for a specified number of levels.

29. A method according to claim 28 wherein said following comprises reading parent map information whose file path is said upward link, and wherein said file path is identified without prior reference to said parent map information.

30. A method according to claim 27 wherein reading said first map information and reading said second map information each result from applying a top-down algorithm to successively lower levels of said hierarchical network information.

31. A method according to claim 1 further comprising deciding whether to read child map information associated with a component of map information according to a perimeter-based criterion.

32. A method according to claim 31 wherein said perimeter-based criterion is programmable and varies with level.

33. A method according to claim 31 wherein said perimeter-based criterion is rectangular with programmable width or height.

34. A method according to claim 1 further comprising deciding whether to read image information content-wise associated with a component of map information according to a perimeter-based criterion.

35. A method according to claim 34 further comprising calling a web browser software code interface with URL information as a parameter, thereby causing said web browser software code to read said image information content-wise associated with said component.

36. A method according to claim 34 wherein said component is a component of child map information of a component of said first map information or said second map information.

37. A method according to claim 1 further comprising decompressing first compressed image information content-wise associated with said first area responsively to said user signal, and decompressing second compressed image information content-wise associated with said second area responsively to said user signal.

38. A method according to claim 1 further comprising decompressing first compressed image information content-wise associated with said first area in anticipation of said user signal, and decompressing second compressed image information content-wise associated with said second area in anticipation of said user signal.

39. A method according to claim 38 wherein decompressing said first compressed image information and decompressing said second compressed image information each result from applying a bottom-up algorithm to successively higher levels of said hierarchical network information.

40. A method according to claim 1 further comprising deciding whether to decompress compressed image information content-wise associated with a component of map information according to a perimeter-based criterion.

41. A method according to claim 40 wherein said perimeter-based criterion is programmable and varies with level.

42. A method according to claim 40 wherein said perimeter-based criterion is rectangular with programmable width or height.

43. A method according to claim 40 further comprising calling a web browser software code interface with URL information as a parameter, thereby causing said web browser software code to decompress said compressed image information.

44. A method according to claim 40 wherein said component is a component of said first map information or said second map information.

45. A method according to claim 1 wherein said receiving of said user signal comprises receiving information about individual pointing device motions in at least an x dimension and a y dimension.

46. A method according to claim 45 further comprising receiving a button-down signal which indicates that input from said pointing device has been switched to a down state, initiating said navigational shifting responsively to said button-down signal, later receiving a button-up signal which indicates that input from said pointing device has been switched to an up state, and ceasing said navigational shifting responsively to said up signal.

47. A method according to claim 46 wherein a screen location of said pointing device coincides with a screen location of displayed content upon receipt of said button-down signal.

48. A method according to claim 46 further comprising displaying both a vertical region of content newly within view and a horizontal region of content newly within view prior to said button-up signal, and displaying both said vertical region of content newly within view and said horizontal region of content newly within view subsequent to said button-down signal.

49. A method according to claim 1 further comprising keyboard means for directing said navigational shifting in a+x direction and keyboard means for directing said navigational shifting in a−x direction.

50. A method according to claim 1 further comprising keyboard means for directing said navigational shifting in a+y direction and keyboard means for directing said navigational shifting in a−y direction.

51. A method according to claim 1 further comprising user means for directing second navigational shifting such that an x coordinate value is reinitialized and a y coordinate value is reinitialized.

52. A method according to claim 51 further comprising toolbar means for directing navigation comprising said second navigational shifting.

53. A method according to claim 1 further comprising receiving a button-down signal which indicates that input from a pointing device has been switched to a down state, initiating said navigational scaling responsively to said button-down signal, later receiving a button-up signal which indicates that input from said pointing device has been switched to an up state, and ceasing said navigational scaling responsively to said up signal.

54. A method according to claim 53 wherein the screen location of said pointing device coincides with a scrollbar area upon receipt of said button-down signal.

55. A method according to claim 53 further comprising displaying both a vertical region of content newly within view and a horizontal region of content newly within view prior to said button-up signal, and displaying both said vertical region of content newly within view and said horizontal region of content newly within view subsequent to said button-down signal.

56. A method according to claim 1 further comprising keyboard means for directing said navigational scaling in a scale-decreasing direction.

57. A method according to claim 1 further comprising keyboard means for directing said navigational scaling in a scale-increasing direction.

58. A method according to claim 1 further comprising user means for controlling a center point with respect to which said navigational scaling is centered.

59. A method according to claim 1 further comprising scaling decompressed image information by a scaling ratio N/M, where N is integer and fixed, for a series of values of integer M including M equal to N.

60. A method according to claim 59 wherein said series includes both values of M greater than N and values of M less than N.

61. A method according to claim 59 wherein N is equal to 16.

62. A method according to claim 1 comprising buffering scaled decompressed image information in a data structure referenced by a component information data structure.

63. A method according to claim 1 further comprising toolbar means for directing said navigational scaling in a scale-decreasing direction by a predefined amount.

64. A method according to claim 1 further comprising toolbar means for directing said navigational scaling in a scale-increasing direction by a predefined amount.

65. A method according to claim 1 further comprising user means for directing second navigational scaling such that a scale value is reinitialized.

66. A method according to claim 65 further comprising toolbar means for directing navigation comprising said second navigational scaling.

67. A method according to claim 1 further comprising keyboard means for directing said downward navigation to said first level.

68. A method according to claim 1 further comprising keyboard means for directing said upward navigation to said first level.

69. A method according to claim 1 further comprising toolbar means for directing said downward navigation to said first level.

70. A method according to claim 1 further comprising toolbar means for directing said upward navigation to said first level.

71. A method according to claim 1 wherein said user signal which directs said downward navigation is furthermore a user signal which directs navigational scaling in a scale-decreasing direction, such that a scaling ratio crosses a scaling ratio threshold.

72. A method according to claim 71 wherein said scaling ratio threshold is programmable and potentially unequal to a downward level-to-level scaling ratio.

73. A method according to claims 72 and 59 wherein said scaling ratio threshold is defined by a threshold value of said integer M.

74. A method according to claim 1 wherein said user signal which directs said upward navigation is furthermore a user signal which directs navigational scaling in a scale-increasing direction, such that a scaling ratio crosses a scaling ratio threshold.

75. A method according to claim 74 wherein said scaling ratio threshold is programmable and potentially unequal to an upward level-to-level scaling ratio.

76. A method according to claims 75 and 59 wherein said scaling ratio threshold is defined by a threshold value of said integer M.

77. A method according to claim 1 further comprising maintaining a selection range of one or more selected regions each comprising image information associated content-wise with a selected component of map information.

78. A method according to claim 77 further comprising indicating the selection state of a selected region by hiliting said selected region.

79. A method according to claim 77 further comprising receiving user input from a pointing device, and switching the selection range to a region which coincides with a screen location of said pointing device responsively to said user input.

80. A method according to claim 77 further comprising receiving a first button-down signal which indicates a first change in a state machine for maintaining selection ranges, receiving a first pointing-device button-down signal which indicates that input from a pointing device has been switched to a down state, identifying a selectable region which coincides with a screen location of said pointing device, and switching the selection range state of said region responsively to said first pointing-device button-down signal.

81. A method according to claim 80 further comprising receiving a second button-down signal which indicates a second change in said state machine for maintaining selection ranges, receiving a second pointing-device button-down signal which indicates that input from said pointing device has been switched to a down state, and omitting said switching of said selection range state responsively to said second change in said state machine.

82. A method according to claim 1 further enabling adding a selected unit of information to shopping cart information.

83. A method according to claim 82 further comprising displaying a region of said shopping cart information which contains decompressed image information.

84. A method according to claim 83 wherein said adding comprises duplicating a selected unit of map information already in said shopping cart information.

85. A method according to claims 82 and 77 wherein said adding comprises creating a shopping-cart component of shopping-cart map information, and wherein said creating comprises copying information from a selected component of map information.

86. A method according to claim 82 further comprising keyboard means for directing said adding.

87. A method according to claim 82 further comprising providing audio feedback responsively to user input directing said adding.

88. A method according to claim 87 wherein said audio feedback has a first pitch characteristic for a first addition of a selected unit of information to said shopping cart information, and wherein said audio feedback has a different pitch characteristic for one or more subsequent additions of said selected unit of information to said shopping cart information.

89. A method according to claim 1 further enabling deleting a selected unit of information from shopping cart information.

90. A method according to claim 89 further comprising keyboard means for directing said deleting.

91. A method according to claim 89 further comprising providing audio feedback responsively to user input directing said deleting.

92. A method according to claim 91 wherein said audio feedback has a final pitch characteristic for a final deletion of a selected unit of information from said shopping cart information, and wherein said audio feedback has a different pitch characteristic for one or more previous deletions of said selected unit of information from said shopping cart information.

93. A method according to claim 89 further comprising searching through shopping cart information to find a unit of shopping cart information which matches a selected unit of information.

94. A method according to claim 77 further comprising displaying information that is descriptive of said selection range.

95. A method according to claim 94 further comprising displaying information that is descriptive of monetary amounts associated with said selection range.

96. A method according to claims 94 and 82 further comprising displaying information that is descriptive of monetary amounts associated with one or more units of shopping cart information which match said selection range.

97. A method according to claim 82 further comprising displaying information that is descriptive of monetary amounts associated with said shopping cart information in toto.

98. A method according to claim 1 further comprising determining map information by positioning a plurality of components according to a packing algorithm.

99. A method according to claim 98 wherein the width and height of each component in said plurality is predetermined.

100. A method according to claim 98 wherein said packing algorithm preferably groups like components in proximity to one another.

101. A method according to claim 98 wherein said packing algorithm optimizes a measure of area usage.

102. A method according to claim 98 wherein said packing algorithm is recursive.

103. A method according to claims 98 and 83 further comprising toolbar means for toggling to or from displaying shopping cart information.

104. A method according to claim 98 further comprising toolbar means for directing repacking according to said packing algorithm.

105. A method according to claim 1 further comprising branching from displaying said region of said joined map information to displaying a region of map information arbitrarily distant from said joined map information.

106. A method according to claim 105 further comprising text-edit means for directing said branching.

107. A method according to claim 105 further comprising pulldown menu means for directing said branching.

108. A method according to claim 1 further comprising branching from displaying said region of said joined map information to displaying information suitable for rendering by web browser software code, wherein the dimensions of said information suitable for rendering by web browser software code are not determined by map information.

109. A method according to claim 1 further comprising branching from displaying information suitable for rendering by web browser software code to displaying said region of said joined map information, wherein the dimensions of said information suitable for rendering by web browser software code are not determined by map information.

110. A method according to claim 109 further comprising cancelling a pending navigation of said web browser software object.

111. A method according to claim 1 further comprising branching from displaying said region of said joined map information to displaying a region of map information determined by positioning a plurality of components according to a packing algorithm.

112. A method according to claim 1 further comprising displaying leaf content in a mall configuration, and further comprising branching from said displaying of said leaf content.

113. A method according to claims 112 and 108 wherein said branching from said displaying of said leaf content is branching to said displaying of said information suitable for rendering by web browser software code.

114. A method according to claim 1 further comprising storing history information about branching navigations.

115. A method according to claim 114 further comprising user means for directing backward branching according to said history information.

116. A method according to claim 115 further comprising toolbar means for directing said backward branching.

117. A method according to claim 114 further comprising user means for directing forward branching according to said history information.

118. A method according to claim 117 further comprising toolbar means for directing said forward branching.

119. A method according to claim 114 further comprising storing a history x coordinate value and a history y coordinate value in an entry of said history information, and later initializing an x coordinate value to said history x coordinate value and initializing a y coordinate value to said history y coordinate value.

120. A method according to claim 114 further comprising storing a history scale value in an entry of said history information, and later initializing a scale value to said history scale value.

121. A method according to claim 1 further comprising buffering a margined region of said first level comprising vertical and horizontal margins with respect to the source region of a destination view area.

122. A method according to claim 121 wherein said source region is larger than said destination view area.

123. A method according to claim 1 further comprising buffering a region of said first level using modulo addressing in the x dimension.

124. A method according to claim 1 further comprising buffering a region of said first level using modulo addressing in the y dimension.

125. A method according to claims 123 and 124 further comprising organizing image transformations by quadrant.

126. A method according to claim 1 further comprising buffering a block-width region of said first level, wherein the width of said block-width region is an integral number of block widths, when a navigational shifting increment in the x direction is not an integral number of block widths.

127. A method according to claim 126 wherein said block width is the block width of an image compression standard.

128. A method according to claim 127 wherein said image compression standard is an MPEG Intraframe coding standard.

129. A method according to claim 1 further comprising buffering a block-height region of said first level, wherein the height of said block-height region is an integral number of block heights, when a navigational shifting increment in the y direction is not an integral number of block heights.

130. A method according to claim 129 wherein said block height is the block height of an image compression standard.

131. A method according to claim 130 wherein said image compression standard is an MPEG Intraframe coding standard.

132. A method according to claims 1 and 78 further comprising buffering a region of said first level, wherein said buffering comprises buffering a hilited region.

133. A method according to claim 1 further comprising buffering a region of said first level, wherein said buffering comprises buffering into a YUV-format buffer.

134. A method according to claim 133 wherein said YUV-format buffer is a YUV-format offscreen buffer.

135. A method according to claim 1 further comprising buffering a region of said first level, wherein said buffering comprises buffering into an RGB-format buffer.

136. A method according to claim 135 wherein said RGB-format buffer is an RGB-format offscreen buffer.

137. A method according to claim 1 further comprising determining whether a YUV-format offscreen buffer format is available, and attempting to allocate a YUV-format offscreen buffer when said YUV-format offscreen buffer format is available.

138. A method according to claim 1 further comprising attempting to allocate an RGB-format offscreen buffer having a number of bits per pixel equal to the number of bits per pixel in an RGB-format screen buffer.

139. A method according to claim 1 further comprising buffering a region of said first level, wherein said buffering comprises buffering into a plurality of buffers, wherein a majority of the contents of a first buffer is not duplicated within the contents of a second buffer.

140. A method according to claim 139 further comprising copying source data for a scaling transformation into a straddle buffer.

141. A method according to claim 123 further comprising copying source data for a scaling transformation into a straddle buffer.

142. A method according to claim 124 further comprising copying source data for a scaling transformation into a straddle buffer.

143. A method according to claim 1 further comprising determining destination coordinates for a scaling transformation according to a tiling of destination space.

144. A method according to claim 143 wherein an origin of said tiling remains unchanged despite a user input directing navigational shifting.

145. A method according to claims 143 and 59 wherein a period of said tiling is a multiple of N.

146. A method according to claim 1 wherein a screen buffer comprises at least part of the destination of a scaling transformation.

147. A method according to claim 146 wherein said scaling transformation further comprises colorspace conversion.

148. A method according to claim 147 wherein said colorspace conversion is a YUV-to-RGB colorspace conversion.

149. A method according to claim 1 wherein an offscreen buffer comprises the destination of a scaling transformation.

150. A method according to claim 149 further comprising copying scale-output data from said offscreen buffer into a screen buffer, wherein a padded unit of said scale-output data is larger than the fraction of said padded unit that is copied into said screen buffer.

151. A method according to claims 143 and 150 wherein said padded unit is larger than a tile of said tiling by a predefined padding amount in the x dimension.

152. A method according to claims 143 and 150 wherein said padded unit is larger than a tile of said tiling by a predefined padding amount in the y dimension.

153. A method according to claim 150 further comprising determining coordinates of said padded unit using modulo arithmetic.

154. A method according to claim 1 further comprising initiating a DirectDraw blit.

155. A method according to claim 1 further comprising computing a destination coordinate as a linear transformation of a source coordinate.

156. A method according to claim 155 further comprising redefining said linear tranformation responsively to user input directing navigational scaling.

157. A method according to claim 1 further comprising computing a source coordinate as a linear transformation of a destination coordinate.

158. A method according to claim 157 further comprising redefining said linear tranformation responsively to user input directing navigational scaling.
